(19) United States
(12) Patent Application Publication
(10) Pub. No.: US 2016/0345563 A1
(43) Pub. Date: Dec. 1, 2016

(54) METHOD AND APPARATUS FOR JOINING LINES

(71) Applicant: OC10, LLC, Jamaica Plain, MA (US)

(72) Inventors: Paul V. Fenton, Marblehead, MA (US); Kevin L. Ohashi, Jamaica Plain, MA (US); Dave Dufour, Jamaica Plain, MA (US); Gary Streeter, Jamaica Plain, MA (US); Ben Streeter, Jamaica Plain, MA (US); Sam Kjellman, Jamaica Plain, MA (US)

(21) Appl. No.: 15/233,816

(22) Filed: Aug. 10, 2016

Related U.S. Application Data
(63) Continuation-in-part of application No. 14/031,005, filed on Sep. 18, 2013.
(60) Provisional application No. 61/744,079, filed on Sep. 18, 2012.
(60) Provisional application No. 62/203,182, filed on Aug. 10, 2015.
(60) Provisional application No. 62/303,720, filed on Mar. 4, 2016.

(51) Int. Cl. A01K 91/047; B29C 45/53; B29C 45/14; B29C 65/70; B29C 65/00

(52) U.S. Cl. CPC A01K 91/047; B29C 65/70; B29C 66/69; B29C 45/14467; B29C 45/14065; B29C 45/53; B29C 45/531; B29K 2105/0097

(57) ABSTRACT

A hand-held device for joining fishing line segments of monofilament, fluorocarbon, and/or braid lines of similar or differing sizes or combinations. The device is electrically powered and is portable. The device includes an encasement for orienting the fishing line segments in a closed chamber in close, tensioned, non-contacting orientation. A material is injected into the closed chamber to encase the lines. This material can be adhesive material or a flowable polymer material having, typically, a melting temperature lower than the line segments to be bonded. Alternatively, A pre-formed, flexible polymer sheath (or sleeve) is used to retain the line segments in the chamber. A heater heats the polymer sheath (or sleeve) within the encasement to allow the polymer to flow and encase the line segments without melting the line segments. Bonding of the line segments can be achieved without melting, abrading, compressing, or impairing the integrity the line segment(s) to be encased. The result is a system that is able to join various types and sizes of fishing line segments together or securing hooks or other components to at least one line.

### REFERENCE TO PENDING PRIOR PATENT APPLICATIONS

This patent application:

(i) is a continuation-in-part of pending prior U.S. patent application Ser. No. 14/031,005, filed Sep. 18, 2013 by OC10, LLC and Paul V. Fenton et al. for MATERIALS, METHODS AND DEVICES FOR JOINING LINES (Attorney's Docket No. FENTON-7), which patent application claims benefit of prior U.S. Provisional Patent Application Ser. No. 61/744,079, filed Sep. 18, 2012 by Paul V. Fenton et al. for MATERIALS, METHODS AND DEVICES FOR JOINING LINES (Attorney's Docket No. FENTON-2/FENTON-7 PROV);

(ii) claims benefit of pending prior U.S. Provisional Patent Application Ser. No. 62/203,182, filed Aug. 10, 2015 by OC10, LLC and Paul Fenton et al. for MATERIALS, METHODS AND DEVICES FOR JOINING LINES (Attorney's Docket No. FENTON-10 PROV); and

(iii) claims benefit of pending prior U.S. Provisional Patent Application Ser. No. 62/303,720, filed Mar. 4, 2016 by OC10, LLC and Paul Fenton et al. for MATERIALS, METHODS AND DEVICES FOR JOINING LINES (Attorney's Docket No. FENTON-17 PROV).

The four (4) above-identified patent applications are hereby incorporated herein by reference.

### FIELD OF THE INVENTION

The present invention relates to devices and methods for joining monofilament and/or braided lines together using a flowable material such as an adhesive (e.g., a hot melt adhesive) or flowable polymer or blend or composite or low temperature metal, etc. that allows for bonding (mechanical and/or chemical) of the lines, preferably using a relatively lower melting temperature material and/or adhesive setting material.

### BACKGROUND OF THE INVENTION

Recreational, commercial and sport fishing requires the use of fishing line which needs to be attached to a reel, to lines of different sizes and composition, to lures, hooks and weights, and the like. Current methods of knot-tying, metal crimping and/or fishing line welding require compressing, deforming, and/or abrading segments of line together, which have been shown to weaken the line strength. As a result, unintended or premature line breakage can occur.

Tying knots can be difficult due to line size, line stiffness, lighting (visibility) and cold temperatures (making it difficult to manipulate hands), etc.

Using metal crimping systems requires matching the correct crimp size to the line size in order to achieve optimal attachment. In addition, crimps require special tooling and the ability to apply the correct pressure to compress the line without excessively abrading the line, pinching the line, or leaving the crimp too loose so that the line ultimately slips.

Welding devices generally require the use of monofilament line, and also the use of special equipment to optimize the bond between the lines. However, with welding devices, the ability to bond different materials, or lines of different sizes, is not easy or straightforward, and has previously required compressing the line segments to weld, crimp, or tie them, which impacts the integrity of the raw line material and weakens the bond. Securing or joining lines together using any of the above methods generally, in most all instances, results in bond strength less than the line itself, which can result in line failure.

Failure can occur due to untying of knots, crimp slippage, weld bond failure, knots weakening the line, crimps weakening the line, weld heat or the friction stress of tying knots re-orienting the polymer materials in the line so as to weaken the line, etc.

U.S. Pat. No. 6,793,750 (Bittar) describes a hand-held fishing line welder that uses heat, RF energy or ultrasonic energy to heat and melt a monofilament line in order to bond it to another monofilament line, thereby creating a weld between the fishing lines. This approach can allow for joining lines of a single material and of a common size. However, the joining of lines of different materials, of different sizes, or a combination of different materials and different sizes, and maintaining a strong bond between the lines, is quite difficult using this approach. In addition, this welding approach requires compressing line segments together, which negatively impacts line strength at the bond. As such, developing a weld that is equal to, or stronger than, the original line strength is difficult using this welding technique.

It would, therefore, be advantageous to have a device that can join lines together (mechanically and/or chemically) in a quick, easy, and reproducible manner, for lines of the same or different materials, and for lines of the same or different sizes, using a hand-held device. The lines do not have to touch; in fact, having spacing between the lines will allow bonding material to surround or encase the lines, whereby to provide a much stronger bond. In addition, leaving space between individual line segments at the bond avoids compressing, abrading, deforming or otherwise impairing the physical integrity of the lines. The resulting bond can therefore be stronger than the original line strength.

### SUMMARY OF THE INVENTION

Accordingly, the present invention relates to materials, methods and devices for providing a quick, easy and reproducible manner of joining fishing line segments, from one or more discrete lines and/or of a different or the same material and/or of the same or different size, together.

As used herein, the term “line” may mean a polymer or metal line, particularly suitable for a fishing line, and may be a monofilament and/or braided line (including, but not limited to, polymer lines made of nylon, fluorocarbon, polyester, Ultra High Molecular Weight Polyethylene (UHMWPE) and/or biodegradable materials, natural fibers, and, if metal, of steel, Nitinol or titanium, etc. wire materials), of similar or differing materials and/or sizes and/or combinations of materials and/or sizes.

In one embodiment, a method and apparatus is used such that the fishing lines are held together in a parallel, non-contacting relation in a closed chamber and a flowable adhesive material (e.g., a hot melt adhesive material) is caused to enter the closed chamber to surround and encase the lines. After the hot melt adhesive material has set, the lines are removed from the closed chamber and are joined together in a strong bond.

As a further exemplary embodiment, a method and apparatus is used that also positions the fishing line segments in a closed chamber where the line segments are held so a flowable polymer sheath (or sleeve) can be molded around the line segments so that the line segments are locked together in a non-contacting parallel orientation. The line segments may, alternatively, be secured in a non-parallel non-contacting relationship. Segments from a single line may be secured together around a hook or other component, or segments from two or more lines may be secured together.

The polymer sheath (or sleeve) comprises a material that melts at a lower temperature than the lines themselves. The closed chamber is heated such that the material of the polymer sheath (or sleeve) melts so as to surround and encase the lines and, upon cooling, the line segments are joined together in a strong bond. The raw flowable polymer material may comprise a fluid, powder, solid component, or pellets that are introduced into the chamber such that, once heated, it is molded within the chamber, creating the polymer sheath (or sleeve) that encapsulates the line segments such that they are spaced apart, whereby to increase the contacting surface area between the line segments and polymer sheath (or sleeve). As an alternative embodiment of fabricating the bond, the raw material of the polymer sheath (or sleeve) may be in a flowable form that is actuated (i.e., set) using ultraviolet light or other mechanism, whereby to mold the flowable material so as to encapsulate the line segments in a bond, without relying on any melting of the raw material.

The resulting polymer sheath (or sleeve) may be formed in an elongate shape with one or more tapered ends so as to provide a smooth transition from the line to the polymer sheath (or sleeve); however, any other alternative shape that suits the application may also be utilized. The polymer sheath (or sleeve) may also be fabricated so as to partially encapsulate a component such as the eyelet of a hook or other component to be secured by the line segments, such that a smooth transition from the hook or other component to the line is produced.

The present invention also includes a device to carry out the methods heretofore described, and that device is preferably a hand-held device that has a handle and jaws that can be moved between an open position and a closed position. When open, the lines can be inserted between the jaws and, when closed, the abutting jaws form a closed chamber where the joining of the lines takes place (e.g., by molding the flowable adhesive or flowable polymer around the lines).

In one embodiment of the hand-held device, an adhesive material (e.g., a hot melt adhesive) is injected into the closed chamber to surround and encase the lines, and when the material has set, the jaws can be opened and the joined lines removed.

In another embodiment, one or both of the jaws of the hand-held device has a heater and there is a meltable polymer sheath (or sleeve) that is located within the jaws of the hand-held device and the polymer sheath (or sleeve) positions the line segments in a non-contacting, parallel (or non-parallel) orientation within the closed chamber when the jaws are in their closed position. The heater can be activated and the raw polymer material melts at a temperature below the melting temperature of the line(s), such that the polymer material flows in the closed chamber to surround and encase the line segments and, upon cooling, the line segments are strongly joined together by the polymer.

The molding instrument embodiments of the invention may comprise a cartridge system that houses the raw polymer material in the form of a fluid, powder, pellet or solid. This facilitates loading of the raw polymer material, changing polymer materials, and/or the addition of colors or other enhancement features such as scents, additives, or reinforcement materials, etc., whereby to enhance the ability of a single molding instrument to create polymer sheaths (or sleeves) with varying characteristics. Additionally, the mold cavity may be replaceable so as to accommodate different line segment sizes, different numbers of line segments (e.g., three or more line segments may be molded together with a single polymer sheath or sleeve), different orientations of line segments in parallel or non-parallel orientations, or the encapsulation of hook or other components within the polymer sheath (or sleeve).

The embodiments of the invention improve the bond strength between at least two line segments. The line segments may be spaced apart at the bond so as to avoid impairing the material of the lines. The segments may comprise discrete lengths of a single line; alternatively, the segments may comprise two or more lines that may be secured together. The embodiments of the invention may be used to secure segments of at least one line to secure a hook, lure, weight, additional fishing line(s) and/or other fishing components.

In addition, the embodiments may attach at least two segments of filament for other applications outside of fishing. In particular, any application in which two segments of line, thread, yarn, suture, wire or other flexible elongated material are bonded together may benefit from the embodiments of the invention, which secure at least two segments together such that they are spaced apart so as to improve bond strength and the profile of the bond while preserving the physical integrity of the raw line material.

In one preferred form of the invention, the invention comprises the provision and use of a molded fastener, formed at least in part out of a flowable material, to secure two or more line segments in position relative to one another. In use, the line segments are positioned with a desired orientation (e.g., in a parallel or non-parallel, spaced relationship), the flowable material is flowed about the line segments so as to engulf the line segments, and then the flowable material is set so as to form an encasing structure about the line segments, whereby to lock the two or more line segments in position relative to one another.

In one form of the invention, the molded fastener is formed in situ, e.g., the line segments are positioned in a mold with the desired orientation, the flowable material is flowed into the mold and about the line segments, and then the flowable material is set so as to form the encasing structure about the line segments, whereby to lock the line segments in position relative to one another.

In another form of the invention, the molded fastener is at least partially pre-formed, and then the final configuration of the molded fastener is effected in situ, e.g., the line segments are positioned in the at least partially pre-formed molded fastener, the flowable material is flowed about the line segments, and then the flowable material is set so as to form the encasing structure about the line segments, whereby to lock the line segments in position relative to one another.

The flowable material may comprise any material capable of performing the desired function. In one form of the invention, the flowable material forms a mechanical bond with the line segments when set. In another form of the invention, the flowable material forms a chemical bond with the line segments when set. And in another form of the invention, the flowable material forms both mechanical and chemical bonds with the line segments when set. The flowable material may comprise an adhesive (including a hot melt adhesive) and/or a flowable polymer and/or any other appropriate material, and flowing/setting of the flowable material may be effected according to the nature of the flowable material, e.g., heating/cooling, the absence or presence of UV light, the absence or presence of a reactant, etc.

In one preferred form of the present invention, there is provided a system for securing at least two line segments in position relative to one another, the system comprising:

a molded fastener formed at least in part out of a flowable material, wherein the flowable material is flowed about the at least two line segments after the at least two line segments have been positioned with a desired orientation and is thereafter set, whereby to form an encasing structure about the at least two line segments, whereby to lock the at least two line segments in position relative to one another.

In another preferred form of the present invention, there is provided a method for securing at least two line segments in position relative to one another, the method comprising:

positioning the at least two line segments in a hand-held tool with a desired orientation;

using the hand-held tool to flow flowable material about the at least two line segments so as to engulf the at least two line segments; and

setting the flowable material in the hand-held tool so as to form a molded fastener which acts as an encasing structure about the at least two line segments, whereby to lock the at least two line segments in position relative to one another.

In another preferred form of the present invention, there is provided a method for joining lines, the method comprising the steps of:

positioning the lines in a side by side relationship in a closed chamber;

introducing an adhesive material into the closed chamber to surround the lines; and

allowing the adhesive material to encase the lines and join the lines together.

In another preferred form of the present invention, there is provided a method for joining lines having a melting temperature, the method comprising the steps of:

providing a meltable fastener having a melting temperature below the melting temperature of the lines;

affixing the lines to the meltable fastener in a non-contacting, parallel orientation; and

heating the meltable fastener to the melting temperature of the meltable fastener to cause the meltable fastener to flow and surround and encase the lines to join the lines together.

In another preferred form of the present invention, there is provided a hand-held device to carry out the joining of lines, the device comprising a handle having a pair of jaws, at least one of the jaws being movable with respect to the other of the jaws to an open position wherein the jaws are spaced apart and a closed position wherein the jaws are abutting each other, the jaws forming a closed chamber when in the closed position, and a means of introducing an adhesive material into the closed chamber to surround and encase the lines to join the lines together.

In another preferred form of the present invention, there is provided a hand-held device to carry out the joining of lines having a melting temperature, the device comprising a handle having a pair of jaws, at least one of the jaws being movable with respect to the other of the jaws to an open position wherein the jaws are spaced apart and a closed position wherein the jaws are abutting each other, the jaws forming a closed chamber when in the closed position, at least one heater adapted to be activated to heat the closed chamber, a meltable fastener positioned within the closed chamber and adapted to retain the lines in a non-contacting parallel orientation, the at least one heater adapted to heat the meltable fastener to a temperature below the melting temperature of the lines to cause the meltable material to flow and surround and encase the lines to join the lines together.

In another preferred form of the present invention, there is provided a device to carry out the joining of lines having a melting temperature, the device comprising an upper housing and a lower housing, at least one of the housings being movable between a closed position where the upper and lower housings abut against each other forming a closed chamber therebetween and an open position where the upper and lower housings are separated from each other, at least one of the upper and lower housing having a heater to heat the closed chamber, a meltable fastener positioned within the closed chamber and adapted to retain the lines in a non-contacting parallel orientation, the at least one heater adapted to heat the meltable fastener to a temperature below the melting temperature of the lines to cause the meltable material to flow and surround and encase the lines to join the lines together.

In another preferred form of the present invention, there is provided a system for securing at least two line segments in position relative to one another, the system comprising:

a hand-held device, wherein the hand-held device comprises a mold defining a mold chamber and an inlet port in fluid communication with the mold chamber, and further wherein the hand-held device is configured to support the at least two line segments so that the at least two line segments extend into the mold chamber; and

a welding cartridge comprising a heating element and a solid polymer element, wherein the welding cartridge is configured to be received by the hand-held device so that when the heating element is energized and the solid polymer element is moved so as to contact the heating element, flowable polymer will enter the inlet port and flow into the mold chamber.

In another preferred form of the present invention, there is provided a welding cartridge comprising:

a housing having a distal end, a proximal end and a lumen extending therebetween;

a heating element disposed at the distal end of the housing; and

a solid polymer element movably disposed within the lumen.

In another preferred form of the present invention, there is provided a method for securing at least two line segments in position relative to one another, the method comprising:

providing a system comprising:
a hand-held device, wherein the hand-held device comprises a mold defining a mold chamber and an inlet port in fluid communication with the mold chamber, and further wherein the hand-held device is configured to support the at least two line segments so that the at least two line segments extend into the mold chamber; and
a welding cartridge comprising a heating element and a solid polymer element, wherein the welding cartridge is configured to be received by the hand-held device so that when the heating element is energized and the solid polymer element is moved so as to contact the heating element, flowable polymer will enter the inlet port and flow into the mold chamber;

positioning the at least two line segments so that they extend into the mold chamber; and

activating the heating element on the welding cartridge so as to melt the solid polymer element and cause flowable polymer to enter the inlet port and flow into the mold chamber.

### BRIEF DESCRIPTION OF THE DRAWINGS

These and other objects, features and advantages of the present invention will become more readily apparent in view of the following detailed description of the preferred embodiments of the invention, which is to be considered in conjunction with the accompanying drawings wherein like numbers refer to like parts and further wherein:

FIG. 1A is a schematic view of an exemplary embodiment of the present invention using a syringe for injecting an adhesive material or flowable polymer to contact the line segments;

FIG. 1B is a schematic view of the actual injection of the adhesive material or flowable polymer to contact the line segments;

FIG. 1C is a schematic view of a step of removing the syringe after the injection of the adhesive material or flowable polymer has been completed;

FIG. 2A is a perspective view of an exemplary embodiment of the present invention joining two line segments together;

FIG. 2B is a perspective view of a shrink tube usable to carry out the embodiment of FIG. 2A;

FIG. 3A is a perspective view of an exemplary embodiment of the present invention illustrating the introduction of a line into a clamshell encasement for joining portions of the line together;

FIG. 3B is a perspective view of the embodiment of FIG. 3A with the portions of the line secured within the encasement;

FIG. 3C is a schematic view of the step of injecting an adhesive material or flowable polymer or other flowable material into the encasement so as to join the portions of the line segments together;

FIG. 4A is a side view of a hand-held device of the present invention that is usable to join two or more line segments together;

FIG. 4B is an enlarged perspective view of the lower jaw of the hand-held device of FIG. 4A;

FIG. 4C is an enlarged view showing the jaws of the hand-held device of FIG. 4A in their closed position to join the line together;

FIG. 4D is a perspective view of a line having been joined together in accordance with the steps of FIGS. 4A-4C;

FIG. 5A is a schematic view of an exemplary embodiment of the present invention illustrating line segments positioned for introduction into a meltable polymer sheath (or sleeve);

FIG. 5B is a schematic view of the embodiment of FIG. 5A, with the line segments positioned within the meltable polymer sheath (or sleeve) and with the meltable polymer sheath (or sleeve) contained within a clamshell encasement, with the clamshell encasement being in its open position;

FIG. 5C is a schematic view of the embodiment of FIG. 5A, with the polymer sheath (or sleeve) contained within a clamshell encasement and with the clamshell encasement in its closed position;

FIG. 5D is a schematic view of the embodiment of FIG. 5A, with the line segments joined together within the melted polymer sheath (or sleeve);

FIG. 6A is a perspective view of a polymer sheath (or sleeve) usable with the present invention;

FIG. 6B is a perspective view of a polymer sheath (or sleeve) usable with the present invention, with line segments affixed thereto;

FIG. 6C is a perspective view of a melted polymer sheath (or sleeve) joining the line segments together;

FIG. 7A is a perspective view of a further exemplary embodiment of the present invention;

FIG. 7B is a cross-sectional view of the embodiment of FIG. 7A, illustrating line segments in position to be joined together;

FIG. 7C is a cross-sectional view of the embodiment of FIG. 7A, illustrating the completion of joining the line segments together;

FIG. 8 is a side view of another exemplary embodiment of the present invention, illustrating the use of a glue gun to join two line segments together;

FIGS. 9A-9D are schematic views of a hand-held device utilized to produce a polymer sheath fastener that joins segments of line together in accordance with an embodiment of the present invention;

FIGS. 10A-10F are schematic views showing operational aspects of the hand-held device shown in FIGS. 9A-9D;

FIG. 11 is a perspective view of a representative mold cavity utilized to produce a polymer sheath fastener in accordance with the construction shown in FIGS. 9A-9D and 10A-10F;

FIGS. 12A and 12B are cross-sectional views of the polymer plunger assembly of the construction shown in FIGS. 9A-9D and 10A-10F, highlighting the plunger, injector, heater and mold components in accordance with an embodiment of the present invention;

FIG. 13 is a perspective view showing the polymer sheath used to secure segments of line so as to attach a fishing hook in accordance with the construction of FIGS. 9A-9D and 10A-10F;

FIGS. 14A-14L are schematic views of the resulting polymer sheath (or sleeve) construct that secures individual line segments together, with the individual line segments being separated by a pre-defined space so as to increase bond integrity in accordance with an embodiment of the present invention;

FIGS. 15A-15E are side views of an alternative hand-held device that incorporates an adhesive polymer cartridge system for injecting polymer sheath material into a mold containing line segments so as to secure those line segments together in accordance with an embodiment of the present invention;

FIGS. 16A-16C are schematic views of an adhesive or polymer filled cartridge in accordance with the embodiment of FIGS. 15A-15E;

FIG. 17 is a polymer sheath (or sleeve) embodiment illustrating a preferred relationship between the polymer sheath (or sleeve) dimensions and the secured line dimensions so as to optimize tensile strength using the devices described above in accordance with an embodiment of the present invention;

FIG. 18 is a table showing exemplary performance characteristics for the present invention;

FIG. 19 is an exemplary graph showing the tensile strength of joined lines as a plot of sleeve length vs. line diameter;

FIG. 20 is a schematic view showing another approach for connecting a plurality of line segments in accordance with the present invention;

FIG. 21 is a schematic view showing still another approach for connecting a plurality of line segments in accordance with the present invention;

FIG. 22 is a schematic view showing yet another approach for connecting a plurality of line segments in accordance with the present invention;

FIGS. 23 and 24 are schematic views of a novel portable hand-held line-welding system formed in accordance with the present invention;

FIGS. 25-28 are schematic views of the novel welder of the novel portable hand-held line-welding system of FIGS. 23 and 24;

FIGS. 29-32 are schematic views of one form of the novel welding cartridge of the novel portable hand-held line-welding system of FIGS. 23 and 24;

FIGS. 33-38 are schematic views of another form of the novel welding cartridge of the novel portable hand-held line-welding system of FIGS. 23 and 24;

FIGS. 39-50 are schematic views showing use of the novel portable hand-held line-welding system of FIGS. 23 and 24;

FIGS. 51-53 are schematic views showing how the novel welder of the novel portable hand-held line-welding system of FIGS. 23 and 24 can utilize replaceable welding heads;

FIGS. 54 and 55 are schematic views showing how a mount may be provided for mounting the novel welder of the novel portable hand-held line-welding system of FIGS. 23 and 24 to a surface;

FIG. 56 is a schematic view showing various ways in which the line joinder may be strengthened; and

FIG. 57 is a description of the line connection made by the overmold system of the present invention, including a free body diagram showing the various pulley forces, visco-elastic shear forces and adhesion mechanisms present in the line connection.

### DETAILED DESCRIPTION OF THE PREFERRED EMBODIMENTS

### Line Welding in General

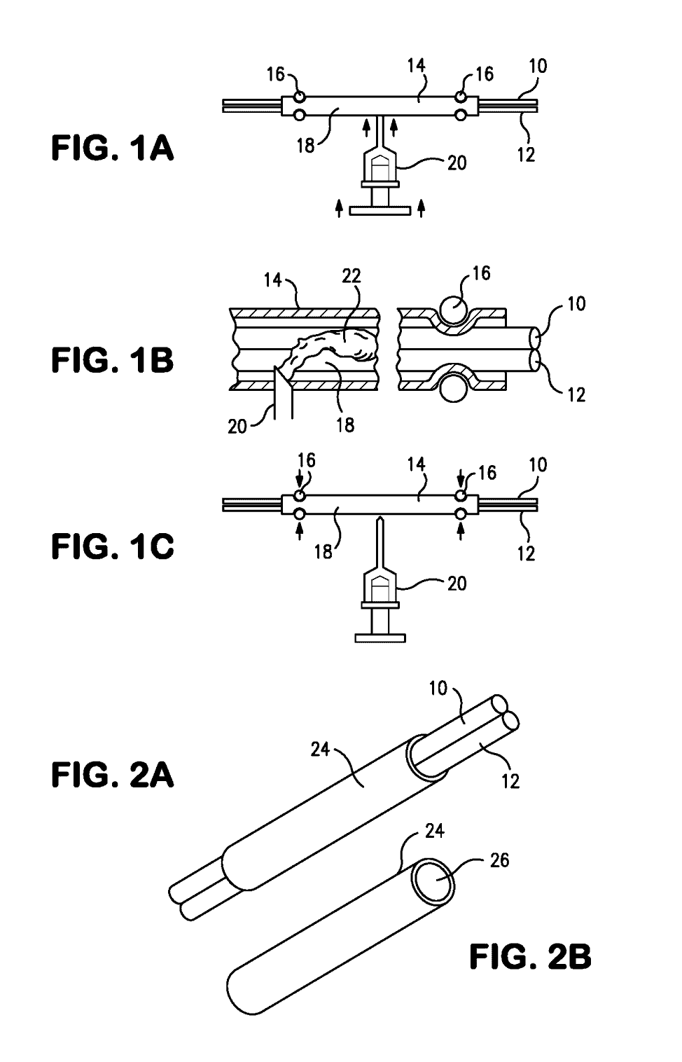

Referring now to FIGS. 1A-1C, there is shown schematic views of an exemplary embodiment of the present invention. Accordingly, taking FIG. 1A, there is a side schematic view illustrating two lines 10, 12 that are to be joined together in accordance with the present invention. As can be seen in FIG. 1A, the lines 10, 12 pass through a sleeve 14 that has sealing devices 16 (such as clamps) that provide lateral seals between the lines 10, 12 and the sleeve 14, thereby creating a closed chamber 18 therein. It should be noted that the lines 10, 12 may comprise segments from a single line, or segments from two or more lines, which will be secured together by a polymer sheath (or sleeve), with that polymer sheath (or sleeve) having a pre-defined geometry determined by the geometry of the closed chamber (or cavity) 18.

As also can be seen in FIG. 1A, there is a syringe 20 that is in communication with the closed chamber 18 to allow a sealing, adhesive or bonding material to be injected into the closed chamber 18, whereby to surround and encase the line segments 10, 12. It should be noted that this embodiment of the invention, as well as subsequent embodiments of the invention, may bond together at least two line segments, with those two line segments being from a single line, from two lines, or from more than two lines; alternatively, a hook, other fishing component, or miscellaneous part may be secured to one or more line segments by encapsulating a portion of the component to the line segment(s) via the molded adhesive bond construct, such that a bond is formed. It should also be appreciated that an overmold may be formed on a single line for the purpose of creating a marker, for example, depth markers on a line at regular intervals.

Examples of adhesive materials usable with the present invention include, but are not limited to, hot melt adhesives, epoxies, cyanoacrylates, acrylics, polyurethanes, silicones, phenolics, polyimides, plastisols, polyvinyl acetate and derivatives thereof.

The sealing, adhesive, or bonding material may also comprise flowable polymers, co-polymers, blends, composites, low temperature metals, etc., or any other flowable material appropriate for use with the present invention.

As to hot melt adhesives or flowable polymer materials, hot melt adhesives or flowable polymers are applied onto the lines to be bonded as adhesives, flowable melts, fluids that solidify, and/or flowable polymers. The hot melt adhesives or flowable polymer melts are molded in situ so as to encapsulate the line segments, set and then solidify upon cooling, whereby to secure together those line segments.

For example, hot melt adhesives or flowable polymers often possess a moderate-to-long “open time” (defined as the time span between adhesive application and assembly of the line segments being joined), but after immobilization of the line segments being joined, the hot melt adhesives or flowable polymers must set quickly enough to ensure a bond of appropriate quality. In addition to setting speed, viscosity is also an important property of a hot melt adhesive or flowable polymer. For uniform hot melt adhesive or flowable polymer application, the viscosity should be sufficiently low at a corresponding application temperature. Hot melt adhesives are highly thermally stressed over long periods of time upon application. One important requirement is, therefore, good thermal stability at application temperature. The thermal stability of hot melt adhesives or flowable polymers depends, among other factors, on the compatibility of the components on which the hot melt adhesive or flowable polymer is based. Incompatibility often exists, especially in the case of components that enhance adhesion. Hot melt adhesives or flowable polymers are usually based on one or more base materials, with various additives. The composition is usually formulated so as to have a glass transition temperature below the lowest service temperature and a suitably high melt temperature. The degree of crystallization should be as high as possible but within the limits of allowed shrinkage. The melt viscosity and the crystallization rate (corresponding “open time”) can be tailored. A faster crystallization rate usually implies a higher bond strength. The present embodiment allows the sealing, adhesive or bonding material to be tailored for optimum performance for the conditions of use and the line segments being bonded.

The nature of the adhesive or flowable polymer or other flowable material and the additives influences the nature of mutual molecular interaction and interaction with the line segments. Good wetting of the line segments is often desirable for forming a satisfying bond between the adhesive or flowable polymer, etc. and the line segments. More polar compositions tend to have better adhesion due to their higher surface energy. Amorphous adhesives or polymers deform easily, and tend to dissipate most of the mechanical strain within their structure, passing only small loads onto the adhesive/line segment interface; even a relatively weak nonpolar-nonpolar surface interaction can then form a fairly strong bond prone primarily to a cohesive failure. The distribution of molecular weights and the degree of crystallinity influences the width of the melting temperature range. Polymers with a crystalline nature tend to be more rigid and have higher cohesive strength than the corresponding amorphous ones, but they also transfer more strain to the adhesive/line segment interface. Higher molecular weights of the polymer chains provide higher tensile strengths and heat resistance. All of these conditions are to be considered in producing materials to optimize the resulting bonded sleeve (or sheath) structure.

An increase in bond strength and service temperature can be achieved by the formation of cross links in the polymer after solidification. This can be achieved by using polymers undergoing curing with residual moisture (e.g., reactive polyurethanes, silicones, etc.), exposure to UV radiation and the like.

Some of the possible base materials are, but are not limited to: Ethylene vinyl acetate (EVA), Ethylene Acrylate (ethylene n-butyl acrylate) (EnBA), ethylene-acrylic acid (EAA), ethylene-ethyl acetate (EEA), Polyolefins (PO), polyethylene (Low Density Polyethylene (LDPE) and High Density Polyethylene (HDPE)), atactic polypropylene (PP or APP), Polybutene-1, Amorphous polyolefin (APO) polymers, Polyamides, polyesters, Polyurethanes and Styrene block copolymers (SBC).

In addition, other materials that are biodegradable may also be utilized so as to provide a means for the polymer to degrade over time in the environment under certain conditions. Such materials may comprise biodegradable polymers that have been treated so as to be easily broken down by microorganisms and return to nature. Many technologies exist today that allow for such treatment. Currently there are some synthetic polymers that can be broken down by microorganisms (e.g., polycaprolactone), others are polyesters and aromatic-aliphatic esters which, due to their ester bonds, are susceptible to attack by water. Some examples of these are the PHA family of natural polymers that include poly-3-hydroxybutyrate, and in addition, the renewably-derived polylactic acid, and the synthetic polycaprolactone. Others are the cellulose-based cellulose acetate and celluloid (cellulose nitrate).

The hot melt adhesives or flowable polymers or other flowable materials can also contain, in addition to the aforesaid base materials, other additives. These include, for example, plasticizers, tackifiers, stabilizers, waxes, adhesion promoters, fillers, elastic thermoplastics and antioxidants. Specific applications-engineering properties (e.g., cohesive strength, viscosity, elastics properties and softening point) can thereby be influenced.

The adhesives or flowable polymers are selected by one skilled in the art in such a way that good compatibility exists with the other additives of the hot melt adhesive or flowable polymer.

If applicable, the hot melt adhesive or flowable polymer can have waxes added to it, e.g., in quantities from 0 to 45 wt %. The quantity is preferably such that the viscosity is lowered into the desired range, but adhesion is not negatively influenced. The wax can be of natural origin, chemically-modified form, or synthetic. Plant waxes and animal waxes can be used as natural waxes, also mineral waxes or petrochemical waxes. As chemically modified waxes, hard waxes such as montan ester waxes, sasol waxes, etc. can be used. Polyalkylene waxes and polyethylene glycol waxes are utilized as synthetic waxes. Petrochemical waxes such as petrolatum, paraffin waxes, microcrystalline waxes and synthetic waxes can be used.

Plasticizers are used in order to adjust the viscosity or flexibility of the final construct, and are contained in the hot melt adhesive or flowable polymer generally at a concentration of from 0 to 20 wt %. Suitable plasticizers are mineral oils, naphthenic mineral oils, polypropylene, polybutene, polyisobutylene, polyisoprene oligomers, hydrogenated polyisoprene and/or polybutadiene oligomers, benzoate esters, phthalates, adipates, vegetable or animal oils, and derivatives thereof. Hydrogenated plasticizers are selected, for example, from the group of the paraffinic hydrocarbon oils. Polypropylene glycol and polybutylene glycol, as well as polymethylene glycol, are also suitable. Esters are also used, as applicable, as plasticizers, for example liquid polyesters and glycerol esters, or plasticizers based on aromatic dicarboxylic acid esters.

The purpose of the stabilizers is to protect the adhesive or polymer composition from breakdown during processing. Antioxidants and light-protection agents are among those which are preferred. They are added to the hot melt adhesive or flowable polymer, typically in quantities of up to 3 wt %.

Further additives can also be incorporated into the hot melt adhesive or flowable polymer in order to vary specific properties. These can be, for example, dyes, or fillers such as titanium dioxide, talc, clay and the like.

The hot melt adhesive or flowable polymer can also contain adhesion promoters. Adhesion promoters are substances that improve the adhesion of the hot melt adhesive or flowable polymer with respect to the line segments that are to be adhesively bonded. Among other things, the adhesion promoters are intended to improve the aging behavior of adhesive bonds under the influence of a moist atmosphere. Typical adhesion promoters are, for example, ethylene/acrylamide comonomers, polymeric isocyanates, reactive organosilicon compounds or phosphorus derivatives. Tackifiers (e.g., terpene) can also be used. The wetting properties of the adhesive or flowable polymer on the substrates can likewise be influenced.

The additives, such as plasticizers, stabilizers, or adhesion promoters, are known to one skilled in the art. They are commercial products, and one skilled in the art can select them in accordance with the desired properties. Care must, of course, be taken for compatibility with the adhesive or flowable polymer and the line segments being joined.

The hot melt adhesive or flowable polymer or other flowable material is generally manufactured by mixing. In this context, all of the components can be made ready simultaneously, heated, and then homogenized; or firstly, the more-easily melted components are made ready and mixed, and then the further adhesive or polymer constituents are added, and finally further additives that are temperature-sensitive are added. It is also possible to manufacture the hot melt adhesive or flowable polymer continuously in an extruder. After decanting or portioning of the completely homogenized mixture, it is allowed to cool, whereupon it solidifies.

The hot melt adhesive in this example is of solid consistency and (aside from contaminants) free of solvents. Methods for manufacturing, decanting, and packaging hot melt adhesives are known to one skilled in the art. It is homogeneous in the solid and liquid phase (e.g., a melt is clear and not opaque or cloudy). No separation of the hot melt adhesive constituents is to be observed even if the melted state continues for a long time.

In terms of utilization, it is generally best to use a hot melt adhesive or flowable polymer having the lowest possible viscosity at application temperature. This ensures better applicability and easier delivery of the hot melt adhesive or flowable polymer. Wetting of the line segments is also thereby promoted. Good application properties are achieved with the hot melt adhesive or flowable polymer according to the present invention. No separation of individual constituents, or phase separation, is to be observed even when held for a longer period in the molten phase. Adhesion to the line segments is good. Bonding of the adhesive or flowable polymer exists even at different temperatures.

In FIG. 1B, there can be seen the actual injection of the adhesive material or flowable polymer or other flowable material 22 into the closed chamber 18 so as to surround both of the line segments 10, 12 for joining them together.

As seen in FIGS. 1A-1C, there is an appearance that the two lines 10, 12 are in contact with each other, however, in a preferred embodiment, the lines 10, 12 are parallel but separated from one another by a finite distance so that the adhesive material or flowable polymer 22 can enter into the space between the lines 10, 12, whereby to enhance the ultimate joinder of the lines 10, 12.

Lastly, in this embodiment, in FIG. 1C, the syringe 20 has been withdrawn and is no longer in communication with the closed chamber 18, such that the adhesive material or flowable polymer or other flowable material is allowed to set. The sleeve 14 can then be removed since the joining of the lines 10, 12 has been completed.

Turning next to FIGS. 2A and 2B, there is shown a sleeve 24 that can be used with the present invention and which is basically a cylindrical configuration with a hollow core 26 extending therethrough. Sleeve 24 can be made out of flexible plastic material. In FIG. 2A, the lines 10, 12 can be seen passing though the sleeve 24 such that the adhesive material or flowable polymer or other flowable material can be injected into the space between the sleeve and the line segments 10, 12 so as to join the line segments 10, 12 together as described with respect to the embodiment of FIGS. 1A-1C. Again, upon setting of the adhesive material or flowable polymer or other flowable material, the sleeve 24 can simply be removed, leaving the line segments 10, 12 joined together by the set adhesive or flowable polymer or other flowable material. Alternatively, if desired, sleeve 24 can remain part of the bonding construct. If desired, line segments 10, 12 can be spaced from one another within sleeve 24 or may be in engagement with one another within sleeve 24.

It will be appreciated that the line segments 10, 12 can be of differing diameters and still be efficiently and strongly joined together with the use of the present invention and, as will be appreciated, the use of differing diameter lines, or lines having different materials, can be joined by means of the various embodiments disclosed and explained in the present specification.

In addition, as is true of the line segments 10, 12, and as well as other embodiments shown herein, the bonding process may be enhanced by some treatment of the relevant portions of the line segments, either chemical or mechanical, so as to make the ultimate joint stronger. The chemical enhancement may be by etching the ends of the lines, the mechanical enhancement may be by roughing the lines. The enhancement may also be effected by appropriate thermal processing.

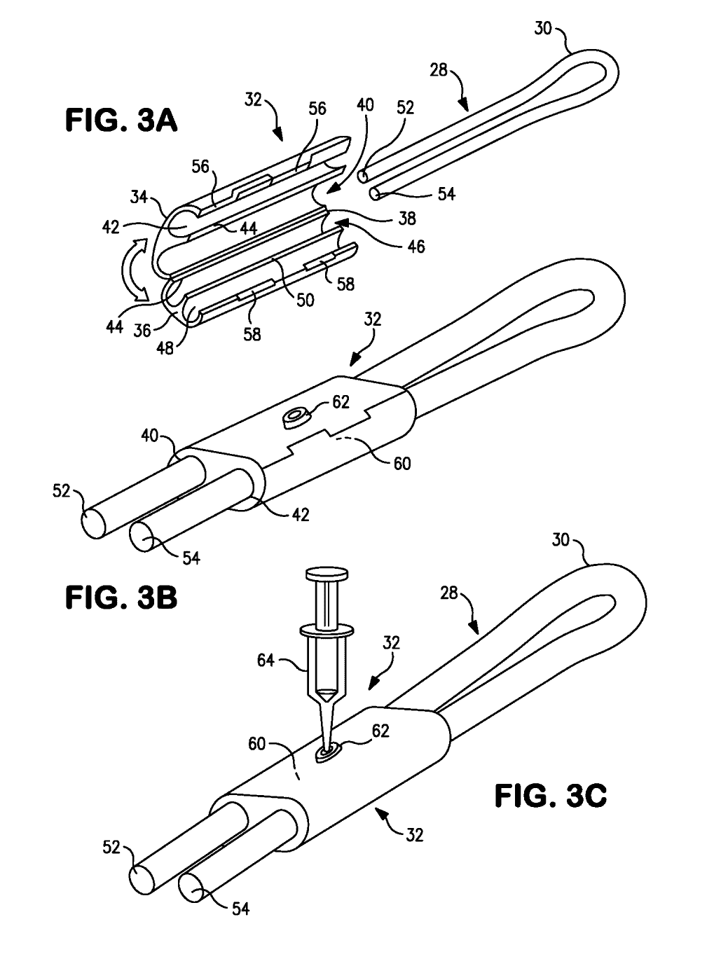

Turning next to FIGS. 3A-3C, there is shown perspective views of an exemplary embodiment of the present invention, wherein a single line 28 is used to form a loop 30 in which segments of the line 28 are secured together by an adhesive or flowable polymer or other flowable material construct. As will be appreciated, while a loop 30 is formed in this embodiment, the same invention can also be used to join two separate lines together.

In the embodiment of FIGS. 3A-3C, a clamshell encasement 32 is used. Clamshell encasement 32 comprises an upper section 34 and a lower section 36 joined together by means of a hinge 38. The hinge 38 may be a living hinge or other type of hinge so as to allow the upper section 34 and lower section 36 to be pivotally affixed to one another along one edge thereof.

As can also be seen in FIG. 3A, the upper section 34 has a pair of separate, semicircular channels 40, 42 formed therein, with a ridge 44 located therebetween; and, in likewise manner, the lower section 36 also has a pair of semicircular channels 46, 48 formed therein, with a ridge 50 located therebetween. In FIG. 3A, the clamshell encasement 32 is shown in its open position, such that the two separate segments 52, 54 of the single line 28 can be oriented within the aligned channels 40, 42 of upper section 34 and the aligned channels 46, 48 of lower section 36, whereby to retain the segments 52, 54 securely within the clamshell encasement 32.

A set of tabs 56 on the upper section 34 latches with a pair of recesses 58 formed on the lower section 36 so that the upper and lower sections 34, 36 can latch together, whereby to secure the clamshell encasement 32 in its closed position as shown in FIG. 3B, however, various alternative devices and latches can also be used to secure the clamshell encasement 32 in the closed position.

As such, with the clamshell encasement 32 in the closed position shown in FIG. 3B, the respective channels 40, 42 and 46, 48 surround the separate segments 52, 54 of the line 28 and form a seal between the line 28 and the separate segments 52, 54 against the clamshell encasement 32, thereby forming a closed chamber 60 within the clamshell encasement 32. As also seen in FIG. 3B, there is an inlet 62 in the upper section 34 of the clamshell encasement 32 and its purpose will hereinafter be discussed.

Turning then to FIG. 3C, taken along with FIGS. 3A and 3B, there is a perspective view of the present invention and illustrating the use of a syringe 64 that is used to inject the adhesive material or flowable polymer or other flowable material into the closed chamber 60 so as to allow the adhesive material or flowable polymer or other flowable material to surround the line 28 and, when set, join the separate segments 52, 54 together via the adhesive or flowable polymer or other flowable material construct.

### Portable Hand-Held Line-Welding Device—First Construction

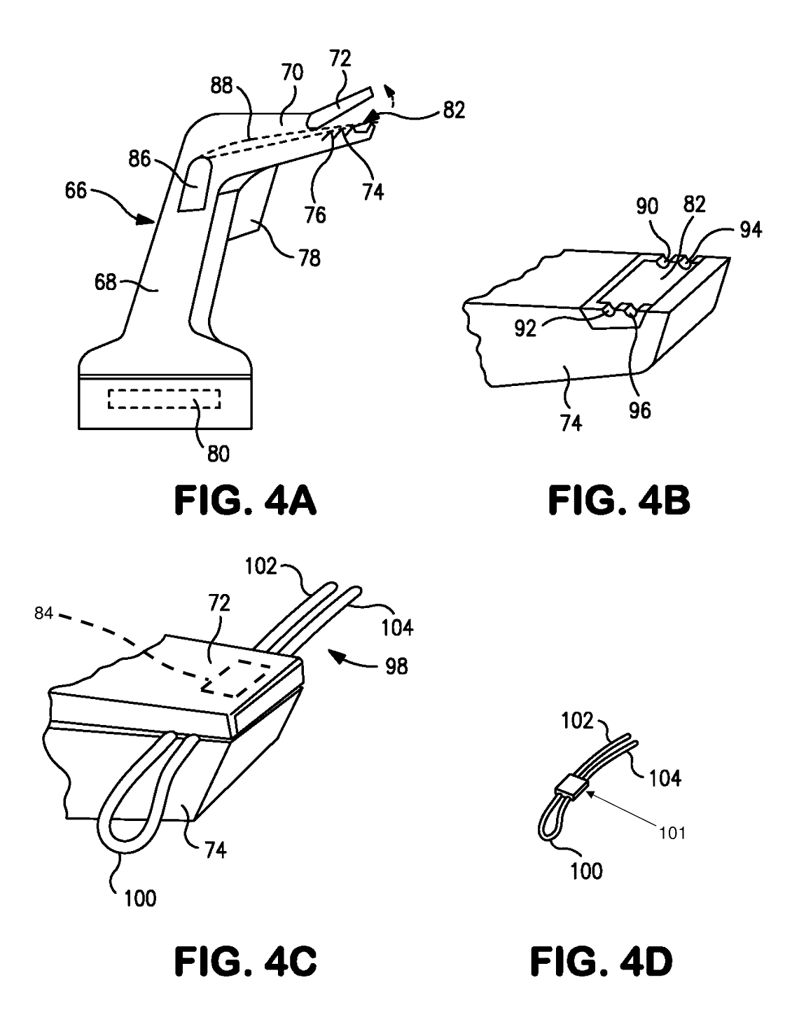

Turning next to FIGS. 4A-4D, there is shown perspective views of a portable hand-held device 66 that can be used to join two line segments together. Accordingly, in FIG. 4A, the hand-held device 66 is shown as having a handle 68 and a forward section 70 that extends laterally outwardly from the handle 68. The forward section 70 includes an upper jaw 72 and a lower jaw 74.

In the embodiment of FIG. 4A, the upper jaw 72 is pivotable between an open position (as shown in FIG. 4A) and a closed position where the upper jaw and lower jaw 72, 74 abut against each other (FIG. 4C). In this respect it should be appreciated that while only the upper jaw 72 is shown in FIGS. 4A-4D as movable or pivotable, in alternative embodiments the lower jaw 74 may be movable or, alternatively, both the upper and lower jaws 72, 74 can be movable. The opening and closing of the jaws 72, 74 may be accomplished manually or by means of some mechanism within the hand-held device 66.

In the embodiment of FIG. 4A, a heater 76, such as a resistance heater, is located in the lower jaw 74 for a purpose that will be later explained and, again, the heater 76 may be in the lower jaw 74, the upper jaw 72 or both the upper and lower jaws 72, 74. Control for the heater 76 may be by means of a trigger switch 78 located for the convenience of the user, with the power being supplied by one or more batteries 80 located in the handle 68. The batteries 80 may be disposable or conventional rechargeable batteries that can be recharged by a separate power source. Alternatively, the hand-held device 66 may be powered by a line cord (not shown) plugged into a receptacle on, for example, a boat.

As can be seen in FIGS. 4A and 4B, a cavity 82 is formed in the lower jaw 74 and, when the upper and lower jaws 72, 74 are closed together, there is formed a closed chamber 84 (FIG. 4C) therebetween that includes the cavity 82. A source of adhesive material or flowable polymer or other flowable material can be provided in a reservoir 86 located in the hand-held device 66, such as within the handle 68, that can be forced through a supply line 88 to inject the adhesive material or flowable polymer or other flowable material into the closed chamber 84. Alternatively, the adhesive material or flowable polymer or other flowable material can be supplied from an external source.

Turning then to FIG. 4B, there is shown an enlarged perspective view of the lower jaw 74 and illustrating the cavity 82 formed therein. As can be seen in FIG. 4B, there are two sets of grooves, that is, there is a first set 90, 92 and a second set 94, 96, that are parallel, spaced-apart, and provide a means of accurately orienting lines along the lower jaw 74 such that the lines span the cavity 82 in parallel, spaced-apart relation.

Turning then to FIG. 4C, taken along with FIGS. 4A and 4B, there is shown the upper and lower jaws 72, 74 in their closed position, thereby forming the closed chamber 84. In this embodiment, there is a single line 98 that forms a loop 100 such the two separate line segments 102, 104 of the line 98 pass though the closed chamber 84 and the separate line segments 102, 104 are aligned within the grooves 90, 92 and 94, 96 such that the line segments 102, 104 are held in a parallel orientation while separated from each other.

The adhesive material or flowable polymer or other flowable material is then injected into the cavity 82 of the closed chamber 84 so as to surround and encase the line segments 102, 104 of the line 98. By way of example but not limitation, adhesive material or flowable polymer may be advanced from reservoir 86, through supply line 88 and into closed chamber 84 for heating by heater 76, so that the adhesive material or flowable polymer flows about line segments 102, 104 in closed chamber 84. Once the adhesive material or flowable polymer has been properly disposed around, and between, line segments 102, 104, heater 76 can be turned off so that the adhesive material or flowable material sets. Once the adhesive material or flowable polymer or other flowable material properly sets, the upper and lower jaws 72, 74 can be opened and the line 98 removed, with the set adhesive material or flowable polymer forming a solid structure (e.g., a sheath or sleeve) 101 (FIG. 4D) that fully joins the line segments 102, 104 together, sealing the loop 100.

It can be seen that the adhesive material or flowable polymer or other flowable material can comprise a wide variety of adhesives and flowable polymers or other flowable material that can join the line segments. Thus, in an alternative embodiment, the adhesives or polymers or other flowable material may be molded around the line segments as a flowable fluid or mass that then can be activated by a number of setting mechanisms. By way of example but not limitation, the present invention may utilize UV-activated adhesives with a UV light provided within the jaws 72, 74 to carry out the curing, or the adhesive material may be a multi-component adhesive such as an epoxy material.

Furthermore, while a loop 100 is illustrated in the embodiment of FIGS. 4A-4D, it will be appreciated that the same hand-held device 66 can be used to simply join two or more line segments (of the same or discrete lines) together, and the line segments may be of differing diameters or materials. Also, the hand-held device 66 can be used to secure at least one hook and/or other component to a single line segment or to multiple line segments. Due to the encapsulation capabilities of the present invention, the resulting molded sheath (or sleeve) 101 may also be configured by the geometry of the molding chamber to cover the eyelet of the hook or other component.

Thus it will be seen that with the embodiments of FIGS. 1A-1C, 2A and 2B, 3A-3C and 4A-4D, the line segments which are to be secured together are positioned within a mold or cavity, then an adhesive or flowable polymer or other flowable material is introduced into the mold so that the adhesive or flowable polymer or other flowable material flows around the line segments within the mold, and then the adhesive or flowable polymer or other flowable material is set so as to form a solid construct (e.g., a sheath or sleeve) which secures the line segments to one another.

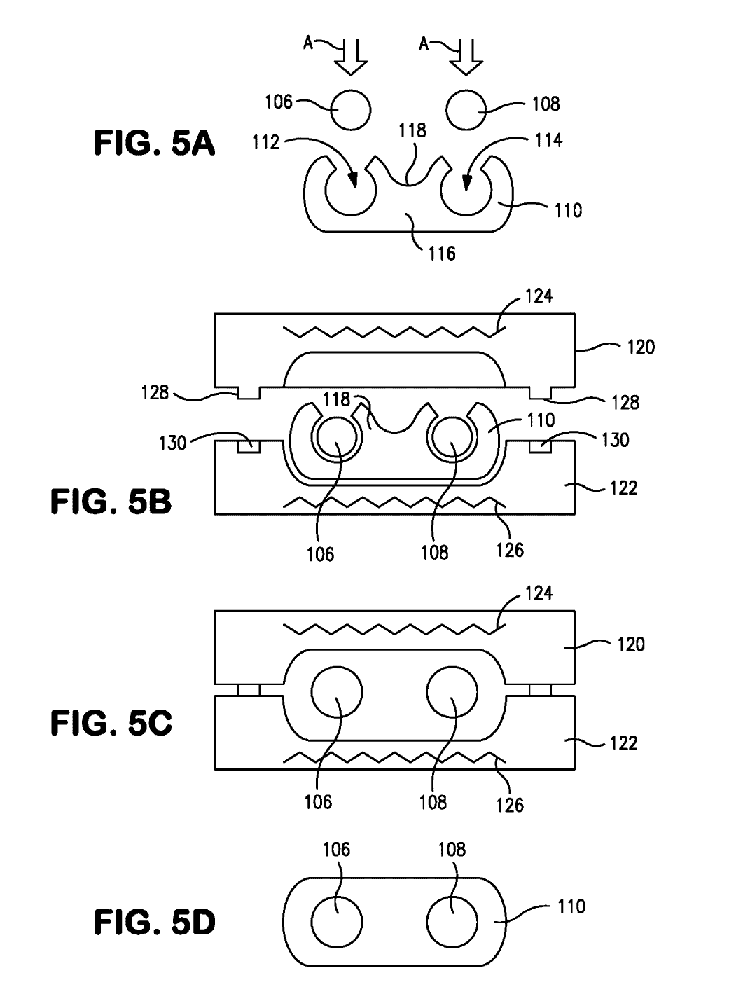

Turning next to FIGS. 5A-5D, there is shown schematic views illustrating another exemplary embodiment of the present invention that uses a meltable material, e.g., a flowable polymer, to carry out the joining of two or more line segments. In FIG. 5A, there can be seen two line segments 106, 108 in position to be fitted, by movement in the direction of the arrows A, into a pre-formed polymer sheath (or sleeve) 110. The pre-formed polymer sheath (or sleeve) 110 comprises a material that has a melting temperature that is lower than the melting temperature of the line segments 106, 108, and is configured so as to have two circular indentations 112, 114 dimensioned to receive and retain the line segments 106, 108, with the line segments 106, 108 being separated by a center portion 116.

The material for the pre-formed polymer sheath (or sleeve) 110 can preferably be any material that has a lower melting (or glass transition) temperature than the line segments 106, 108 and, upon melting, the melted polymer sheath (or sleeve) 110 surrounds and fully encases the line segments 106, 108 so as to join them together chemically and/or mechanically. The polymer sheath (or sleeve) material may be formed out of a fully biodegradable material.

In this form of the invention, the pre-formed polymer sheath (or sleeve) 110 comprises an upper portion 118 that provides an excess of material, the purpose of which will be discussed below. Turning next to FIG. 5B, there is shown a schematic view of the line segments 106, 108 and the pre-formed polymer sheath (or sleeve) 110 positioned within an upper housing 120 and a lower housing 122. While the upper and lower housings 120, 122 are illustrated to be two separate housings, it will be appreciated that the upper and lower housings 120, 122 can be hinged together, e.g., in the manner of the upper and lower jaws 72, 74 of FIG. 4A. As such, while this embodiment will be described as using housings, the steps of FIGS. 5A-5D may also be carried out using a hand-held device similar to the hand-held device 66 of FIG. 4A.

The upper and lower housings 120, 122 include, like the upper and lower jaws, 72, 74 of FIG. 4A, respectively, an upper heater 124 and a lower heater 126 that can be activated by a user so as to provide the heat needed to melt the pre-formed polymer sheath (or sleeve) 110, i.e., so that it may be molded about line segments 106, 108. In FIG. 5B, the upper and lower housings 120, 122 are in their open position and there may be male keys 128 and corresponding female recesses 130 to align the housings 120, 122 as they are moved toward the closed position of FIG. 5C. Again, as described with respect to the embodiment of FIG. 4A, while an upper and lower heater 124, 126 is disclosed in this embodiment, there may be a heater in only one of the upper or lower housing 120, 122 in carrying out the present invention.

Thus, in FIG. 5C, the upper and lower heaters 124, 126 have been activated to melt the polymer material of the pre-formed polymer sheath (or sleeve) 110, such that the material of the polymer sheath (or sleeve) 110 flows over and between the line segments 106, 108, whereby to join those line segments together. As noted, the excess material of the pre-formed polymer sheath (or sleeve) 110 at the upper portion 118 of the pre-formed polymer sheath (or sleeve) 110 provides material sufficient to cover the upper surfaces of the line segments 106, 108 so that the line segments 106, 108 are fully encased in the material of the polymer sheath (or sleeve) 110.

The final result is illustrated in FIG. 5D, where the line segments 106, 108 are fully encased in the material of the polymer sheath (or sleeve) 110 such that they are securely joined together. The material of the polymer sheath (or sleeve) can also be provided in strips, pre-fabricated molds, microspheres, powder, fluid, pellets, sheets, polymer coated stents and the like in this embodiment and in other embodiments herein disclosed.

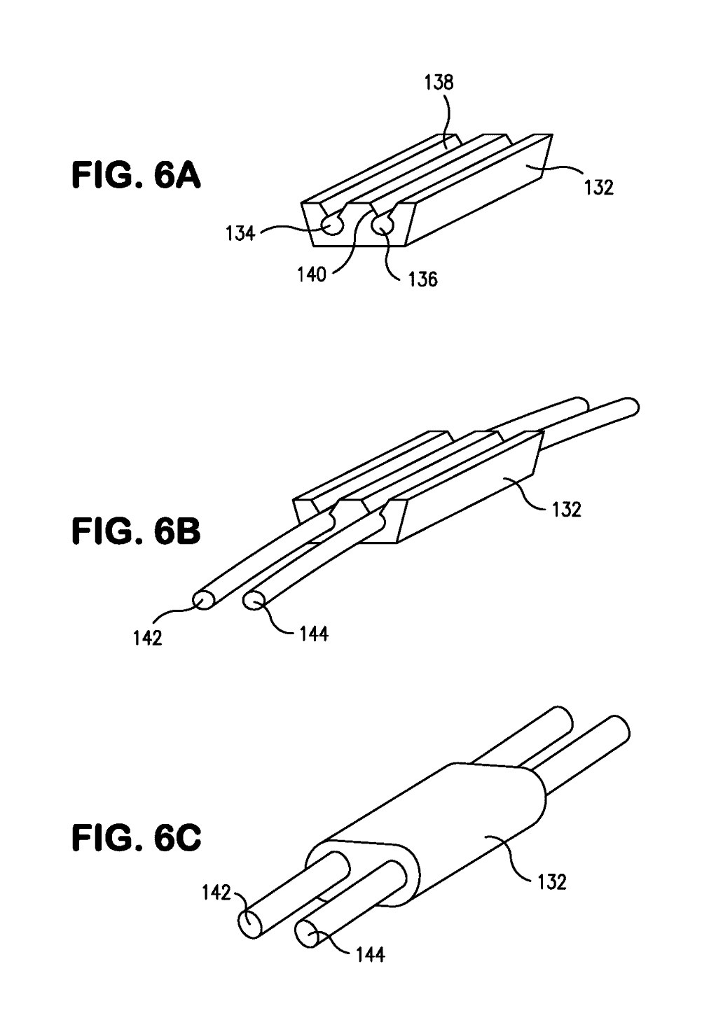

Turning next to FIGS. 6A-6C, there is shown a further exemplary embodiment of the present invention using a pre-formed polymer sheath (or sleeve) 132. Again, the pre-formed polymer sheath (or sleeve) 132 has a pair of channels 134, 136 formed therein for receipt and securement of line segments 142, 144, with the channels 134, 136 being cylindrical in shape with V-shaped entries 138, 140 so that line segments 142, 144 can be simply snapped into the channels 134, 136, separate from each other and retained therein.

Thus, in FIG. 6B, the line segments 142 and 144 have been snapped into position within the channels 134, 136 where they are retained therein. Again, there is an application of heat (not shown) that may be supplied by a clamshell encasement of the type shown in FIG. 3A-3C, 4A-4D, or 5A-5D, or by other heating means, and the pre-formed polymer sheath (or sleeve) 132 melted so as to surround the line segments 142, 144 and join them together. See FIG. 6C.

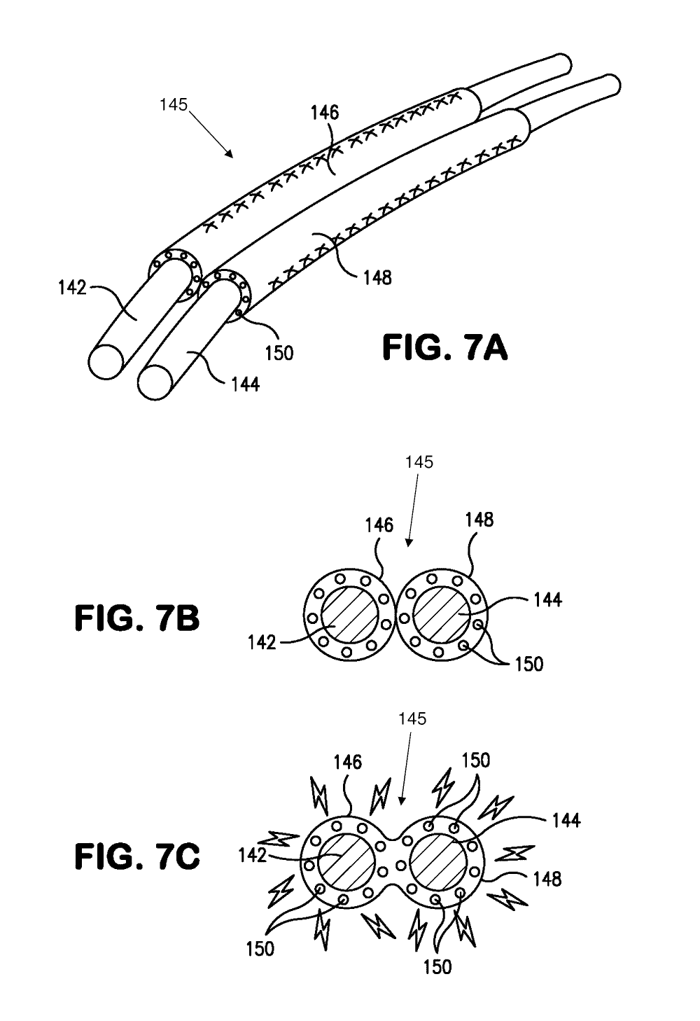

Looking next at FIGS. 7A-7C, there is shown a perspective view and cross-sectional views of a further exemplary embodiment of the present invention. In FIG. 7A, there can be seen a pair of line segments 142, 144 that are intended to be joined together. In this embodiment of the invention, the line segments 142, 144 are encircled by a pre-formed meltable polymer construct 145 that comprises at least two pre-formed polymer sheaths (or sleeves) 146, 148, such that the polymer melts at a temperature that is lower than the melting temperature of the line segments 142, 144. The pre-formed polymer sheaths (or sleeves) 146, 148 can have reinforcing braids 150 within the material of the pre-formed polymer sheaths (or sleeves) 146, 148 so as to strengthen the material (and hence the final construct).

As seen in FIG. 7B, the braided material of the pre-formed polymer sheaths (or sleeves) 146, 148 encircles the line segments 142, 144 as they extend alongside each other awaiting the heating step. In FIG. 7C, the polymer of the pre-formed sheaths (or sleeves) 146, 148 have been heated so that the meltable or flowable material of the pre-formed polymer sheaths (or sleeves) 146, 148 has melted and created a seal surrounding the line segments 142, 144, with the braids 150 embedded therein, thereby joining the line segments 142, 144 together in a junction with enhanced strength.

Thus it will be seen that with the embodiments of FIGS. 5A-5D, 6A-6C and 7A-7C, a pre-formed adhesive or flowable polymer (or other flowable material) sleeve is provided, the line segments which are to be joined are positioned in the pre-formed adhesive or flowable polymer (or other flowable material) sleeve, and then the pre-formed adhesive or flowable polymer (or other flowable material) sleeve is transformed (e.g., by the application of heat) so that some or all of the pre-formed adhesive or flowable polymer (or other flowable material) sleeve becomes flowable, whereby to cause the adhesive or flowable polymer (or other flowable material) to form an encasing structure about the line segments and thereby lock them in position relative to one another.

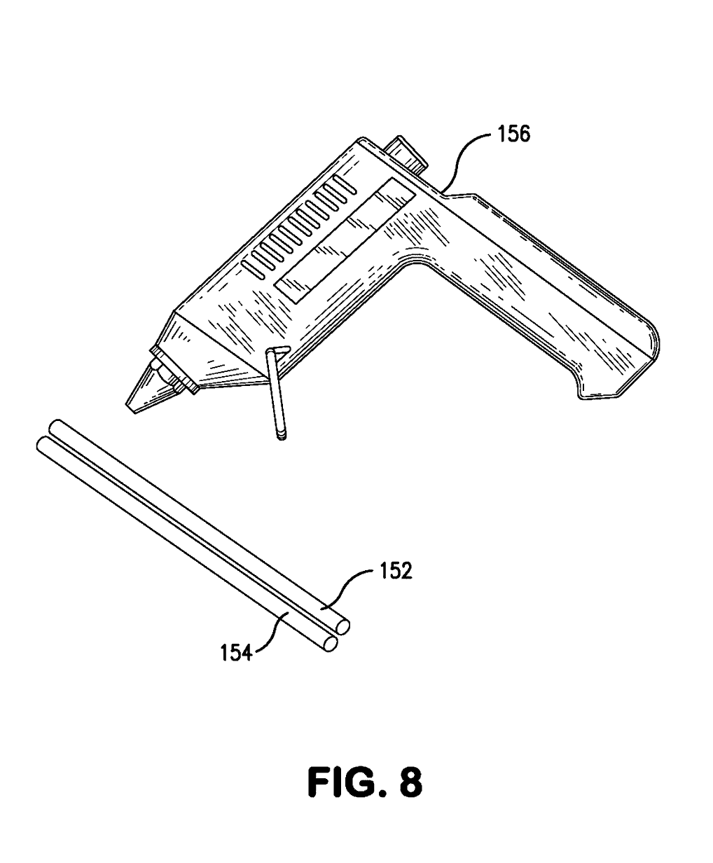

Turning next to FIG. 8, there is shown a side view illustrating a still further embodiment of the present invention wherein two line segments 152, 154 are being joined together with the use of a hand-held device 156 that melts an adhesive or flowable polymer (or other flowable material). Again, the particular adhesive or flowable polymer (or other flowable material) used in the hand-held device 156 is preferably selected so as to have a melting temperature that is lower than the melting temperature of the line segments 152, 154, such that the adhesive or flowable polymer (or other flowable material) can be laid along the junction of the line segments 152, 154 so as to join the line segments 152, 154 together.

It should also be appreciated that with this embodiment of the invention, the line segments 152, 154 may also be aligned in a pre-formed meltable or flowable polymer sheath (or sleeve), e.g., as illustrated in FIG. 6A, and a hand-held heater, similar to the device of FIG. 8, can be used to heat the polymer and melt the polymer so as to mold the sheath (or sleeve) about the line segments and thereby join the line segments together.

### Portable Hand-Held Line-Welding Device—Second Construction

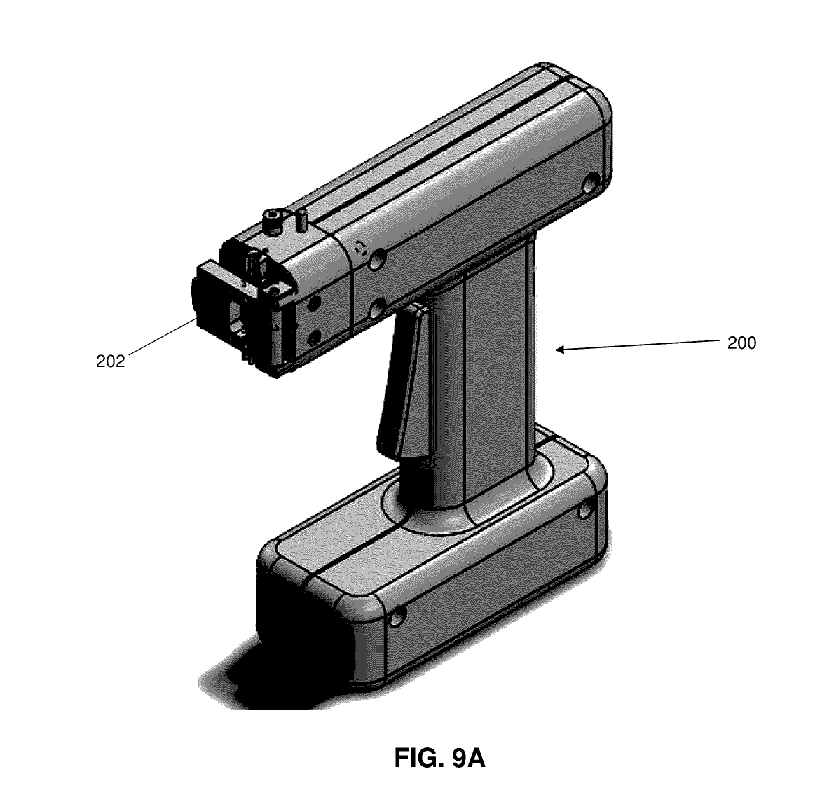

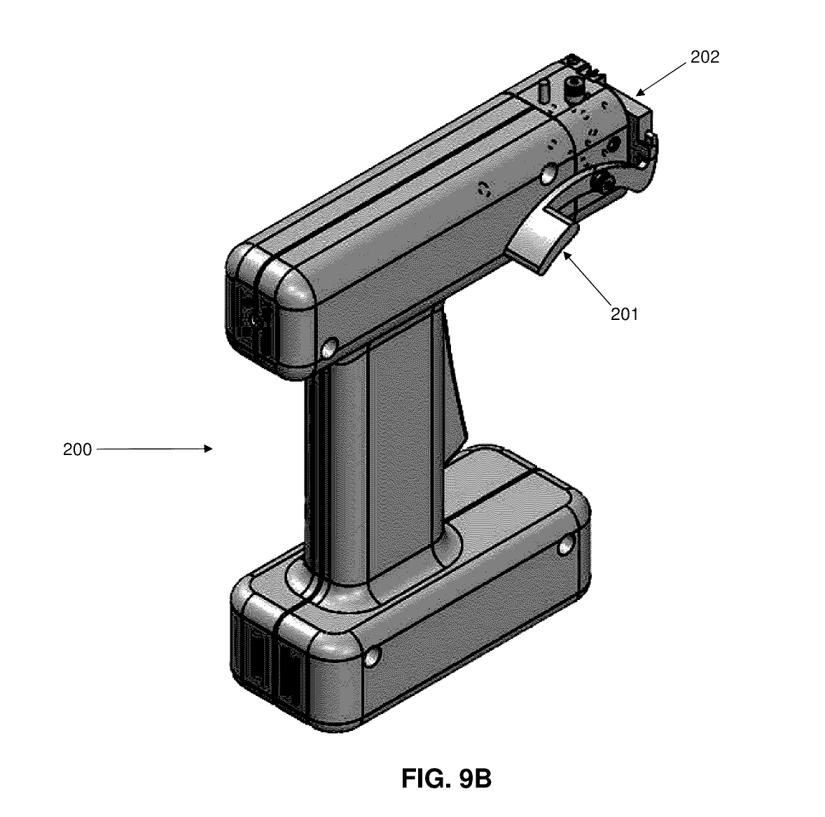

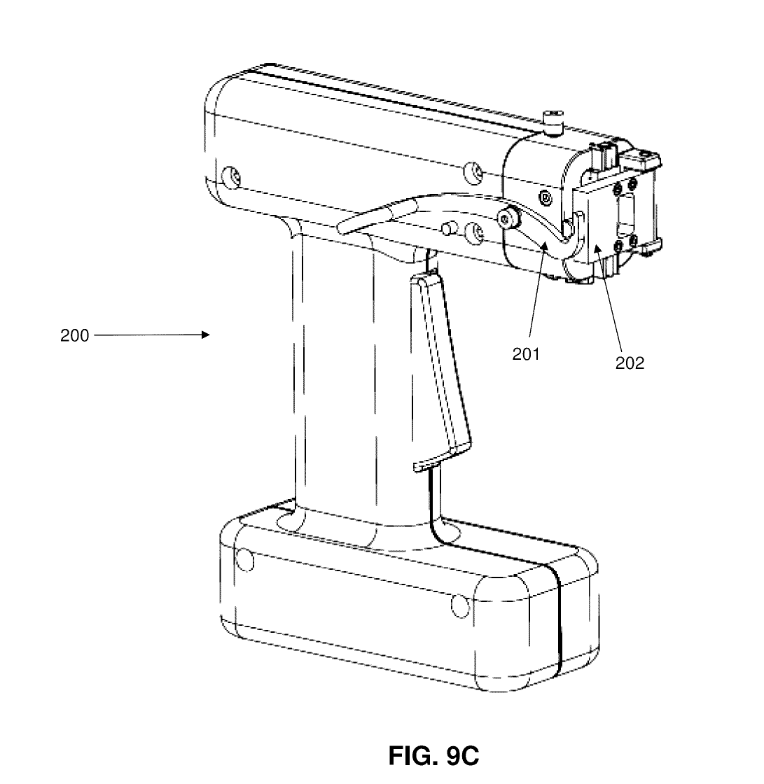

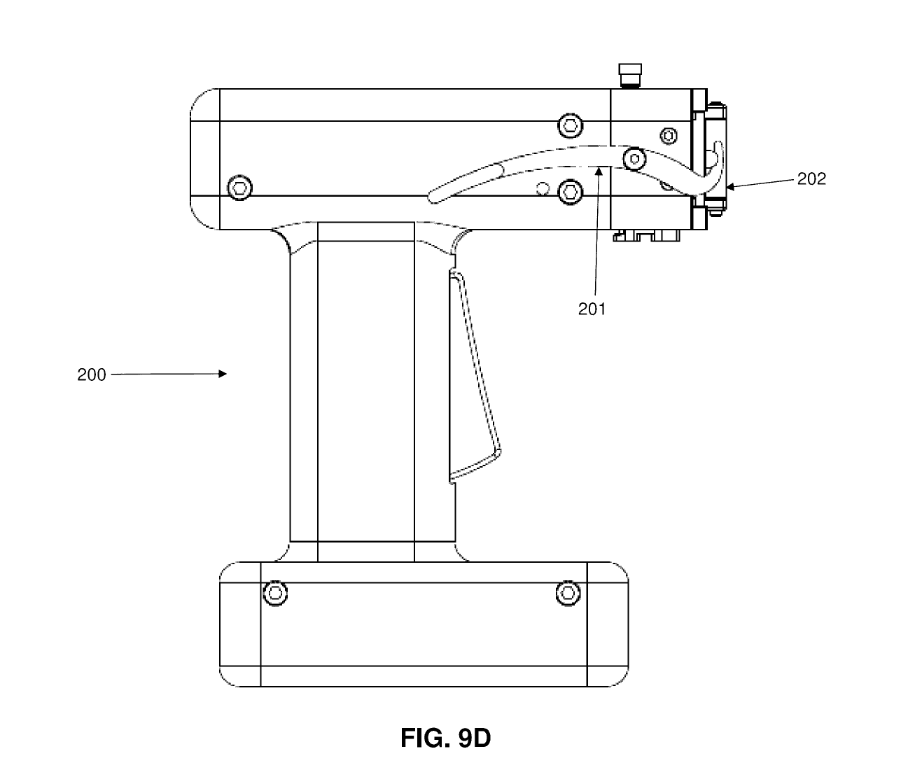

FIGS. 9A-9D show an alternative hand-held device 200 that molds a polymer sheath (or sleeve) fastener about a plurality of line segments so as to join those line segments together.

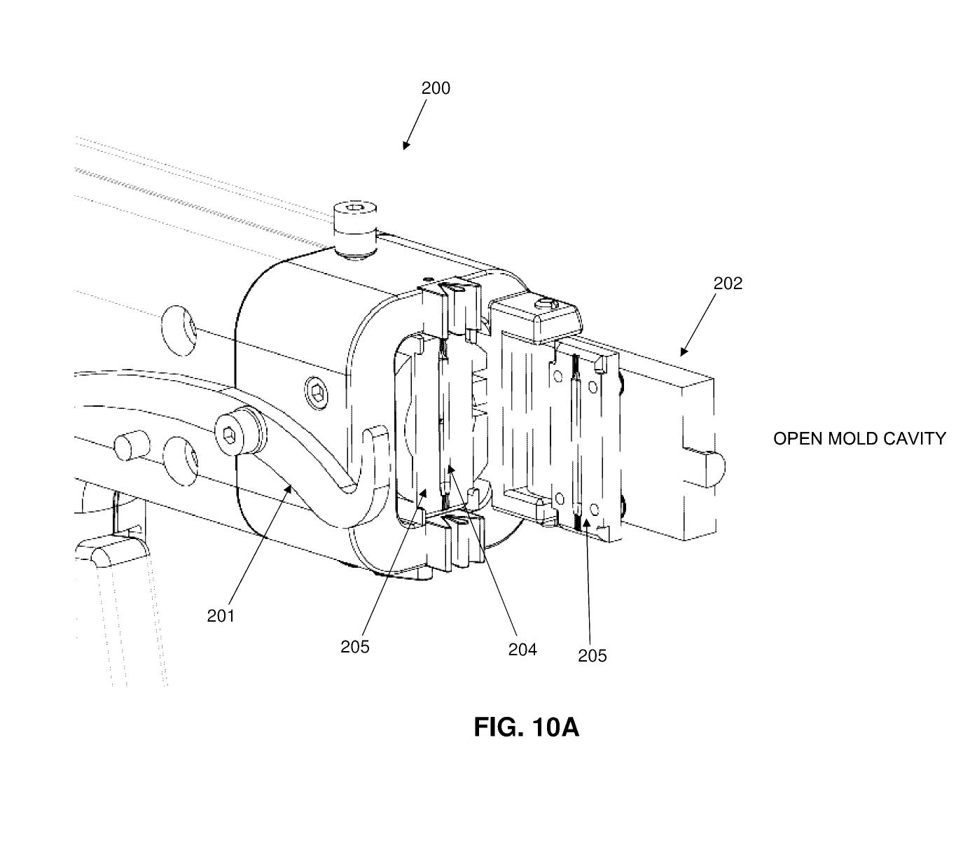

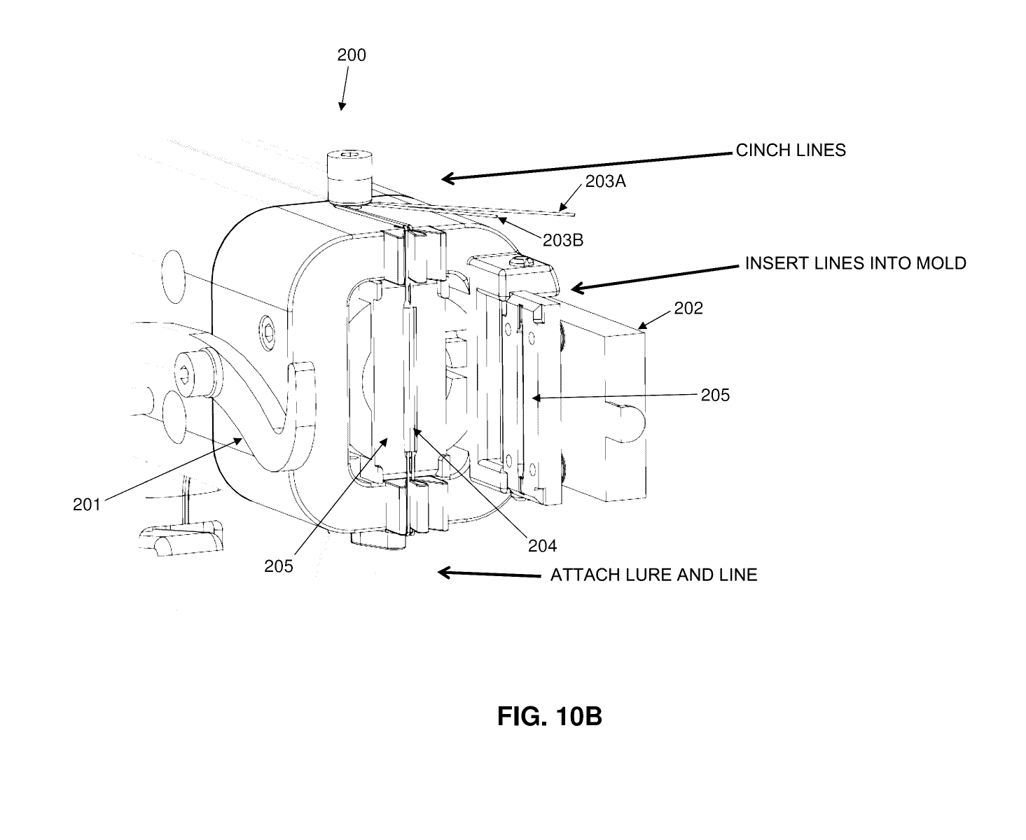

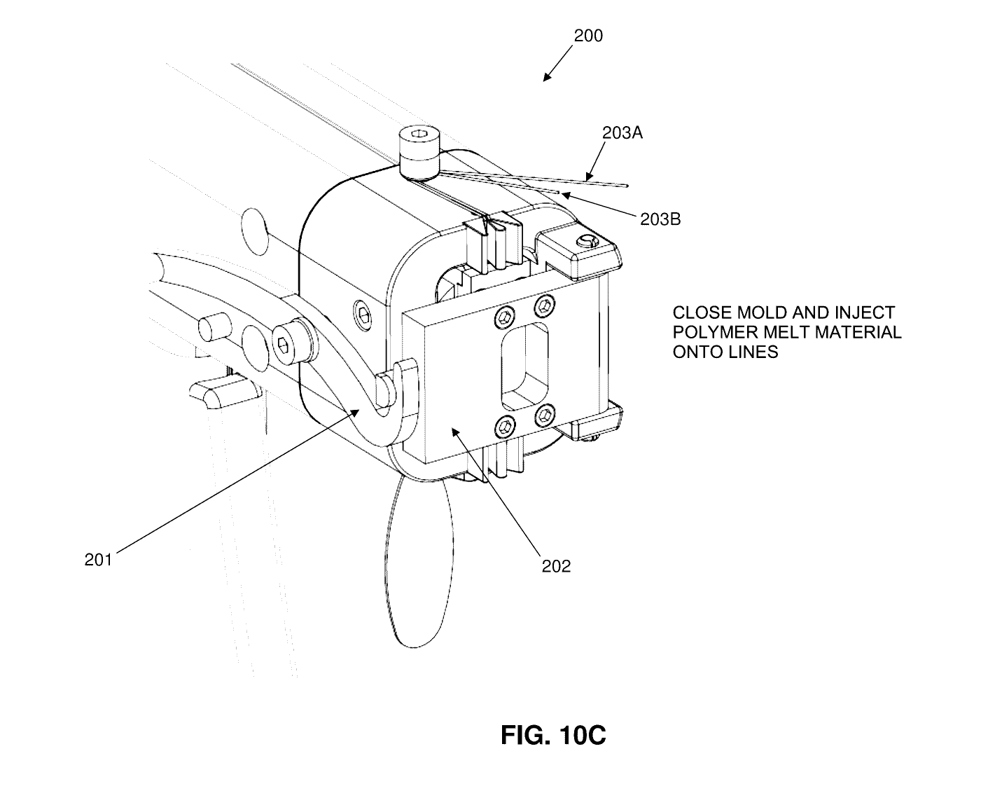

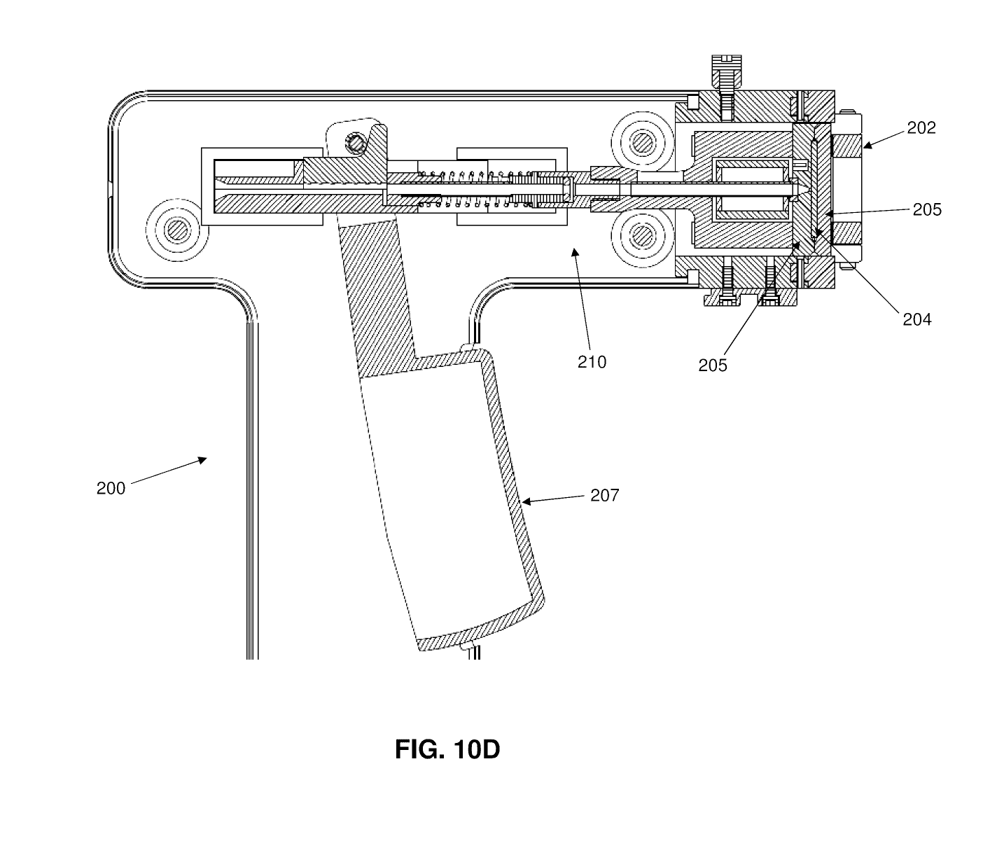

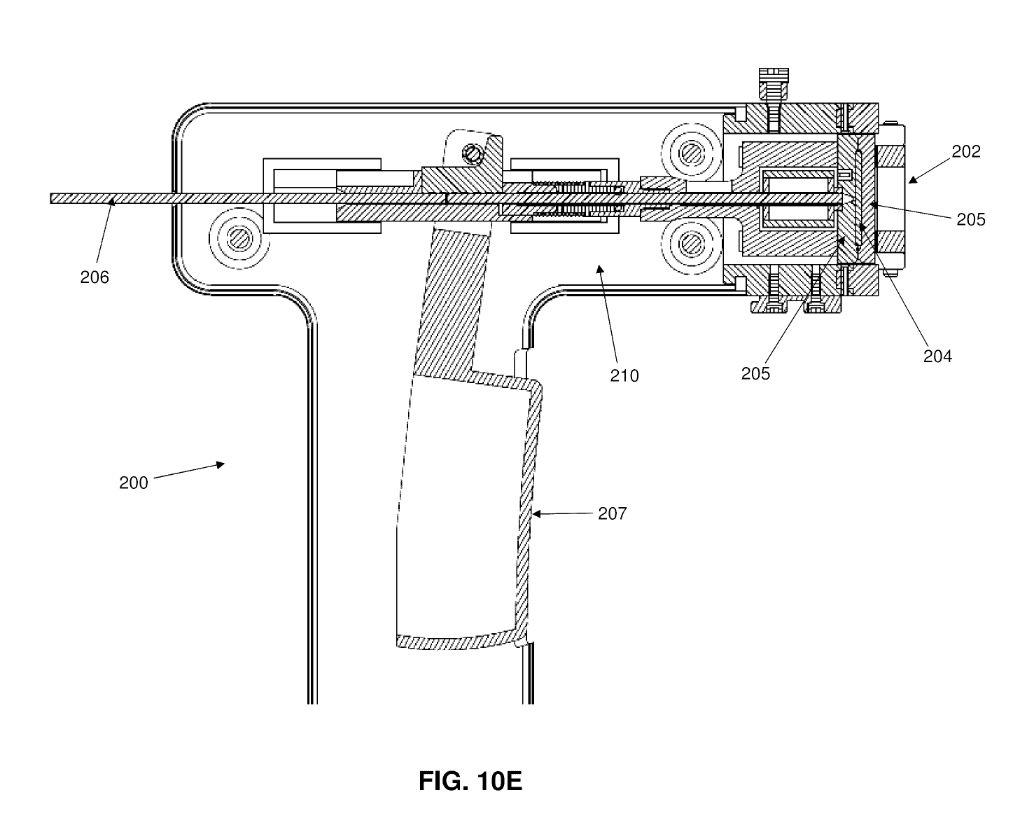

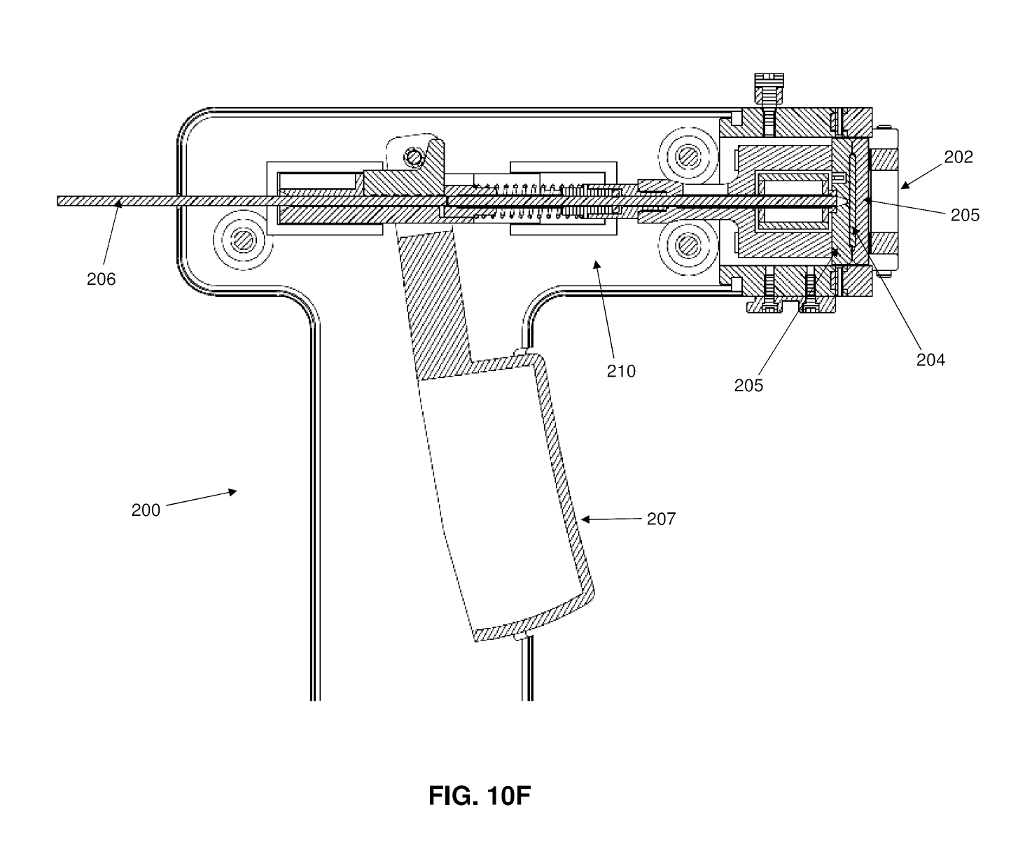

Looking now at FIGS. 9A-9D, and also 10A-10F, with hand-held device 200, a latch 201 is released so as to open a mold door 202 (FIG. 10A), line segments 203A, 203B are extended across the cavity 204 of a mold 205 (FIG. 10B), and then mold door 202 is closed (FIG. 10C). Then, as seen in FIGS. 10D-10F, a stick 206 of flowable polymer (or other flowable material) is loaded into hand-held device 200 and then trigger 207 is depressed, causing injection assembly 210 to inject or administer the flowable polymer into mold cavity 204, whereby to create, in situ, the polymer sheath (or sleeve) that encapsulates the line segments. Note that hand-held device 200 is configured so as to hold the line segments 203A, 203B spaced apart from one another so as to increase the bond strength between the polymer sheath (or sleeve) and the line segments. This bonding process and design does not impair the integrity of the line segments because it avoids crimping, compressing, deforming, or unwantedly abrading of the line segments, which has been shown to reduce the tensile strength of the joined line.

Note that, as shown in FIGS. 10A-10F, cleats, etc. may be provided on the hand-held device for keeping the lines (which are to be joined) taut as they extend through the mold, since it has been found that bonding taut lines can result in a stronger bond.

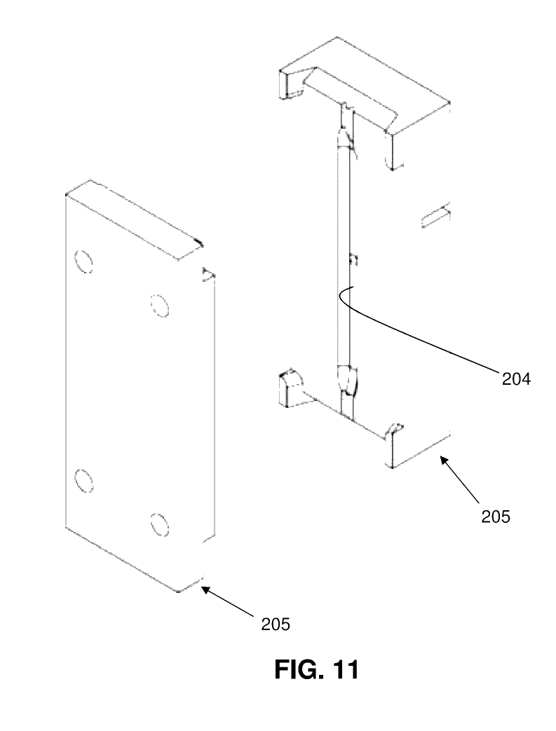

FIG. 11 shows details of the mold 205 which defines mold cavity 204 (and hence the configuration of the molded polymer sheath or sleeve).

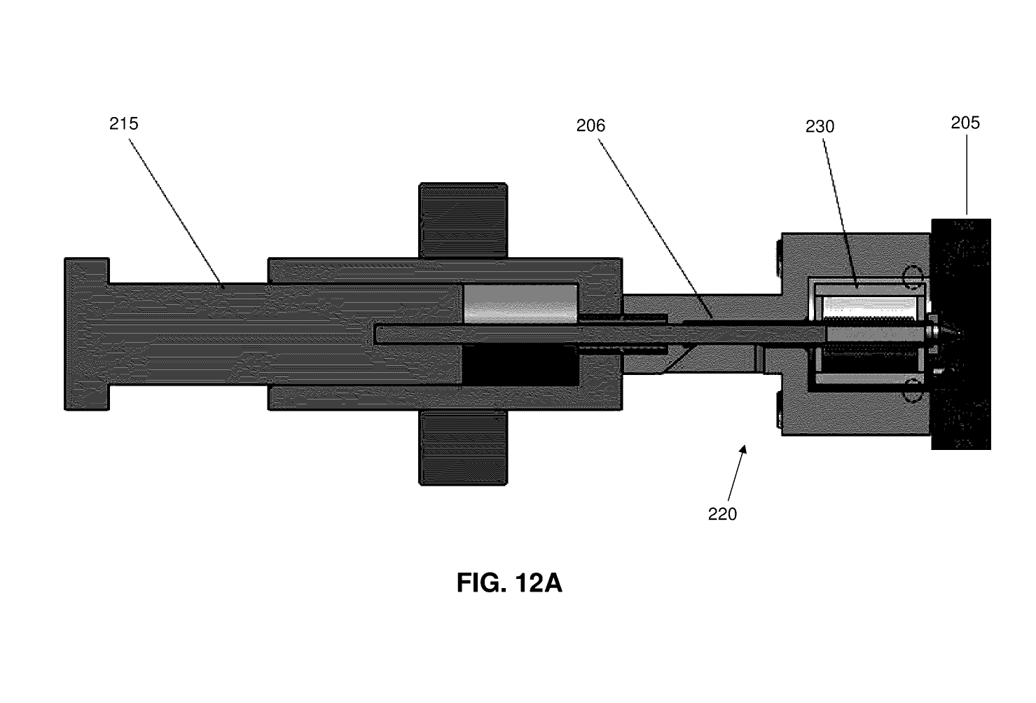

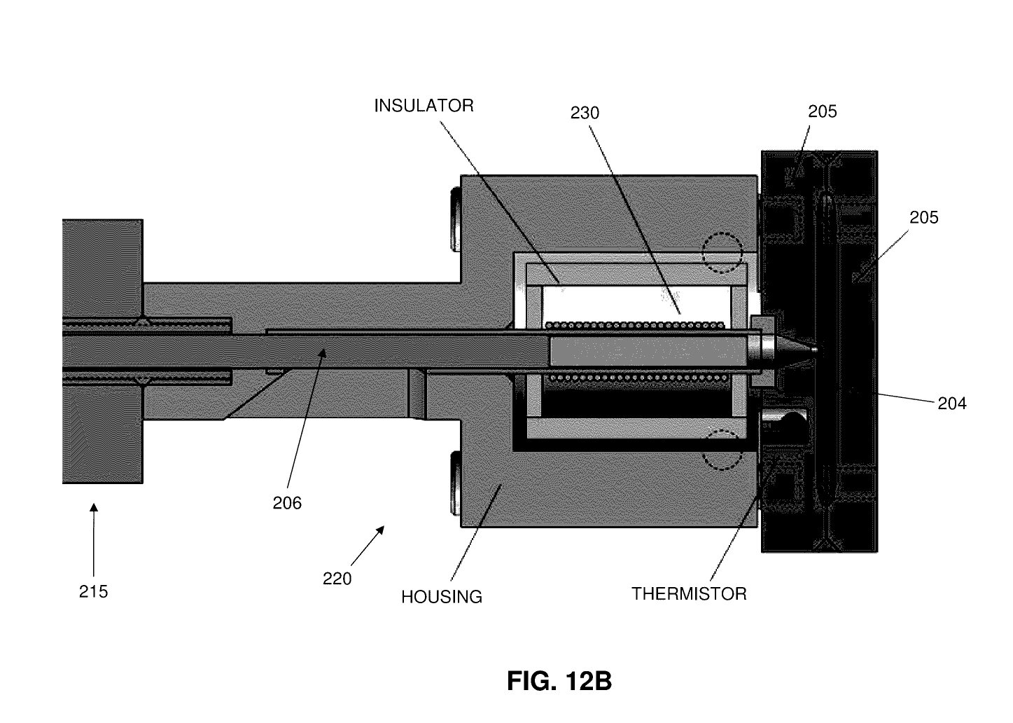

One preferred form of the injection assembly 210 of hand-held device 200 is shown in greater detail in FIGS. 12A and 12B. In this form of the invention, injection assembly 210 generally comprises a plunger mechanism 215 and an injector mechanism 220. The plunger mechanism 215 is used to advance the stick 206 of the flowable polymer material through the injector mechanism 220 such that a heater 230 in the injector mechanism is able to melt the flowable polymer so it can flow into and be molded in cavity 204 of mold 205, thereby encapsulating the line segments that are supported by mold 205 in a spaced orientation so as to create a resulting polymer sheath (or sleeve) that secures the line segments together.

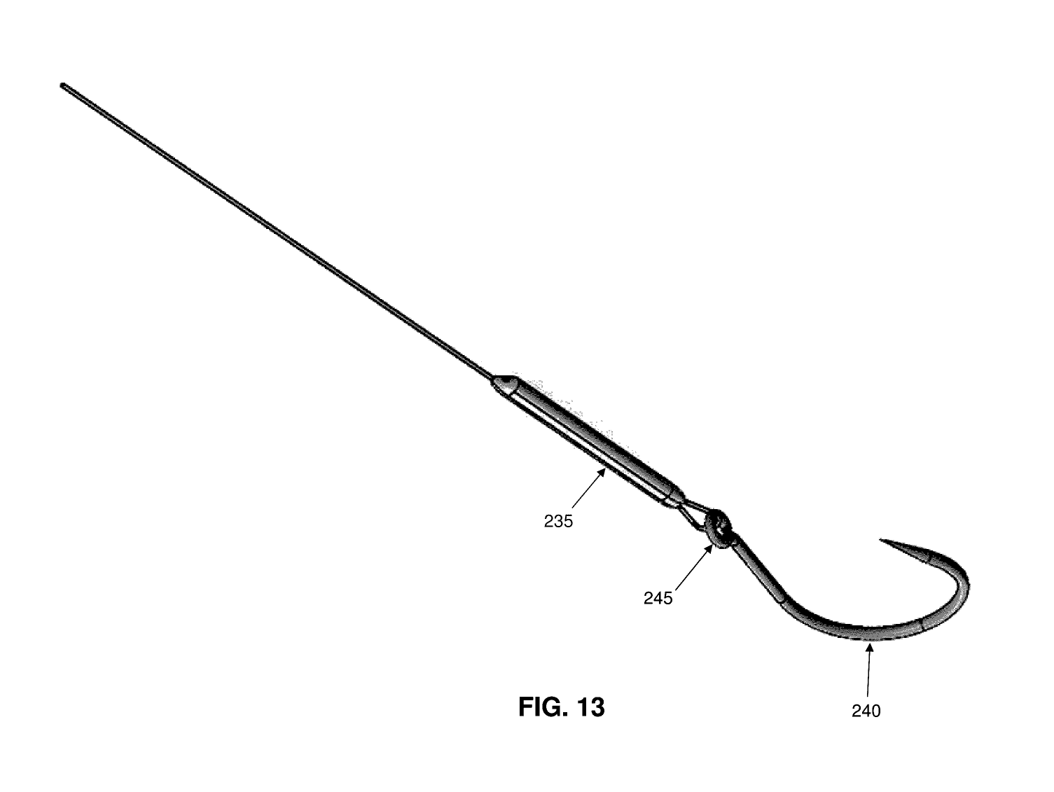

FIG. 13 shows a polymer sheath (or sleeve) 235 created by the hand-held device 200. In FIG. 13, the polymer sheath (or sleeve) 235 is shown being used to bond line segments that secure a fishing hook 240 (or other component), with the line being looped through an eyelet 245 in the hook (or other component).

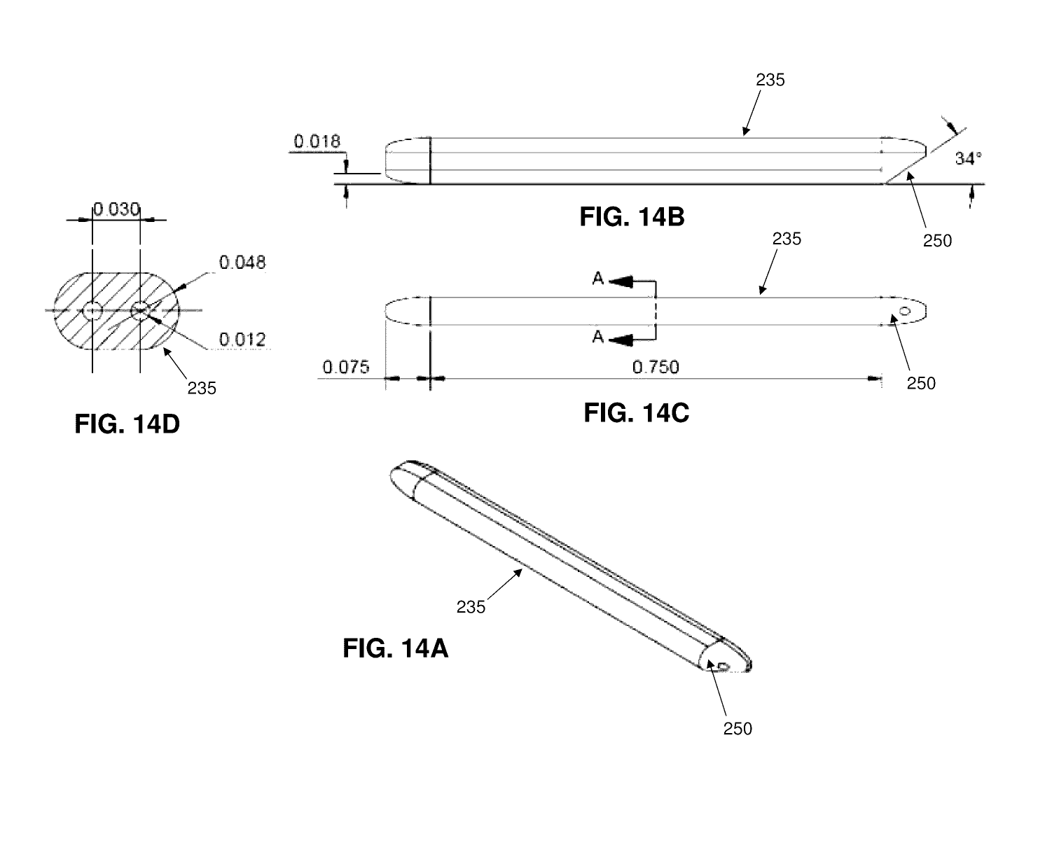

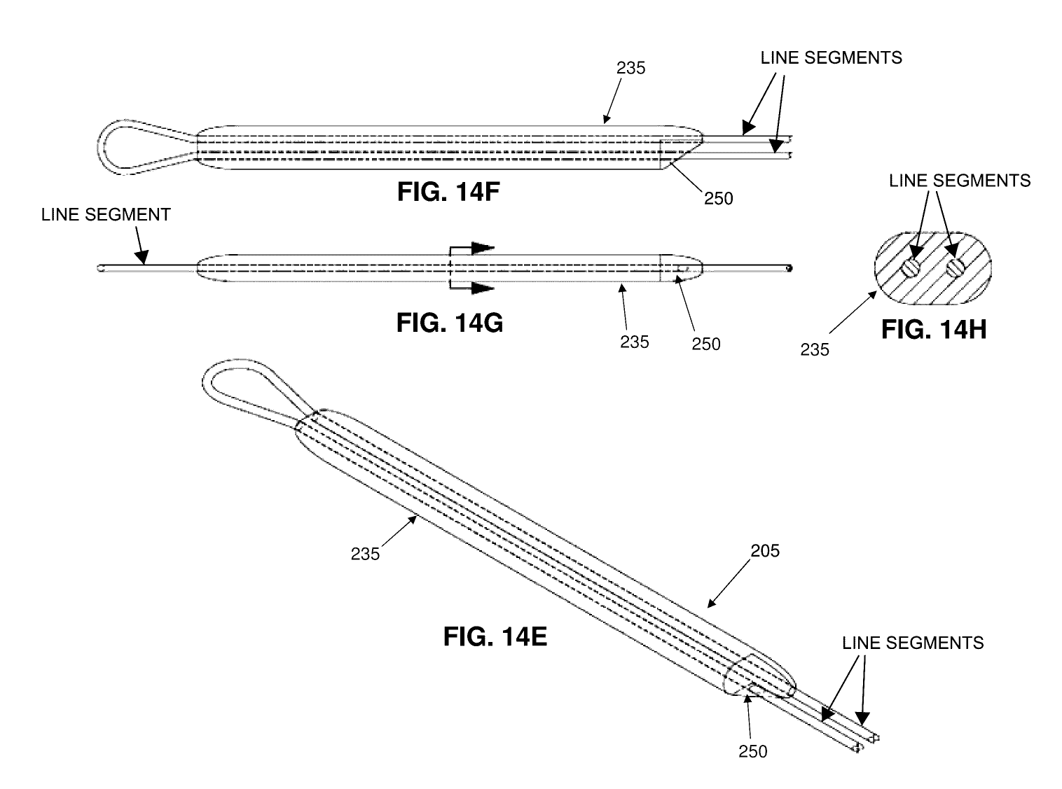

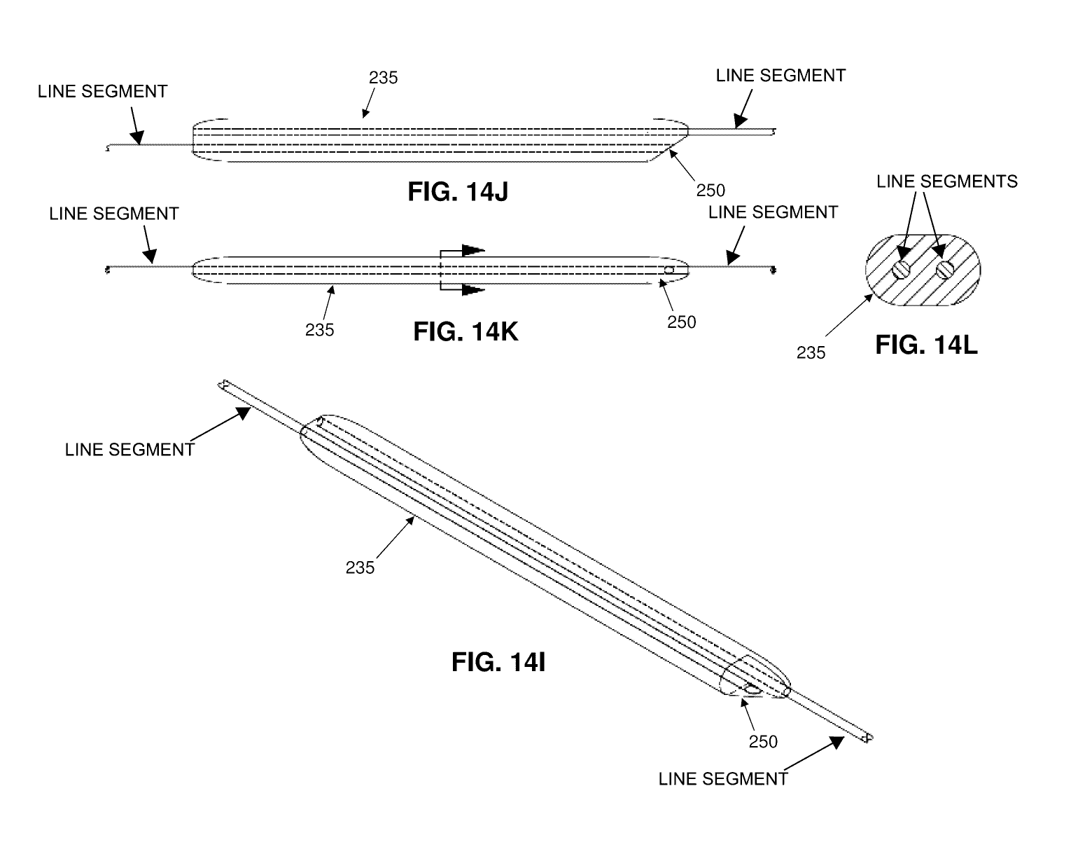

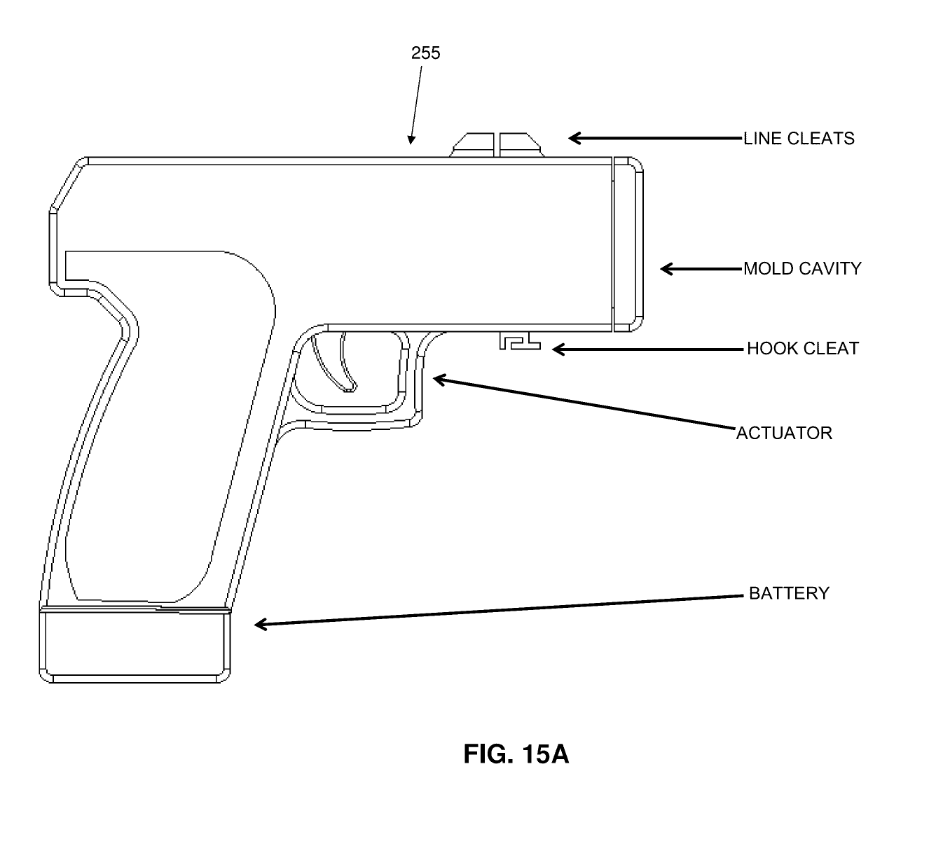

The polymer sheath/sleeve 235 may be fabricated with an elongated orientation as shown in FIGS. 14A through 141. In one preferred form of the invention, the polymer sheath (or sleeve) 235 holds the line segments in parallel, spaced-apart relation. In one preferred form of the invention, polymer sheath (or sleeve) 235 is beveled, e.g., as shown at 250, so as to facilitate passing polymer sheath (or sleeve) 205 through a constrained opening such as the eye of a fishing rod, and to minimize abrasion with line segments or other components, etc.

Alternatively, if desired, the line segments may be secured in the polymer sheath (or sleeve) with a non-parallel orientation, and/or multiple segments from a single line, or multiple lines, may be secured in the polymer sheath (or sleeve). In addition, the polymer sheath (or sleeve) may be used to secure a hook or other component directly to a line segment without having to loop the line. The polymer sheath (or sleeve) may also incorporate any other shape defined by the mold cavity 204 through which the line segments (and hook or other component, for embodiments in which a portion of the hook or other component are to be encapsulated) can be inserted. This geometry may consist of a T-shape (to position hooks orthogonal to the line segments) or any other shape to support the needs for mounting and configuring multiple lines in a non-linear orientation.

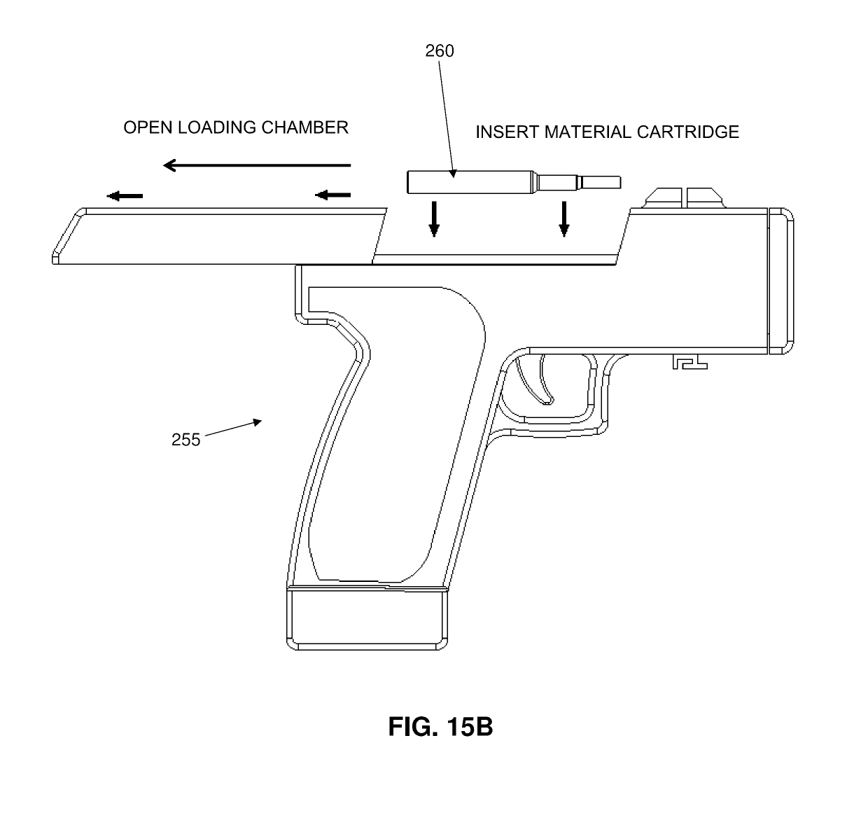

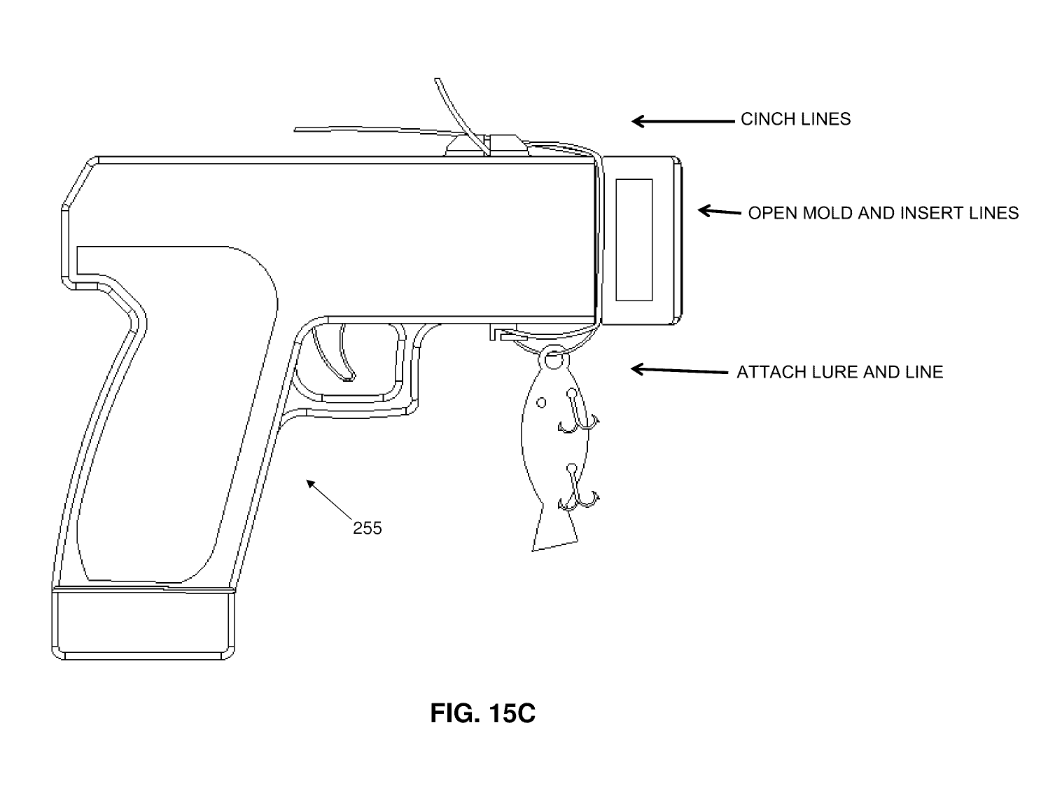

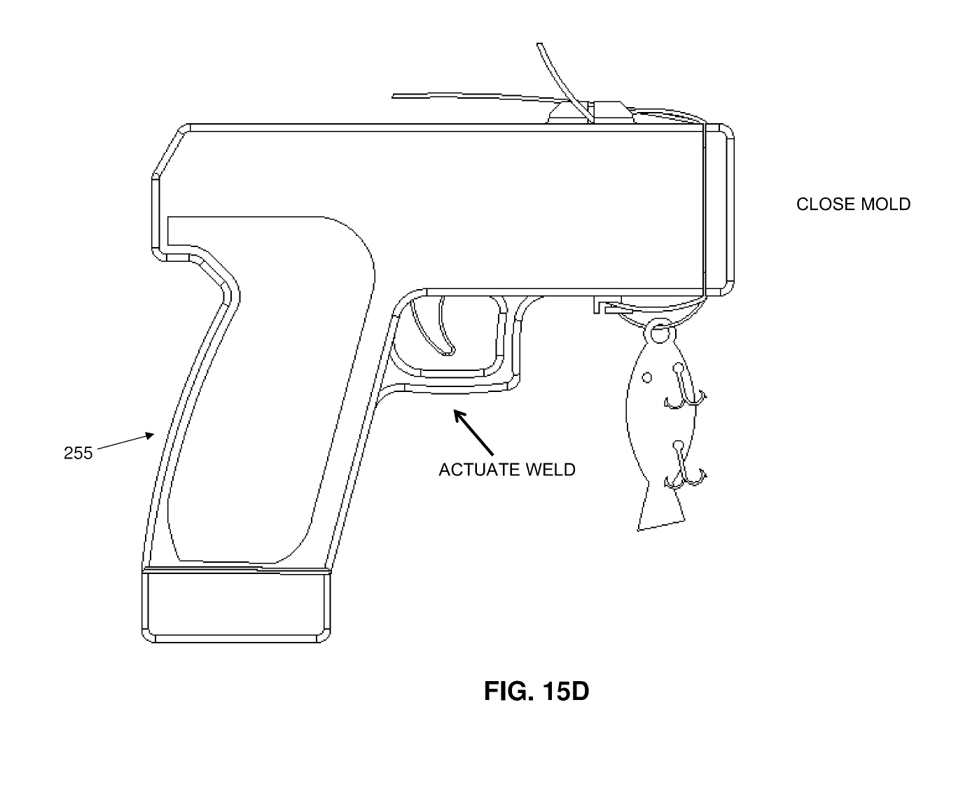

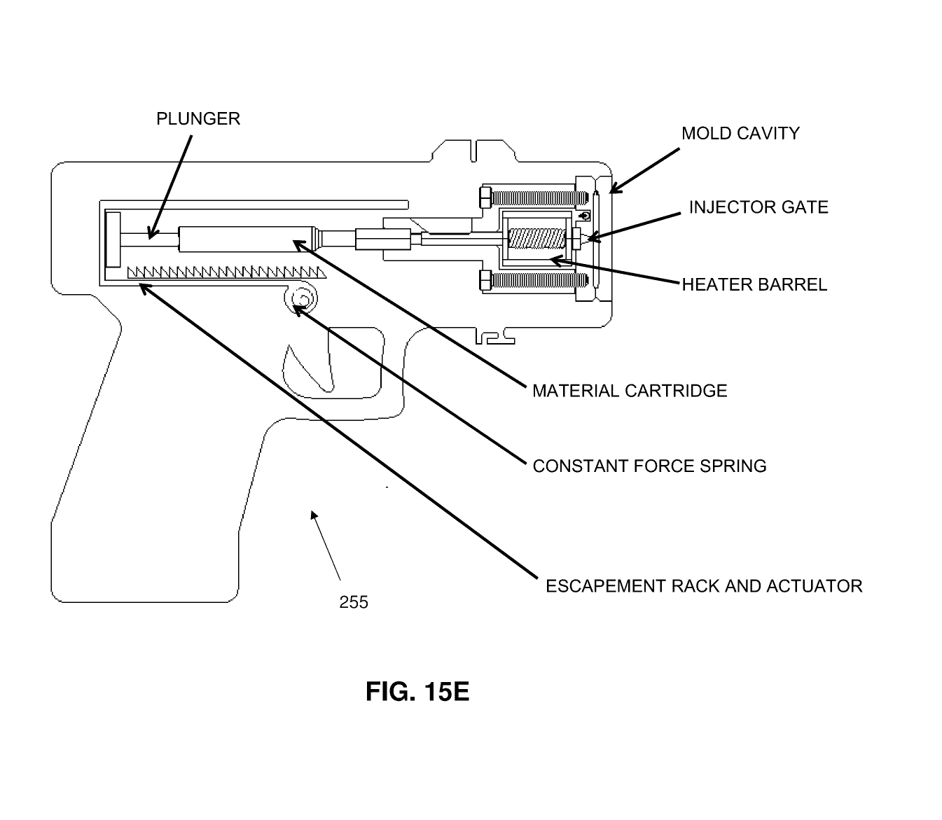

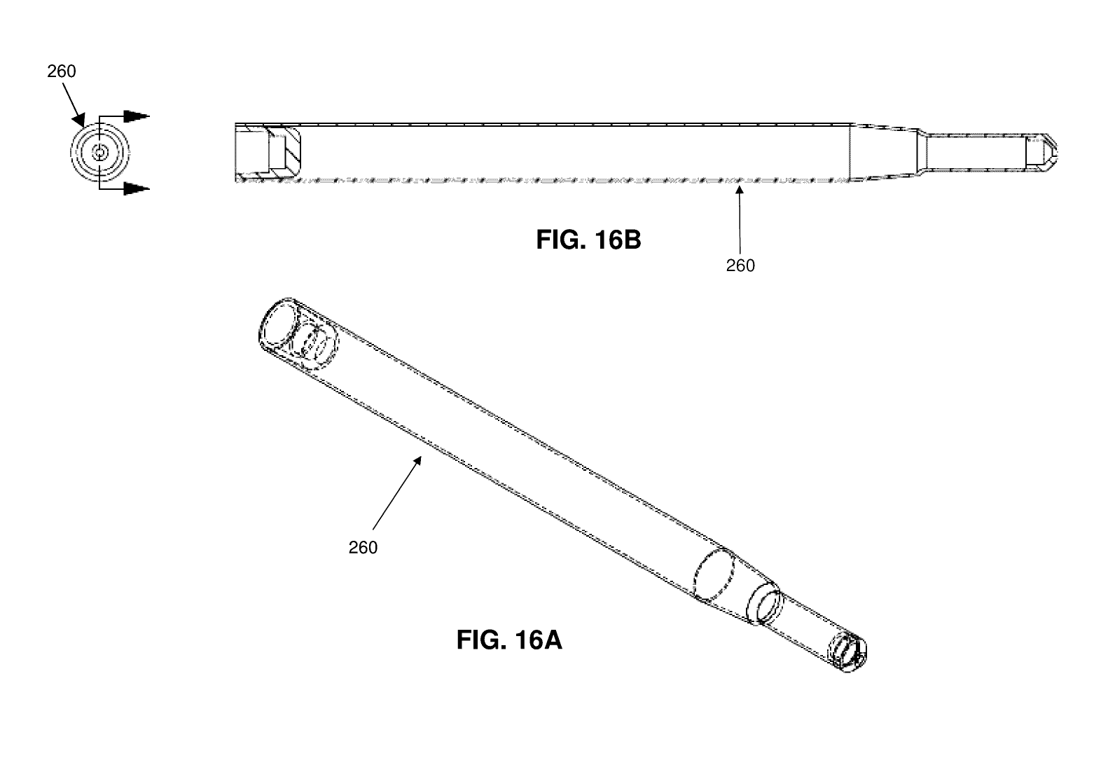

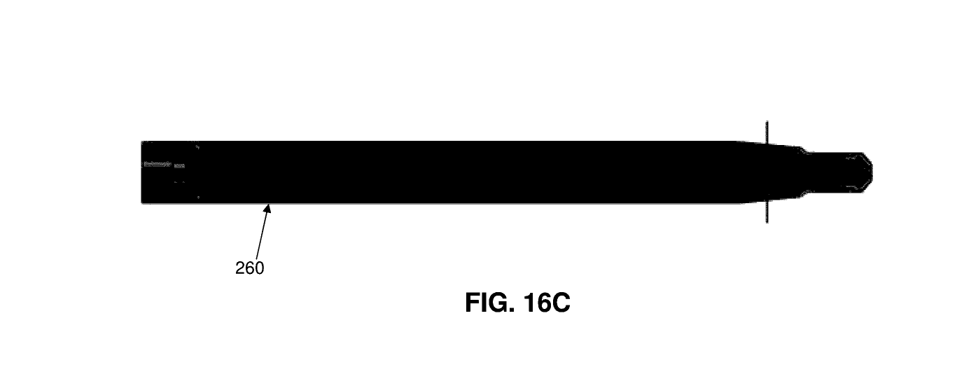

An alternative hand-held device 255, shown in FIGS. 15A to 15E and generally similar to the aforementioned hand-held device 200 except as otherwise stated, incorporates a polymer cartridge system for injecting polymer sheath material into a mold so as to secure line segments. A replaceable cartridge 260 for releasably containing the polymer, and for insertion into the hand-held device 255, is shown in FIGS. 16A-16C. The replaceable cartridge 260 can house the raw polymer material in the form of a fluid, powder, pellet, or solid. A plunger, compressible roller, or other mechanism may be used by hand-held device 255 to expel the raw polymer material out of the cartridge, through the injector mechanism 220, and into the mold cavity 204 of mold 205 so as to mold the polymer sheath (or sleeve) around the oriented line segments. The heater 230 may be used to melt the polymer raw material so as to facilitate injecting the polymer into the mold cavity, especially when the polymer is maintained as a powder, pellet or solid form in the cartridge 260. Alternatively, the cartridge 260 may incorporate an internal spring mechanism, or be pressurized, so as to enable the raw polymer material to be ejected out of cartridge 260 and into mold cavity 204 without requiring an actuating mechanism associated with the hand-held device 255. In those hand-held embodiments, heater 230 melts the raw polymer material to enable flowing the polymer material into the mold cavity 204 where molding around the line segments is achieved. Whether it is these or other cartridge injection mechanisms, the key is to provide a replaceable cartridge that can easily and cleanly inject the raw polymer material into the mold cavity 204, and to allow the user to quickly switch cartridges, whereby to change the material type, viscosity, color, additive, or other feature, so that the polymer sheath (or sleeve) can be customized to the application.

Just as the cartridge 260 may be replaceable, the mold 205 (and hence mold cavity 204) may also be replaceable in order to accommodate different line segment sizes, different numbers of line segments, the orientation of line segments in parallel or non-parallel orientations, or encapsulation of hooks or other components within the polymer sheath (or sleeve), as described above.

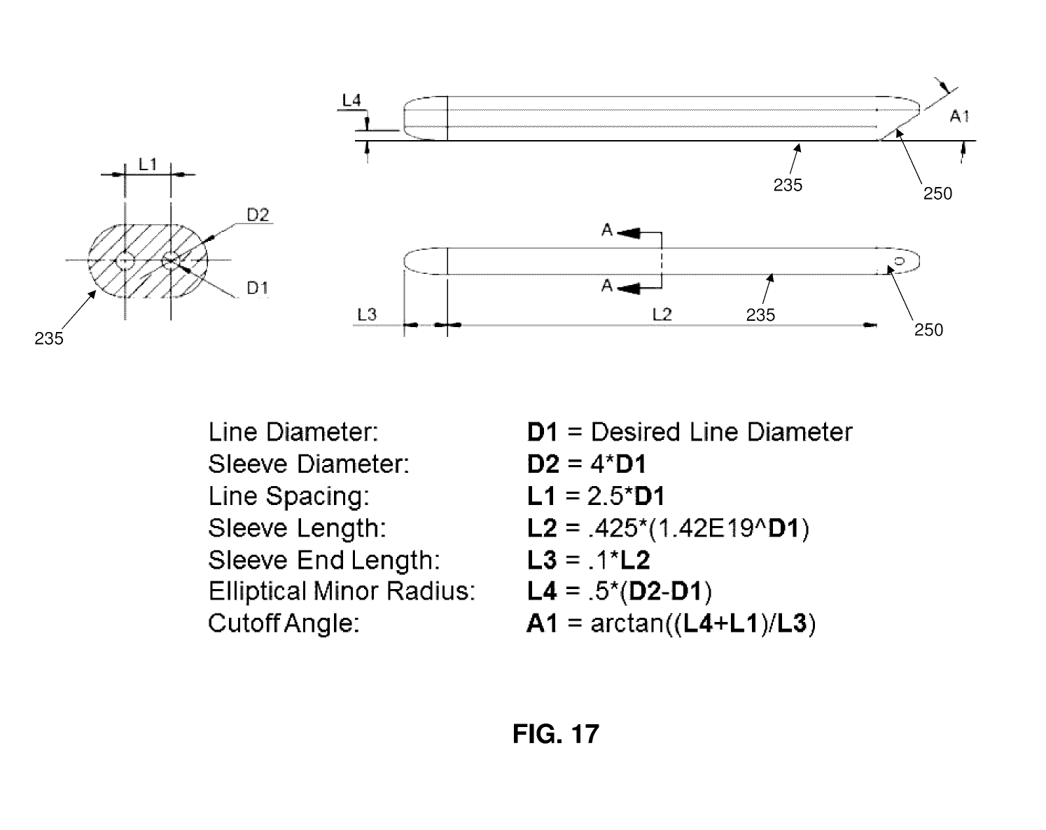

FIG. 17 shows some preferred relationships between the dimensions of the polymer sheath (or sleeve) 235 and the secured line segments so as to optimize the bond strength while maintaining the integrity of the line segments. In one preferred form of the invention, the individual line segments are separated such that the spacing (L1) is at least 0.5 times, and preferably 2.5 times, the diameter (D1) of the smallest diameter line segment so as to ensure that the mold encapsulates the entire surface of the line segment and avoids compressing individual line segments. Greater tensile strength may be achieved when the wall thickness of the polymer sheath (or sleeve) 235 is designed such that the outer diameter, or width for non-circular cross-sections, is greater than the diameter of the line segment which is being encapsulated. By way of example but not limitation, it has been found that better bonding can be achieved where the wall thickness of the polymer sheath (or sleeve) 235 is at least 2 times, and preferably 4 times, the diameter of the line segment which is being encapsulated.

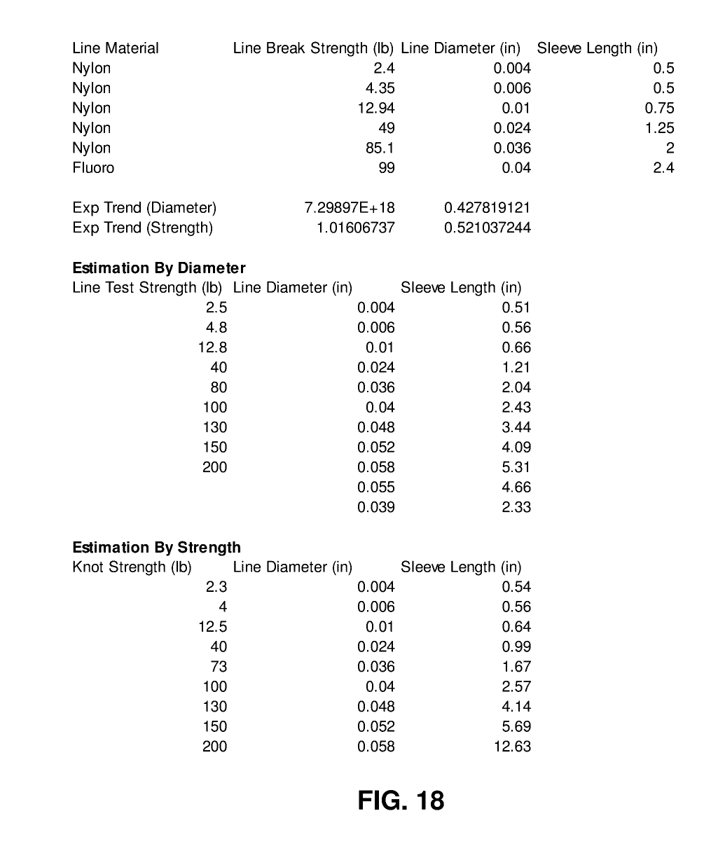

FIG. 18 is a table showing exemplary performance characteristics for the present invention.

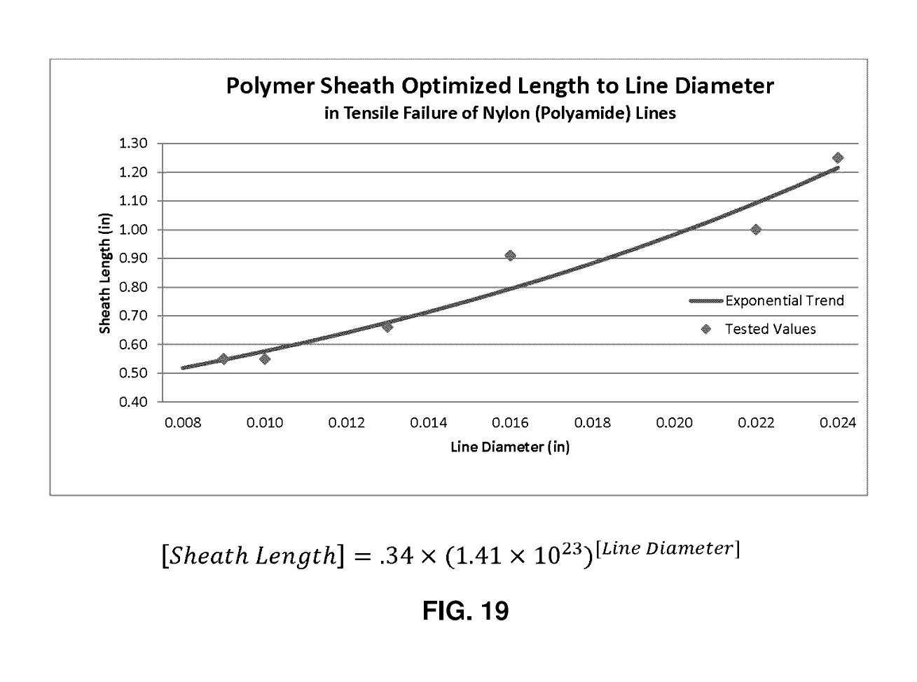

FIG. 19 is an exemplary graph showing the tensile strength of joined lines as a plot of sleeve length vs. line diameter.

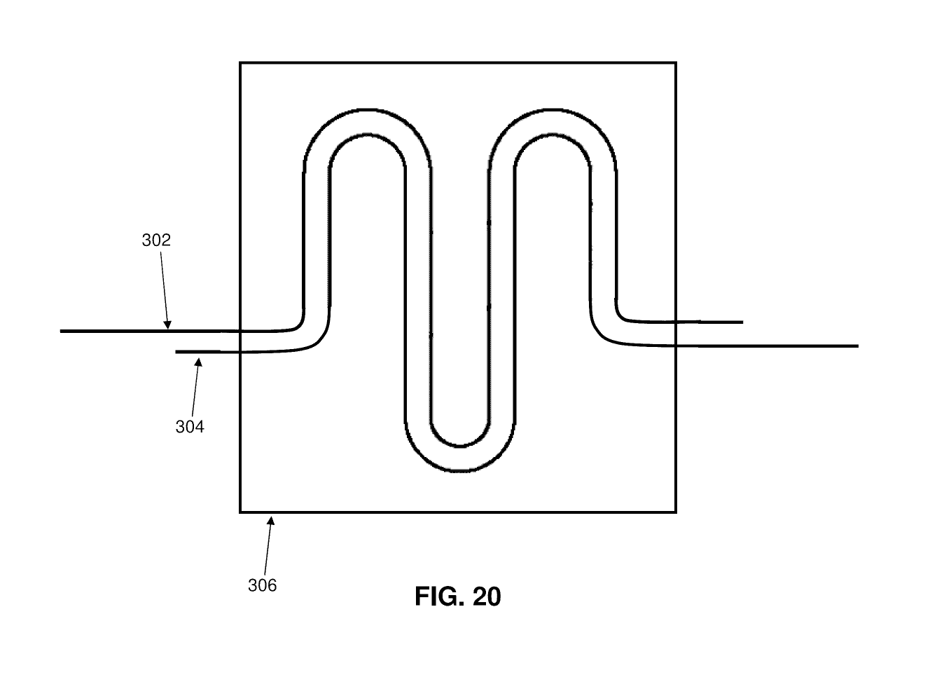

In the foregoing discussion, it was noted that the line segments may extend in parallel or non-parallel, spaced relation within the molded sheath (or sleeve) construct. In this respect it should be appreciated that various strategies may be employed to increase the surface area of the line segments engaged by the molded sheath (or sleeve), and/or to adjust the pathway of the line segments engaged by the molded sheath (or sleeve), whereby to increase the strength of the bond. See, for example, FIG. 20, where the line segments 302, 304 extend in a serpentine manner through the molded sheath (or sleeve) construct 306.

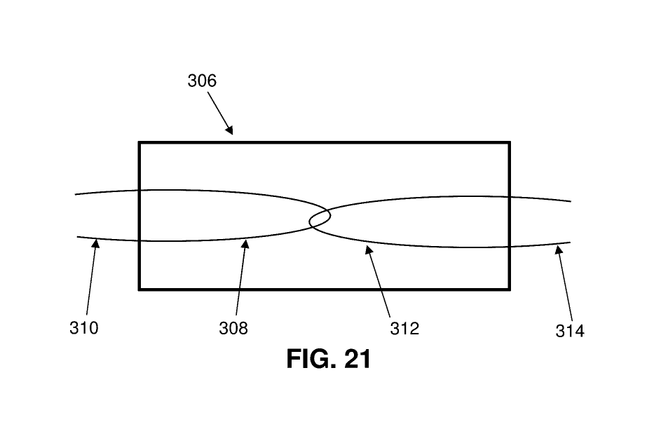

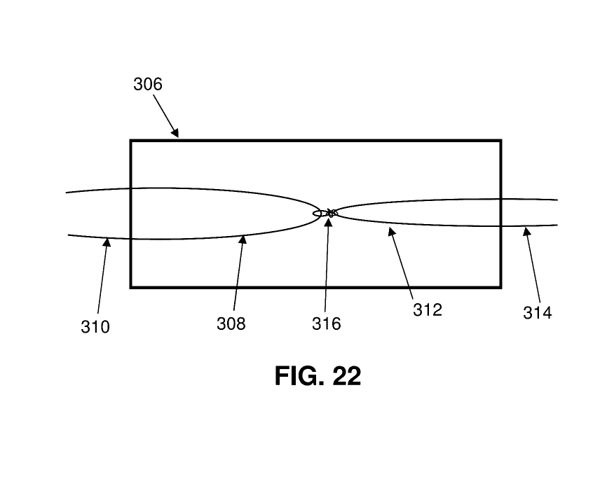

It is also possible to have the line segments contact one another within the molded sheath. See, for example, FIG. 21, which shows a loop 308 of a line 310 and a loop 312 of a line 314, where loop 308 and loop 312 are passed through one another. This approach can provide a superior bond, particularly where one line is braided line and the other line is monofilament line. See also, for example, FIG. 22, where line 314 is knotted (e.g., at 316) within the molded sheath. Again, this can provide a superior bond, particularly where one line is braided line and the other line is monofilament line. Still other configurations for the line segments will be appreciated by those skilled in the art in view of the present disclosure.

In addition to the embodiments discussed above, the devices of the present invention may attach line segments for applications other than fishing. In particular, any application in which two segments of line, thread, yarn, suture, wire, or other flexible elongated material are bonded together may benefit from the embodiments of the present invention, which secure at least two line segments together such that they are spaced apart to improve bond strength and the profile of the bond while preserving the physical integrity of the raw line material.

Thus it will be seen that, in one preferred form of the invention, the invention comprises the provision and use of a molded fastener, formed at least in part out of a flowable material, to secure two or more line segments in position relative to one another. In use, the line segments are positioned with a desired orientation (e.g., in a parallel or non-parallel, spaced relationship), the flowable material is flowed about the line segments so as to engulf the line segments, and then the flowable material is set so as to form an encasing structure about the line segments, whereby to lock the line segments in position relative to one another.

In one form of the invention, the molded fastener is formed in situ, e.g., the line segments are positioned in a mold with the desired orientation, the flowable material is flowed into the mold and about the line segments, and then the flowable material is set so as to form the encasing structure about the line segments, whereby to lock the line segments in position relative to one another.

In another form of the invention, the molded fastener is at least partially pre-formed, and then the final configuration of the molded fastener is effected in situ, e.g., the line segments are positioned in the at least partially pre-formed molded fastener, the flowable material is flowed about the line segments, and then the flowable material is set so as to form the encasing structure about the line segments, whereby to lock the line segments in position relative to one another.

The flowable material may comprise any material capable of performing the desired function. In one form of the invention, the flowable material forms a mechanical bond with the line segments when set. In another form of the invention, the flowable material forms a chemical bond with the line segments when set. And in another form of the invention, the flowable material forms both mechanical and chemical bonds with the line segments when set. The flowable material may comprise an adhesive (including a hot melt adhesive) and/or a flowable polymer and/or any other appropriate material, and flowing/setting of the flowable material may be effected according to the nature of the flowable material, e.g., heating/cooling, the absence or presence of UV light, the absence or presence of a reactant, etc.

### Integrating Heating Element with Cartridge

As discussed above, in some forms of the present invention, the polymer used to join one line segment to another line segment is provided in the form of a solid polymer “stick” (see, for example, FIGS. 12A and 12B), or in the form of a cartridge containing a solid polymer stick (see, for example, FIGS. 15B and 15E). In these forms of the invention, the solid polymer stick is advanced through a passageway in the hand-held device, wherein a heating element is disposed around the passageway. Heat from the heating element is transferred through the walls of the passageway to the solid polymer stick, whereby to heat the polymer and transform (i.e., melt) the polymer from its solid state into a viscous (i.e., liquid or semi-liquid) state. The flowable polymer is then flowed out of the passageway and into a mold (e.g., a mold containing two line segments disposed adjacent to one another, two line segments tied together with a knot, two line segments looped together, etc.) and allowed to cool, whereby to secure the two line segments together.

However, it should also be appreciated that, if desired, a novel cartridge may be provided wherein the heating element is integrated within the cartridge itself and wherein the heating element is in direct contact with the polymer (rather than being disposed about a passageway containing the polymer, such as is disclosed above). By integrating the heating element within the cartridge, and by positioning the heating element in direct contact with the polymer, the heating element can more efficiently heat the polymer and thereby transform (i.e., melt) the polymer from its solid state into its viscous (i.e., liquid or semi-liquid) state, with the heating element requiring far less electrical power to melt the polymer than when the heating element is disposed around the passageway (and where the heat must be transferred through the walls of the passageway). This allows for a reduction in the size of the battery which is used to power the heating element, and can thereby reduce the cost and complexity of the hand-held device. In addition, by positioning the heating element in direct contact with the polymer, the wait-time for the polymer to become ready for injection is substantially reduced, since there is no need to heat an intervening structure (i.e., the sidewall of the passageway which is disposed between the heater and the polymer stick). By way of example but not limitation, a smaller battery such as a single lithium cell battery may be used to power the heating element for the hand-device, whereby to allow for (i) the elimination of a 5 volt regulator and capacitors, (ii) the elimination of level-shifting FETs and 2 resistors, (iii) the elimination of 2 resistors, 1 capacitor, and 1 FET associated with a battery voltage level check, (iv) the elimination of fail-safe circuitry to protect against a 48 watt heater being continually “on” if the microprocessor fails, and (v) the incorporation of a single switch with dual “power on” and “GO” functionality. Furthermore, the use of a smaller battery allows for the use of a smaller battery charger and/or permits the use of a 5 volt USB power cord for charging the battery.

Integrating the heating element within the cartridge, and positioning the heating element in direct contact with the solid polymer stick, also provides several additional advantages. For example, by placing the heating element (e.g., a resistor element) in direct contact with the solid polymer stick, the heating element requires far less power in order to transform the polymer from its solid state into a viscous (i.e., liquid or semi-liquid) state, since the polymer is heated “from the inside out” rather than “from the outside in”. Furthermore, with the heating element integrated into the cartridge, only the polymer that is actually being injected into the mold is heated, and minimal energy is lost heating the cartridge itself. In addition, by disposing the heating element within the cartridge itself, the heating element is replaced each time the cartridge is replaced, thereby eliminating concerns about the lifetime of the heating element (which could be affected, for example, by thermal shock-induced breakage) and hence lengthening the lifespan of the hand-held device. And the body of the cartridge can be made larger, since the heating element is incorporated within the cartridge itself, in direct contact with the polymer, and is no longer disposed around the passageway in the hand-held device—which limits the maximum diameter of the cartridge if heat is to be reliably delivered to the radially-innermost portions of the cartridge. As a result, a greater range of design options are available for the cartridge. Furthermore, since heat does not need to be transferred from a heating element located outside of the cartridge to the solid polymer stick contained within the cartridge, the cartridge does not need to be made out of a high heat transfer material (e.g., metal) and can be polymer-based, thereby reducing the cost of manufacturing the cartridge.

In addition to the foregoing, because the heating element is integrated with the cartridge and does not need to heat the walls of a passageway in the hand-held device which surrounds the cartridge, the hand-held device is able to provide a “rapid off” operation, since the heating element has a relatively small mass and hence a relatively small heat storage factor. In contrast, where the heating element surrounds a passageway in the hand-held device, a substantial amount of heat is stored in the walls of the passageway and hence the hand-held device is not able to provide “rapid off” operation. Furthermore, inasmuch as relatively little heat is stored in the components of the hand-held device, the hand-held device is able to deliver small doses of polymer, since the polymer re-solidifies very quickly after the termination of electrical power to the heating element.

In addition to the foregoing, integration of the heating element with the cartridge allows a partially-used cartridge to be removed from the hand-held device and replaced with another cartridge (e.g., one having a different polymer composition such as a different material or scent or color, etc.). The partially-used cartridge may thereafter be re-inserted into the hand-held device and used for further bonding operations. This ability to remove a partially-used cartridge and replace it with another cartridge allows polymer mixing to be avoided.

Also, incorporating the heating element into the cartridge provides a significant safety feature, since the hand-held device does not need to provide a heat sink for storing heat and, as a result, there is a decreased risk of the user burning themselves through contact with the hand-held device.

### Portable Hand-Held Line Welding Device—Third Construction

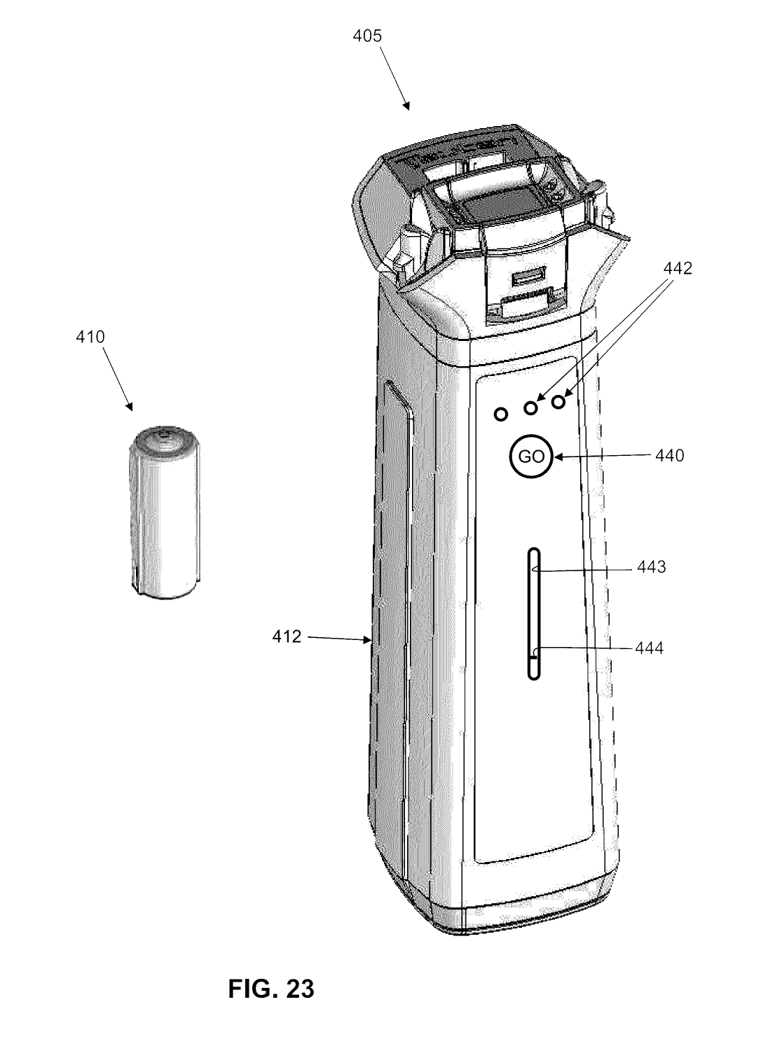

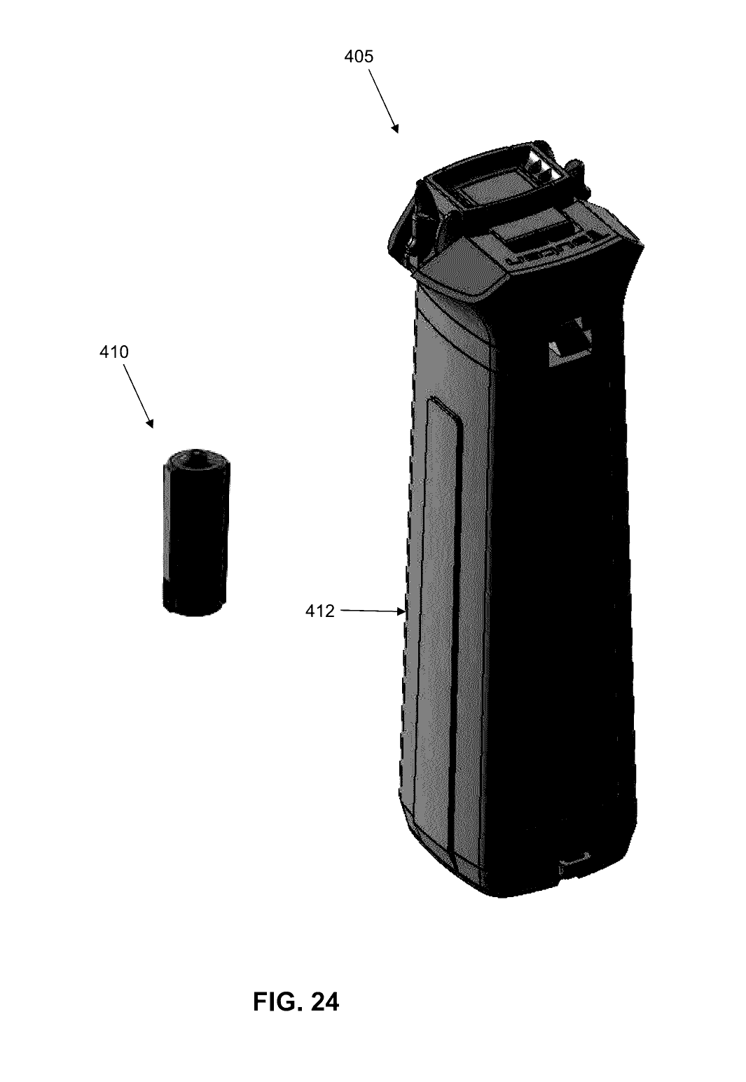

Looking now at FIGS. 23 and 24, there is shown a portable hand-held line-welding system 400 which incorporates a novel welding cartridge comprising an integrated heating element. Hand-held line-welding system 400 generally comprises a welder 405 and a welding cartridge 410 which may be inserted into, and removed from, welder 405 as will hereinafter be discussed in further detail.

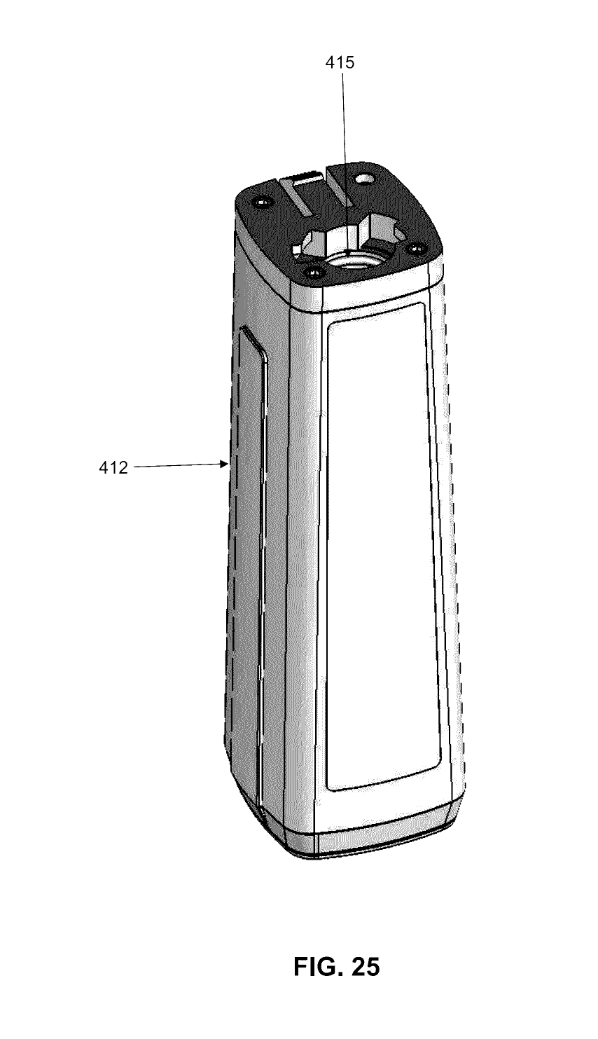

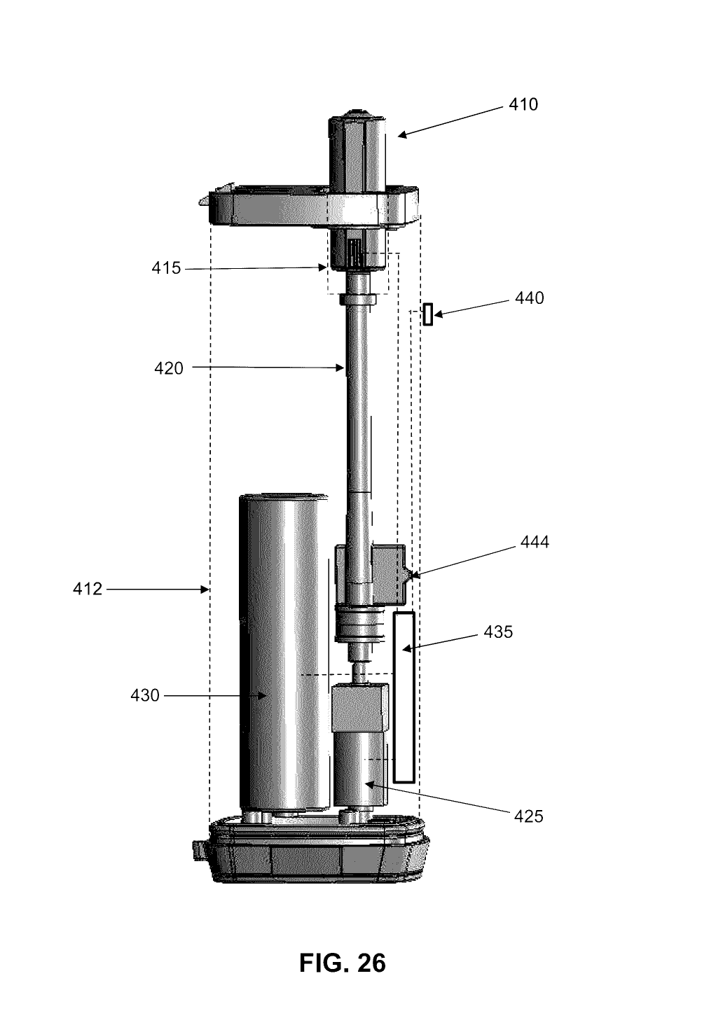

Looking next at FIGS. 25 and 26, welder 405 comprises a body 412 having a cavity 415 formed therein for receiving welding cartridge 410, as will hereinafter be discussed. Cavity 415 comprises an open distal end which is covered by a pivoting cartridge door (see below) and two (or more) electrical contacts for providing electrical power to welding cartridge 410, as will hereinafter be discussed. Cavity 415 has a cross-sectional configuration matching the cross-sectional configuration of welding cartridge 410. Body 412 comprises a plunger 420 longitudinally disposed within body 412 and aligned with the proximal end of cavity 415. Plunger 420 is configured to selectively move distally for advancement along cavity 415, whereby to contact the proximal end of a welding cartridge 410 disposed in cavity 415, as will hereinafter be discussed. Body 412 also comprises a motor 425 which is configured to move plunger 420 distally or proximally (e.g., via a jackscrew) and a battery 430 for powering motor 425 and welding cartridge 410, as will hereinafter be discussed.

Welder 405 also comprises control electronics 435 for selectively operating motor 425 and welding cartridge 410, and an activation button 440 (FIGS. 23 and 26) for allowing user input to control electronics 435. In one preferred form of the present invention, and looking now at FIG. 23, welder 405 also comprises one or more indicator lights 442 (e.g., LEDs) for showing the status of battery 430 and welding cartridge 410, the operational status of welder 405, etc.

In one preferred form of the invention, welder 405 preferably comprises a window 443 (FIG. 23) formed in body 412. Window 443 allows a “tick” mark 444 on plunger 420 (FIG. 26) to be visualized through body 412 (FIG. 23). As a result of this construction, when plunger 420 advances distally while injecting polymer into the mold (see below) tick mark 444 gives a visual read of how much of the cartridge has been consumed.

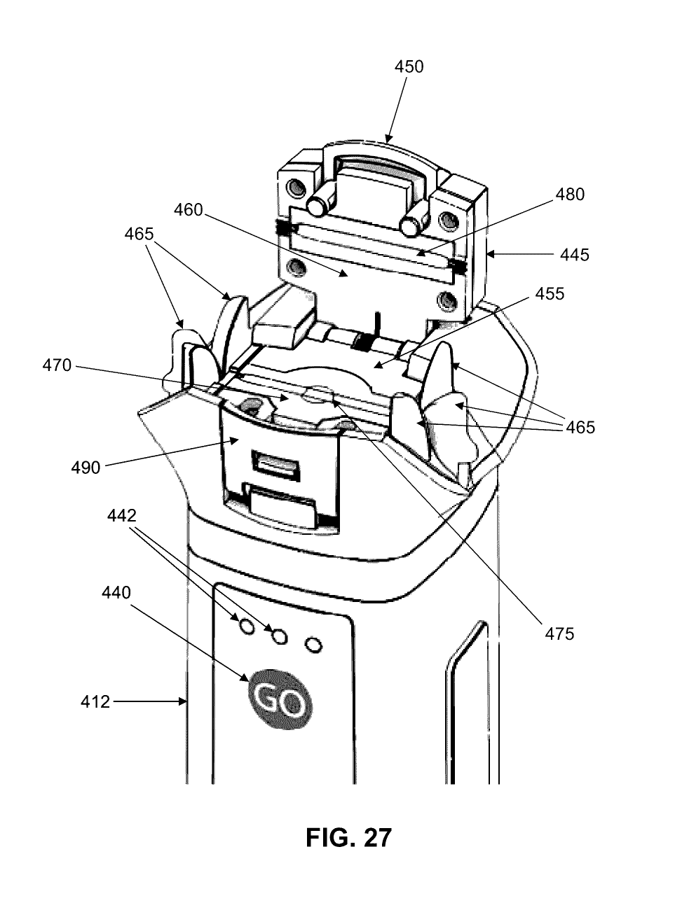

Looking next at FIG. 27, the distal end of welder 405 comprises a mold door 445 which is pivotally mounted to body 412 of welder 405. Mold door 445 opens to allow access to a mold cavity (see below) where the two (or more) line segments (“lines”) which are to be joined are disposed near to one another (e.g., in parallel, spaced relationship to one another, tied together with a knot, looped through one another, etc.) and into which a polymer is selectively flowed, as will hereinafter be discussed in further detail. Mold door 445 is selectively opened and locked closed via a latch 450.

The distal end of welder 405 also comprises a lower mold assembly 455 and an upper mold assembly 460. Upper mold assembly 460 is mounted to the underside of mold door 445 and is sized to mate with lower mold assembly 455 so as to together form the complete mold cavity.

More particularly, and still looking at FIG. 27, lower mold assembly 455 comprises (i) a plurality of guides 465 for holding the two (or more) lines that are to be joined together in position within the mold cavity, (ii) the proximal half 470 of the complete mold cavity, and (iii) an entrance 475 for allowing the flow of polymer from welding cartridge 410 into the complete mold cavity, as will hereinafter be discussed in further detail.

Upper mold assembly 460 comprises the distal half 480 of the complete mold cavity. Distal half 480 of the complete mold cavity is positioned so as to align with proximal half 470 of lower mold assembly 455 so as to together comprise a complete sealed mold cavity.

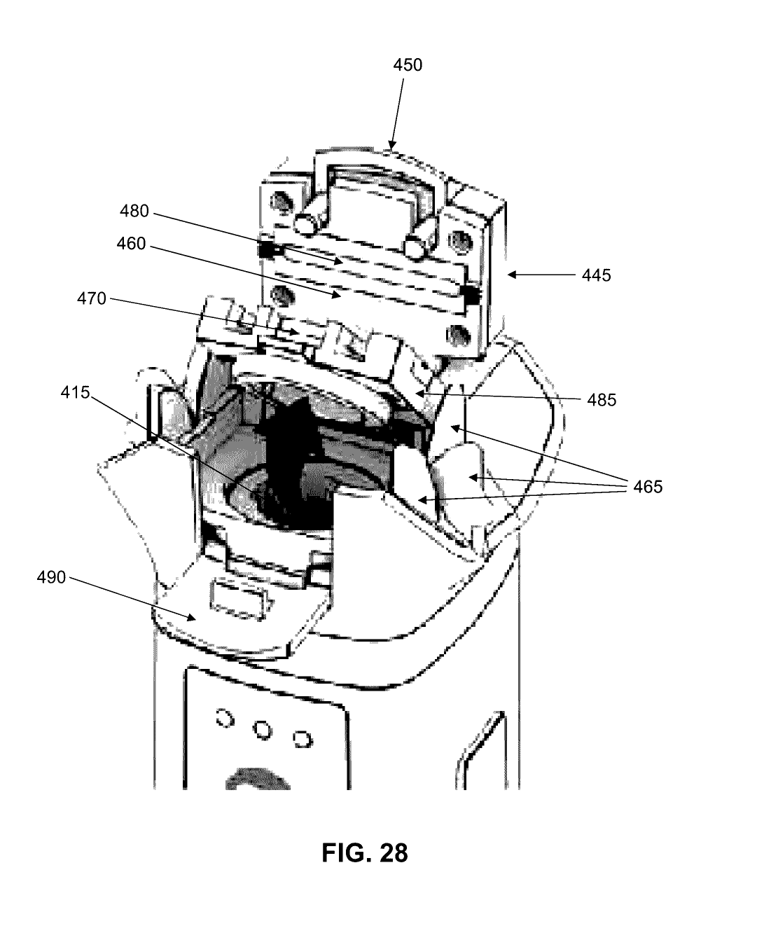

Looking next at FIG. 28, the distal end of welder 405 also comprises a cartridge door 485 which is pivotally mounted to body 412 of welder 405 and which provides access to cavity 415 (and, when a welding cartridge 410 is disposed in cavity 415, to that welding cartridge). It will be appreciated that proximal half 470 of the complete mold cavity is mounted to the top of cartridge door 485. It will also be appreciated that inasmuch as proximal half 470 of the complete mold cavity is mounted to the top side of cartridge door 485, entrance 475 into proximal half 470 of the complete mold cavity passes through cartridge door 485 such that welding cartridge 410 can pass melted polymer through cartridge door 485, through entrance 475 and into the complete mold cavity, as will hereinafter be discussed in further detail. Cartridge door 485 may be selectively opened and locked closed via a latch 490.

### 1. Novel Welding Cartridge with Integrated Heating Element—First Construction

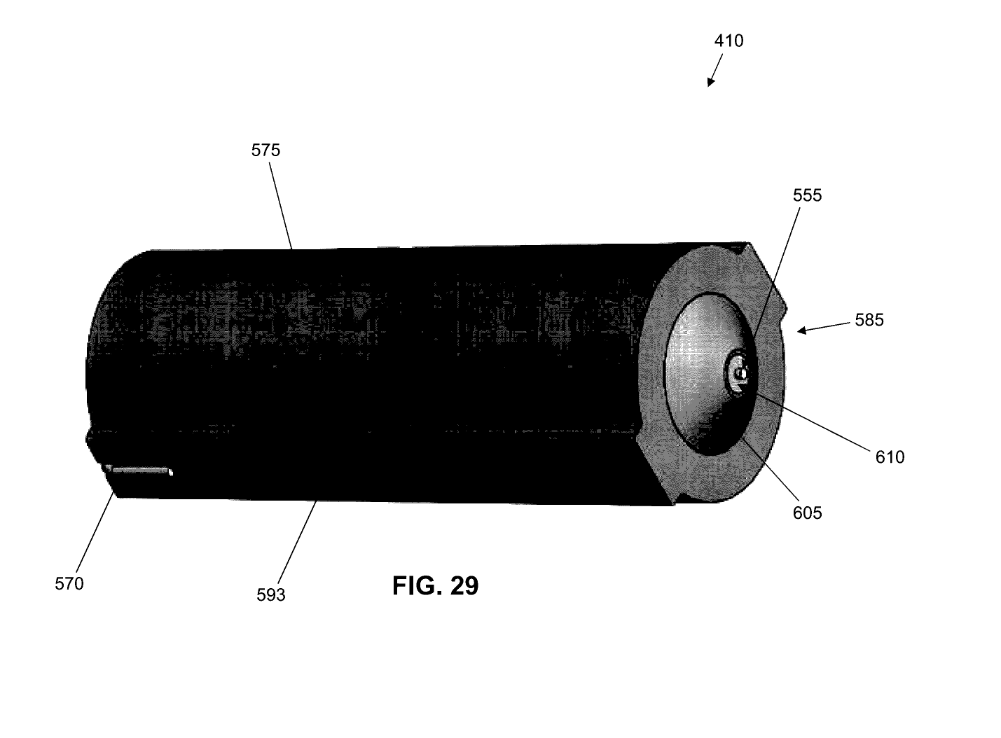

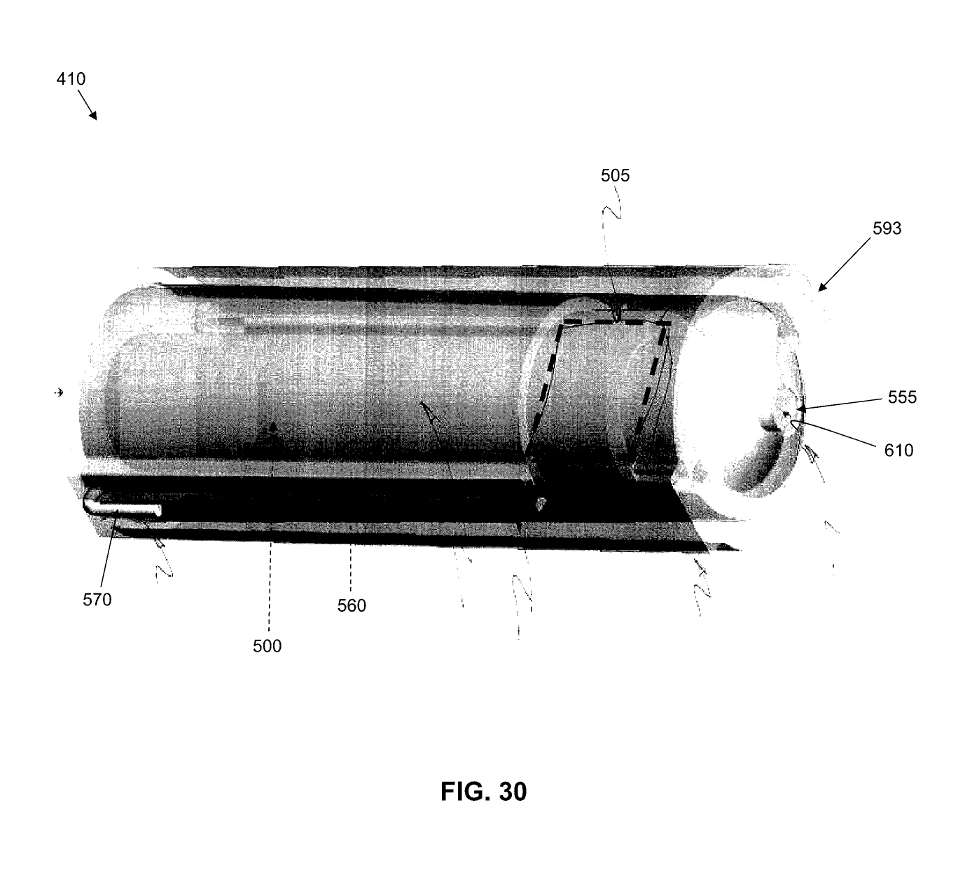

As discussed above, it may be desirable to provide a novel welding cartridge comprising an integrated heating element for use with novel welder 405. To that end, and looking now at FIGS. 29-32, the present invention provides a welding cartridge 410 which includes an integrated heating element. More particularly, welding cartridge 410 generally comprises a housing 495, a polymer stick 500 movably disposed within housing 495, and a heating element 505 for selectively melting polymer stick 500.

More particularly, housing 495 comprises a distal end 510, a proximal end 515 and a lumen 520 extending therebetween. Housing 495 also comprises an outer surface 525 extending between distal end 510 and proximal end 515, and a pair of diametrically-opposed slots 530 formed in outer surface 525 which extend between distal end 510 and proximal end 515 of housing 495.

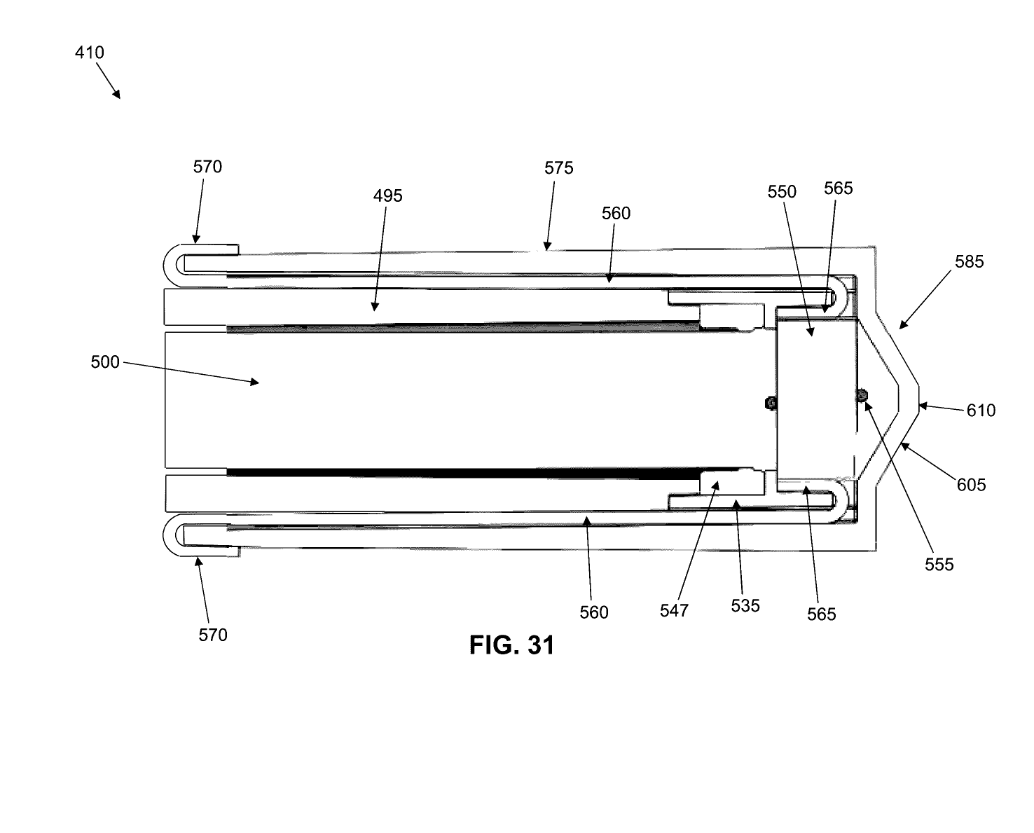

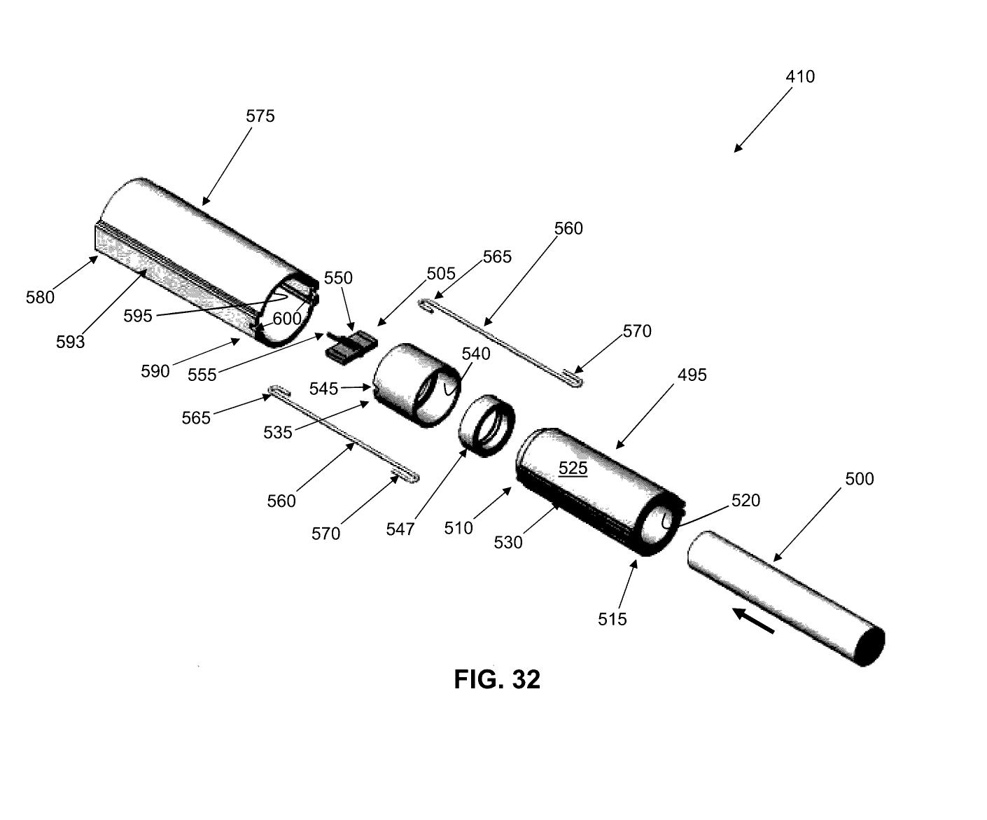

Welding cartridge 410 further comprises an insulator 535 having an opening 540 passing therethrough. Insulator 535 is sized to be mounted to the distal end 510 of housing 495, such that opening 540 of insulator 535 is aligned with lumen 520 of housing 495, and such that polymer stick 500 can pass through lumen 530 of housing 495, through opening 540 of insulator 535, and contact heating element 505, as will hereinafter be discussed. Insulator 535 also comprises a seat 545 (e.g., a pair of diametrically-opposed slits) formed at its distal end for receiving heating element 505. If desired, a spacer ring 547 may be provided for disposition between insulator 535 and housing 495 (FIGS. 31 and 32), in which case insulator 535 may be mounted to spacer ring 547 and/or to housing 495. Spacer ring 547 is a compliant, high-temperature material seal that prevents molten polymer from flowing retrograde during heating and subsequent pushing of the polymer stick.

Heating element 505 comprises a body 550 which is preferably configured as a planar electrical resistor (i.e., an element which increases in temperature when an electric current is passed therethrough). Body 550 is mounted in seat 545 of insulator 535 so as to span opening 540 of insulator 535 and contact polymer stick 500. In a preferred form of the present invention, heating element 505 also comprises a heat director 555 in contact with body 550 of heating element 505. Heat director 555 is configured to direct heat distally (e.g., by thermal conduction) into the nozzle (see below) of welding cartridge 410, whereby to direct flowed polymer distally through the nozzle of welding cartridge 410, as will hereinafter be discussed.

A pair of electrical contact leads 560 are disposed in diametrically-opposed slots 530 of housing 495. Each electrical contact lead 560 comprises a distal electrical contact 565 for making an electrical connection with body 550 of heating element 505, and a proximal electrical contact 570 for making an electrical connection with a power source (e.g., battery 430 of welder 405) via a corresponding electrical connector disposed within cavity 415 of welder 405. Distal electrical contact 565 of electrical contact lead 560 is configured to mount to seat 545 of insulator 535 (i.e., where seat 545 comprises a slot, distal electrical contact 565 is bent so as to seat within the slot) so as to contact body 550 of heating element 505. Proximal electrical contact 570 is configured to be seated in a proximal seat formed in an outer cover (see below), and to remain exterior to the outer cover so as to make electrical contact with electrical contacts provided in cavity 415 of welder 405, whereby to provide electrical power to electrical contact leads 560, as will hereinafter be discussed.

An outer cover 575 is disposed over housing 495, heating element 505, insulator 535 and electrical contact leads 560. More particularly, outer cover 575 comprises a distal end 580 (covered by a distal end cap 585) and a proximal end 590. A pair of ribs 593 preferably extend from distal end 580 to proximal end 590 of outer cover 575. Ribs 593 cooperate with counterpart recesses formed in the sidewall of cavity 415 in welder 405 to help orient welding cartridge 410 within cavity 415. A cavity 595 extends between distal end cap 585 and proximal end 590 and is sized to receive housing 495, heating element 505, insulator 535 and electrical contact leads 560 therein, whereby to cover heating element 505 and the distal portions of electrical contact leads 560. Outer cover 575 preferably comprises a pair of slots 600 formed on proximal end 590 of outer cover 575 which are sized to receive proximal electrical contacts 570 of electrical contact leads 560 therein, allowing proximal electrical contacts 570 to be accessed when outer cover 575 is in place.

Distal end cap 585 may be formed integral with outer cover 575, or it may be mounted to outer cover 575. Distal end cap 585 preferably comprises a tapered distal tip 605 having an exit port 610 opening at the distal end of tapered distal tip 605. Tapered distal tip 605 and exit port 610 effectively form a nozzle for welding cartridge 410. When welding cartridge 410 is fully assembled, the distal tip of heat director 555 projects into exit port 610 of distal end cap 585. It should be appreciated that inasmuch as heat director 555 protrudes distally into exit port 610, heat director 555 also prevents melted polymer from solidifying within, and clogging, the exit port.

As will hereinafter be discussed, when welding cartridge 410 is disposed in cavity 415 of welder 405, and electrical power is delivered to proximal electrical contacts 570 of electrical contact leads 560, heating element 505 will heat up and melt polymer stick 500 when polymer stick 500 is moved distally within lumen 520 of housing 495, whereby to eject melted polymer out exit port 610 of welding cartridge 410. As will also hereinafter be discussed, the melted polymer ejected from exit port 610 is flowed through entrance 475 of cartridge door 485 and into the mold cavity, whereby to join together two (or more) lines disposed in the mold cavity.

### 2. Novel Welding Cartridge with Integrated Heating Element—Second Construction

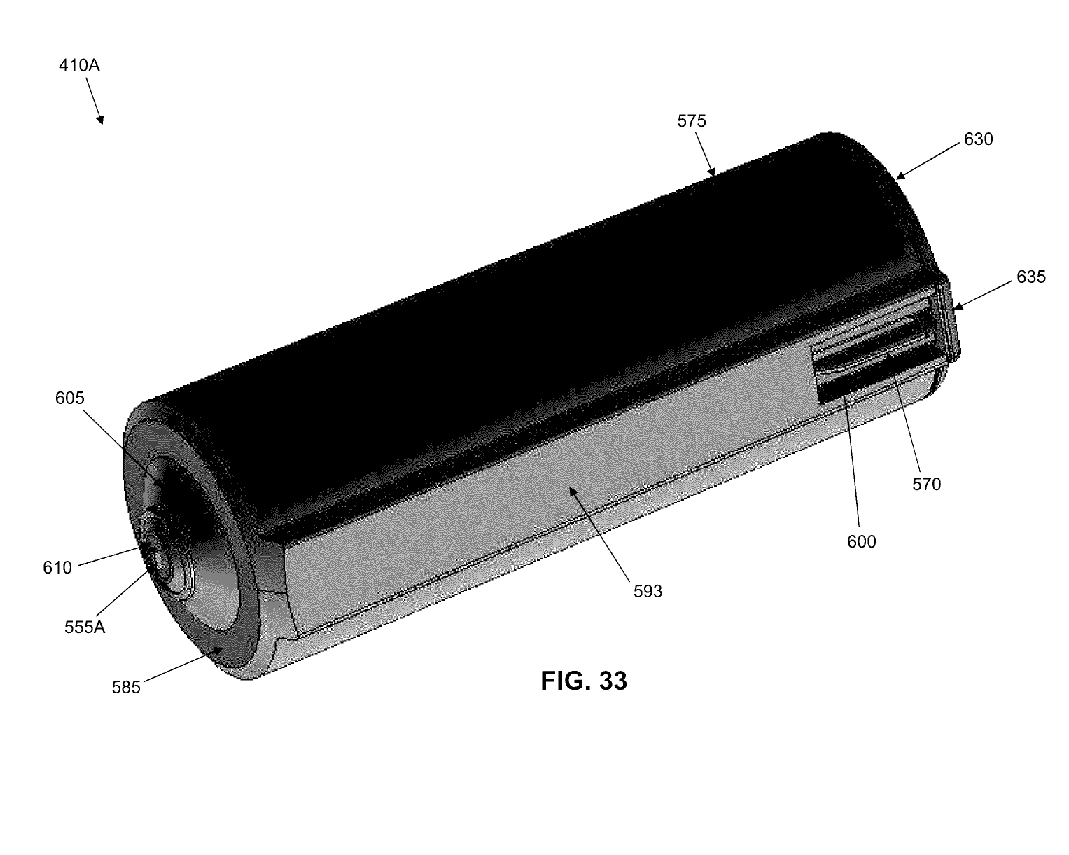

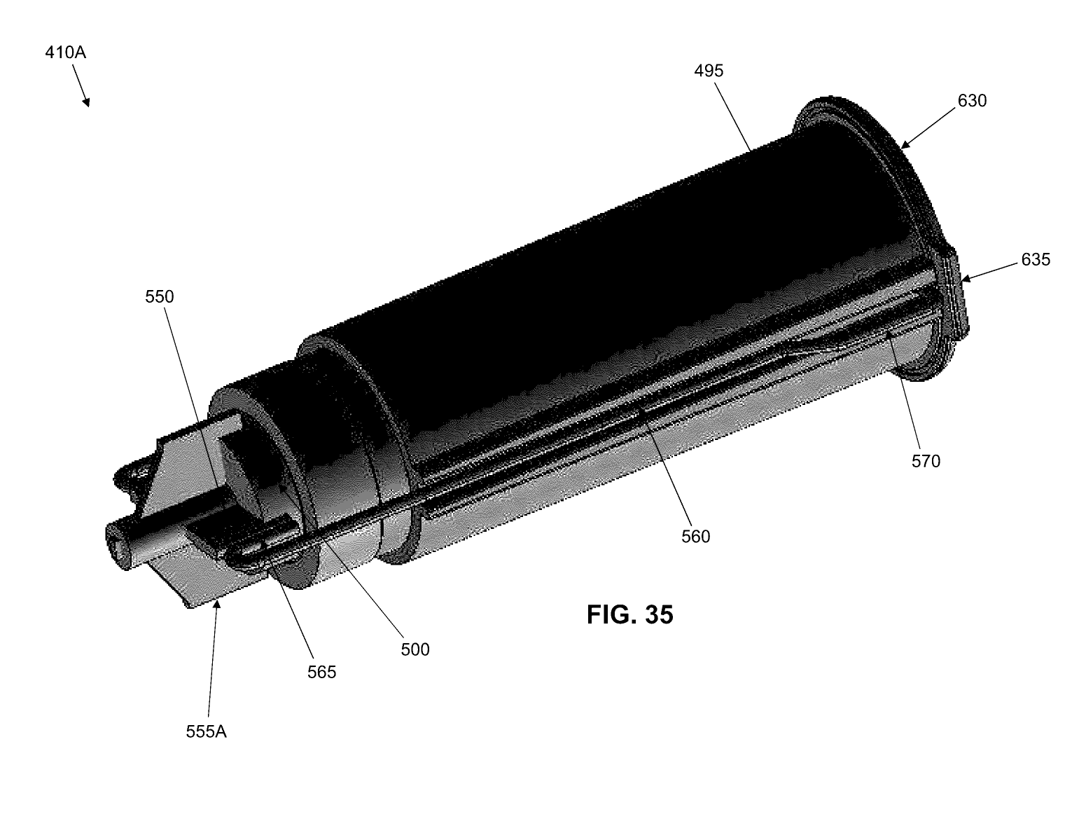

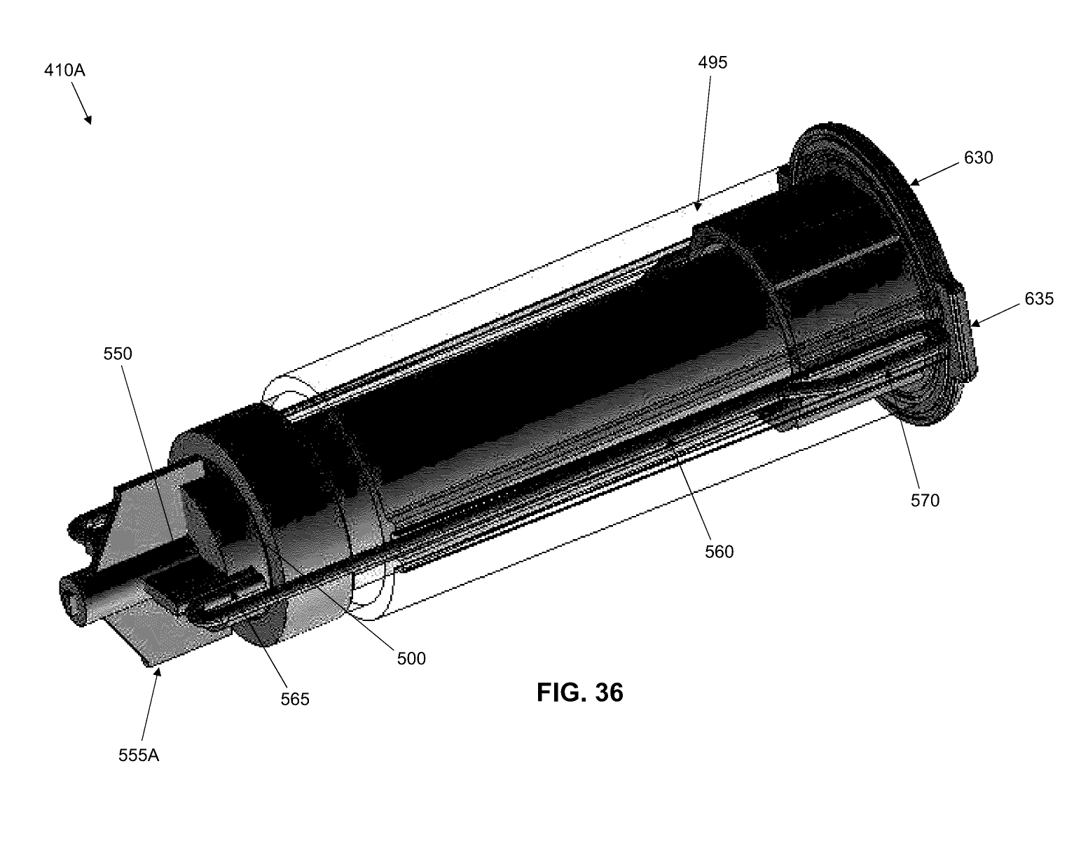

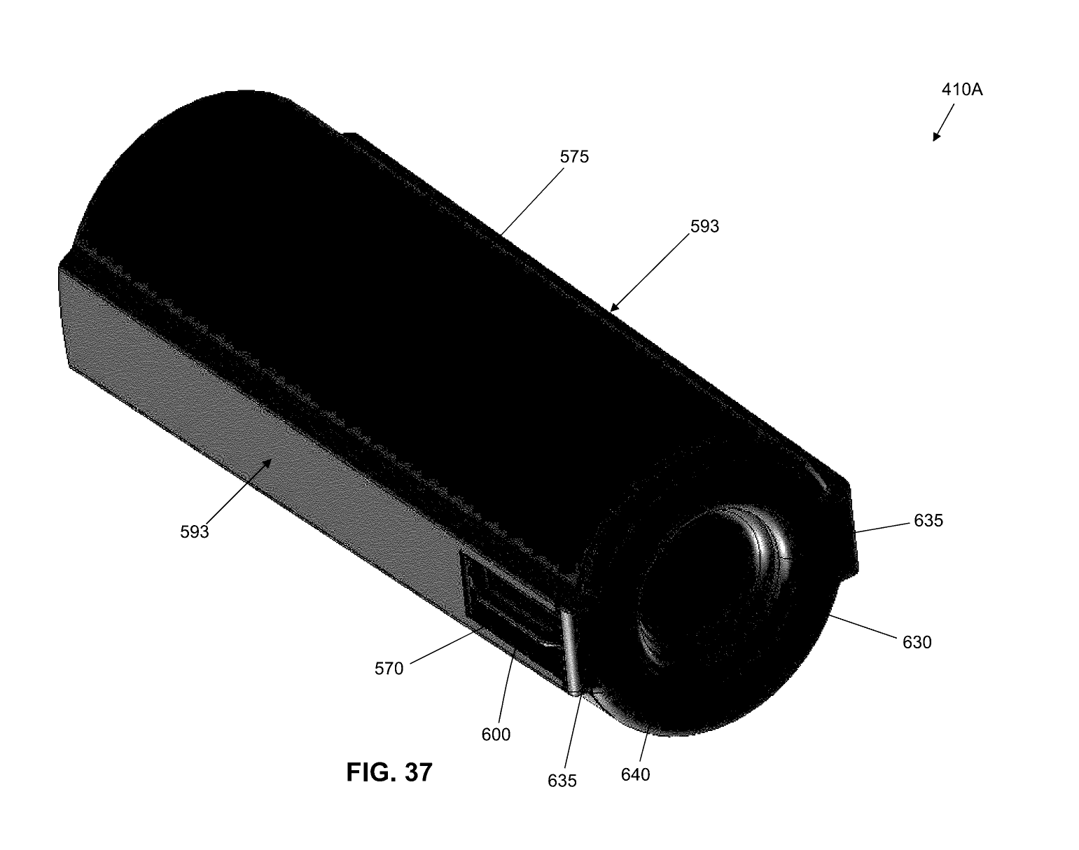

In another form of the present invention, and looking now at FIGS. 33-38, a novel welding cartridge 410A is provided. Welding cartridge 410A is generally similar to welding cartridge 410, however, welding cartridge 410A provides an improved heat director, an end collar, and an end cap, as will hereinafter be discussed in further detail.

Welding cartridge 410A generally comprises a housing 495, a polymer stick 500 movably disposed within housing 495 and a heating element 505 for selectively melting polymer stick 500.

More particularly, housing 495 comprises a distal end 510, a proximal end 515 and a lumen 520 extending therebetween. Housing 495 also comprises an outer surface 525 extending between distal end 510 and proximal end 515, and a pair of diametrically-opposed slots 530 formed in outer surface 525 which extend between distal end 510 and proximal end 515 of housing 495. In one preferred form of the present invention, housing 495 of welding cartridge 410A also comprises a pair of raised seats 615 formed near the proximal end 515 of housing 495, at the proximal ends of diametrically-opposed slots 530, for seating proximal electrical contacts 570 of electrical contact leads 560, as will hereinafter be discussed.

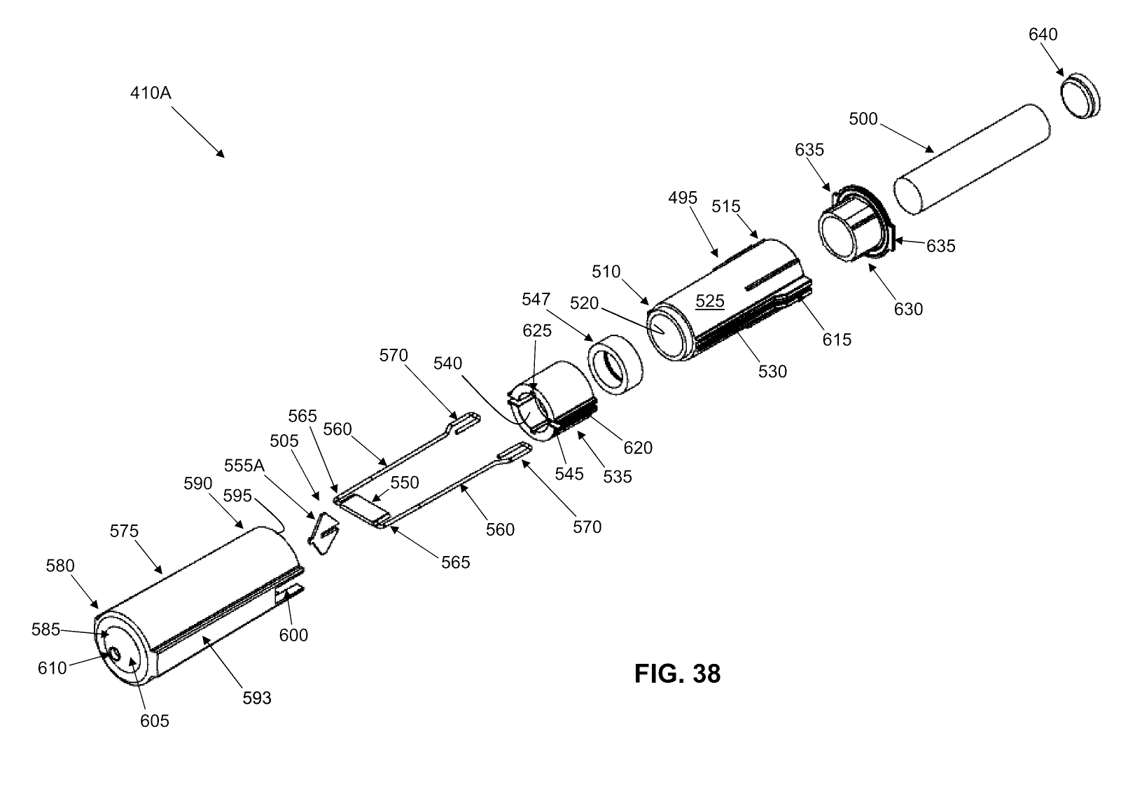

Welding cartridge 410A further comprises an insulator 535 having an opening 540 passing therethrough. Insulator 535 is sized to be mounted to the distal end 510 of housing 495, such that opening 540 of insulator 535 is aligned with lumen 520 of housing 495, and such that polymer stick 500 can pass through lumen 530 of housing 495, through opening 540 of insulator 535, and contact heating element 505, as will hereinafter be discussed. And, in one preferred form of the present invention, insulator 535 comprises two diametrically-opposed slots 620 which may be aligned with diametrically-opposed slots 530 of housing 495 in order to receive electrical contact leads 560 therein, as will hereinafter be discussed. Insulator 535 also comprises a seat 545 (e.g., a pair of diametrically-opposed slits) formed at its distal end for receiving heating element 505 (see below) and a seat 625 (e.g., a pair of diametrically-opposed slits) formed at the distal end of insulator 535, transverse to seat 545, for receiving a heat director (see below). If desired, a spacer ring 547 may be provided for disposition between insulator 535 and housing 495 (FIG. 38), in which case insulator 535 may be mounted to spacer ring 547 and/or to housing 495. Spacer ring 547 is a compliant, high-temperature material seal that prevents molten polymer from flowing retrograde during heating and subsequent pushing of the polymer stick.

Heating element 505 comprises a body 550 which is preferably configured as a planar electrical resistor (i.e., an element which increases in temperature when an electric current is passed therethrough). Body 550 is mounted in seat 545 of insulator 535 so as to span opening 540 of insulator 535 and contact polymer stick 500. In a preferred form of the present invention, heating element 505 also comprises a heat director 555A which is generally similar to the aforementioned heat director 555 but which also preferably includes an additional planar body (set transverse to planar body 550) to more evenly distribute heat to polymer stick 500 and thereby facilitate more efficient melting of polymer stick 500. Heat director 555A is mounted in seat 625 of insulator 535 (i.e., transverse to body 550 of heating element 505) and is in contact with body 550 of heating element 505. Heat director 555A is configured to direct heat distally into the nozzle (see below) of welding cartridge 410A, whereby to direct flowed polymer distally (e.g., by thermal conduction) through the nozzle of welding cartridge 410A, as will hereinafter be discussed. Significantly, because heat director 555A comprises a planar body which is disposed transverse to body 550 of heating element 505, heat can be applied to a larger volume of the polymer stick and more efficient heating and melting of the polymer stick can be achieved.

A pair of electrical contact leads 560 are disposed in diametrically-opposed slots 530 of housing 495 and in diametrically-opposed slots 620 of insulator 535. Each electrical contact lead 560 comprises a distal electrical contact 565 for making an electrical connection with body 550 of heating element 505, and a proximal electrical contact 570 for making an electrical connection with a power source (e.g., battery 430 of welder 405) via a corresponding electrical connector disposed within cavity 415 of welder 405. Proximal electrical contact 570 is configured to be received in raised seat 615 of housing 495. Distal electrical contact 565 of electrical contact lead 560 is configured to mount to seat 545 of insulator 535 (i.e., where seat 545 comprises a slot, distal electrical contact 565 is bent so as to seat within the slot) so as to contact body 550 of heating element 505. Proximal electrical contact 570 is configured to be seated in a proximal seat 615 formed in housing 495, and to be exposed by slots (see below) in an outer cover (see below) so as to make electrical contact with electrical contacts provided in cavity 415 of welder 405, as will hereinafter be discussed.

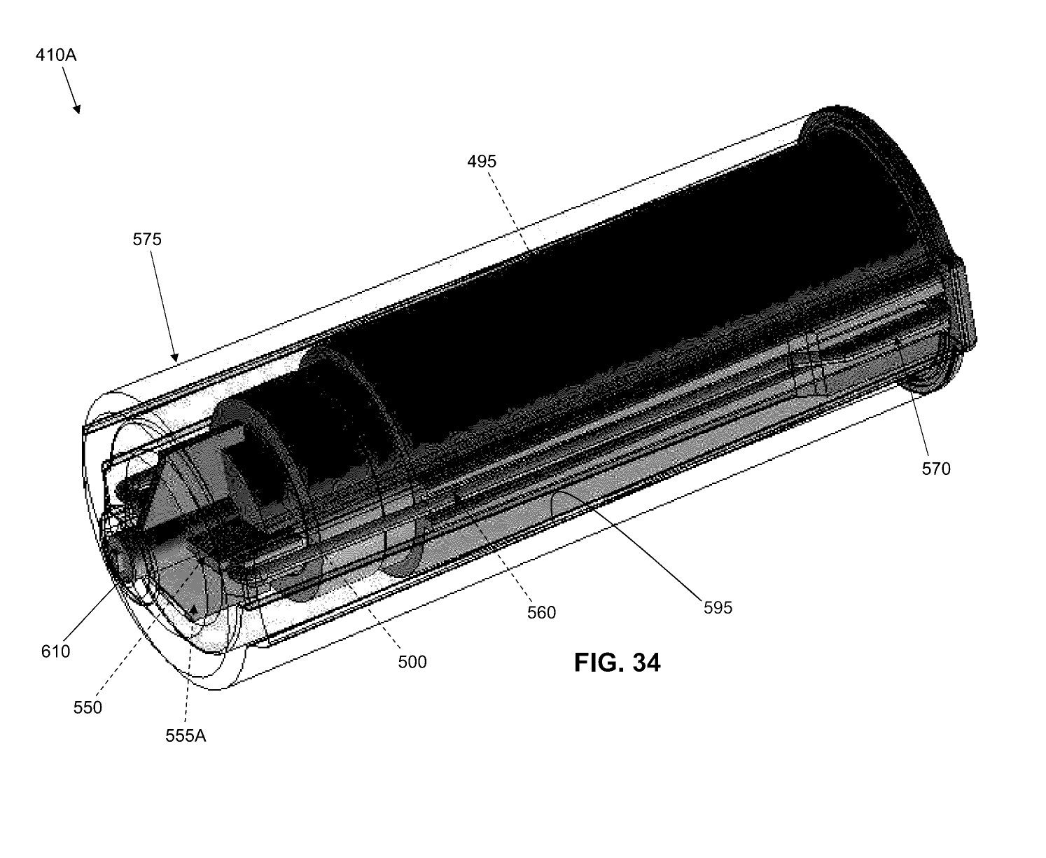

An outer cover 575 is disposed over housing 495, heating element 505, insulator 535 and electrical contact leads 560. More particularly, outer cover 575 comprises a distal end 580 (covered by a distal end cap 585) and a proximal end 590. A pair of ribs 593 preferably extend from distal end 580 to proximal end 590 of outer cover 575. Ribs 593 cooperate with counterpart recesses formed in the sidewall of cavity 415 in welder 405 to help orient welding cartridge 410 within cavity 415. A cavity 595 (FIG. 34) extends between distal end cap 585 and proximal end 590, and is sized to receive housing 495, heating element 505, insulator 535 and electrical contact leads 560 therein, whereby to cover heating element 505 and the distal portions of electrical contact leads 560. Outer cover 575 preferably comprises a pair of slots 600 formed on proximal end 590 of outer cover 575 which are sized to receive proximal electrical contacts 570 of electrical contact leads 560 therein, allowing proximal electrical contacts 570 to be accessed when outer cover 575 is in place.

Distal end cap 585 may be formed integral with outer cover 575 or it may be mounted to outer cover 575. Distal end cap 585 preferably comprises a tapered distal tip 605 having an exit port 610 opening at the distal end of tapered distal tip 605. Tapered distal tip 605 and exit port 610 effectively form a nozzle for welding cartridge 410. When welding cartridge 410 is fully assembled, the distal tip of heat director 555A projects into exit port 610 of distal end cap 585. It should be appreciated that inasmuch as heat director 555A protrudes distally into exit port 610, heat director 555A also prevents melted polymer from solidifying within, and clogging, the exit port.

Welding cartridge 410A also comprises an end collar 630 which is sized to be partially received within lumen 520 of housing 495. If desired, end collar 630 may comprise two diametrically-opposed flanges 635 for covering the proximalmost end of each proximal electrical contact 570 of electrical contact leads 560. It should be appreciated that with this form of the present invention, flanges 635 of end collar 630 and slots 600 of outer cover 575 together form windows which allow proximal electrical contacts 570 to be accessed while still protecting proximal electrical contacts 570 from damage and may help facilitate insertion of welding cartridge 410A into cavity 415 with the proper rotational disposition so as to align with corresponding electrical contacts in welder 405 (e.g., by being received in corresponding recesses formed in the sidewall of cavity 415 in welder 405).

An end cap 640 is also provided for sealing polymer stick 500 within welding cartridge 410A. End cap 640 is configured to be moved distally (e.g., via distal movement of plunger 420 of welder 405) so as to move polymer stick 500 distally.

As will hereinafter be discussed, when welding cartridge 410A is disposed in cavity 415 of welder 405, and electrical power is delivered to proximal electrical contacts 570 of electrical contact leads 560, heating element 505 will heat up and melt polymer stick 500 when polymer stick 500 is moved distally within lumen 520 of housing 495, whereby to eject melted polymer out exit port 610 of welding cartridge 410A. As will also hereinafter be discussed, the melted polymer ejected from exit port 610 is flowed through entrance 475 of cartridge door 485 and into the mold cavity, whereby to join together two (or more) lines disposed in the mold cavity.

### 3. Use of Portable Hand-Held Line Welding Device Utilizing Welding Cartridge with Integrated Heating Element

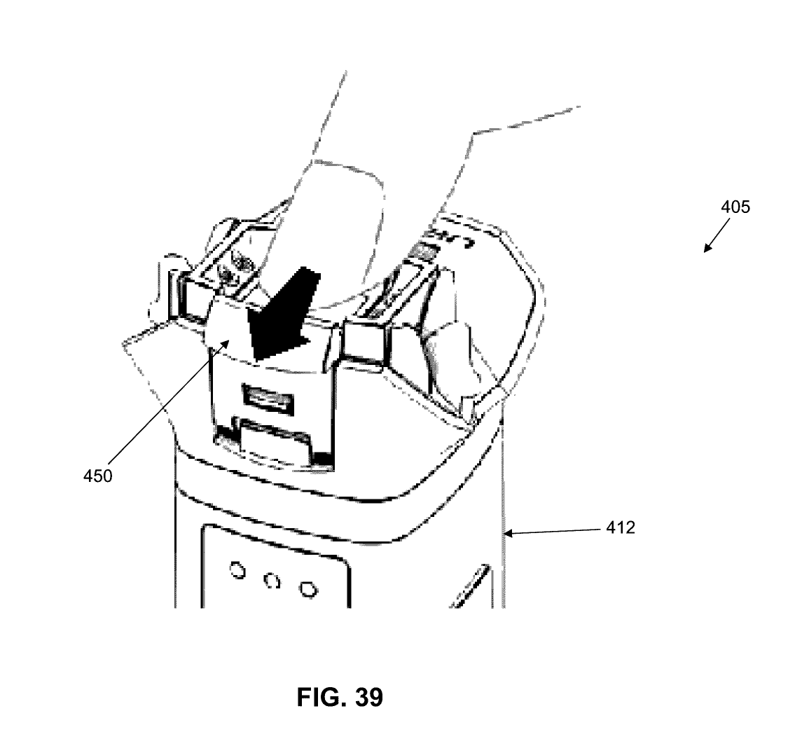

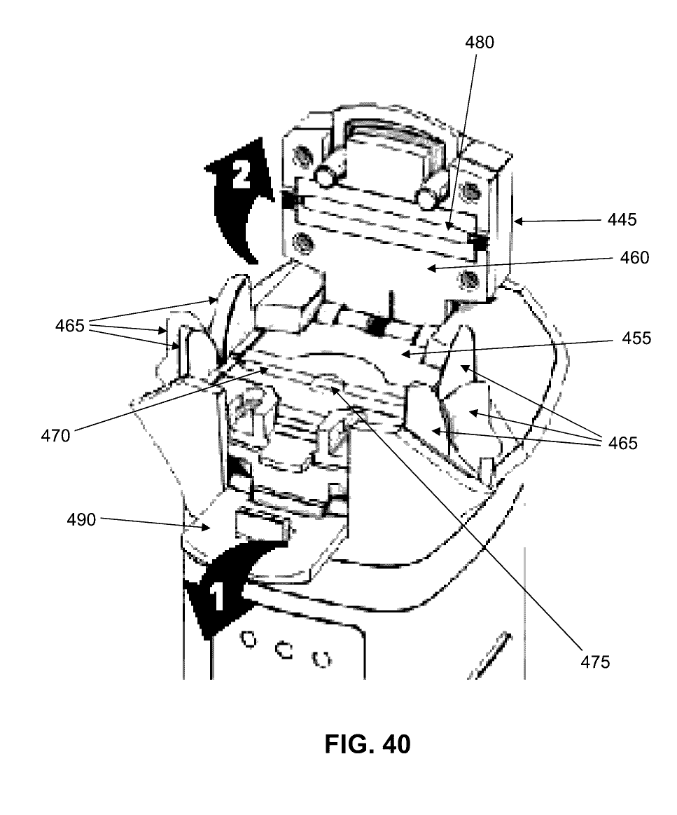

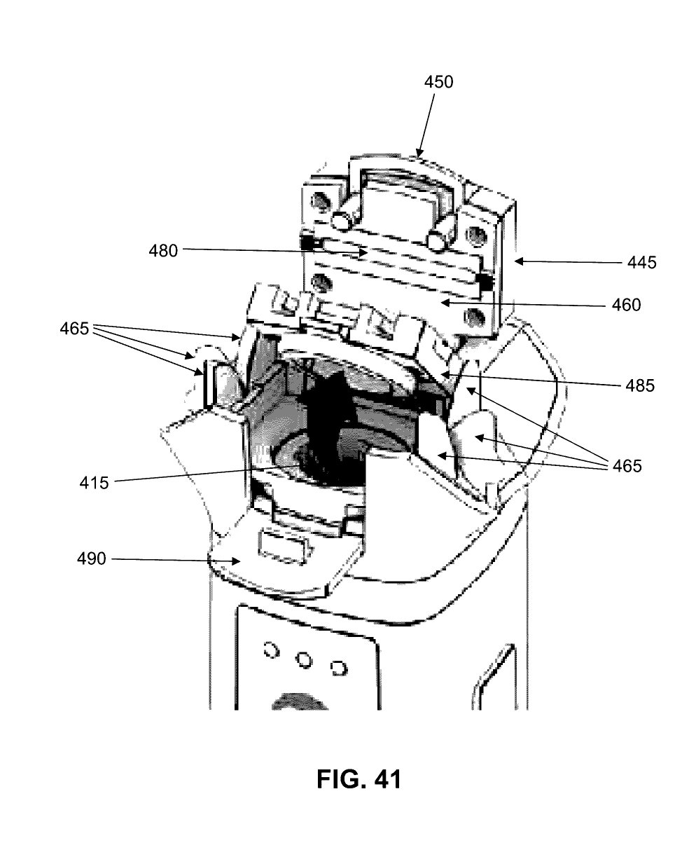

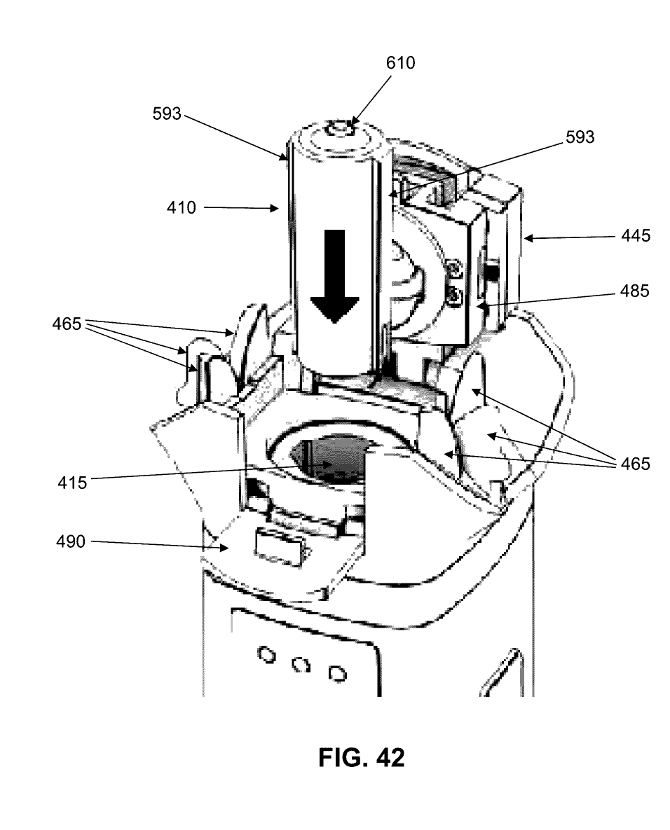

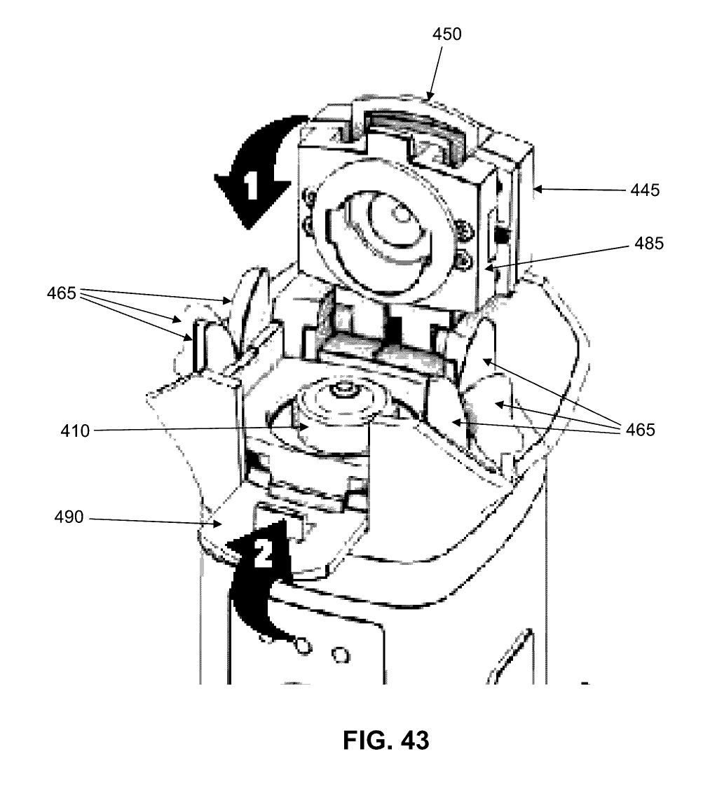

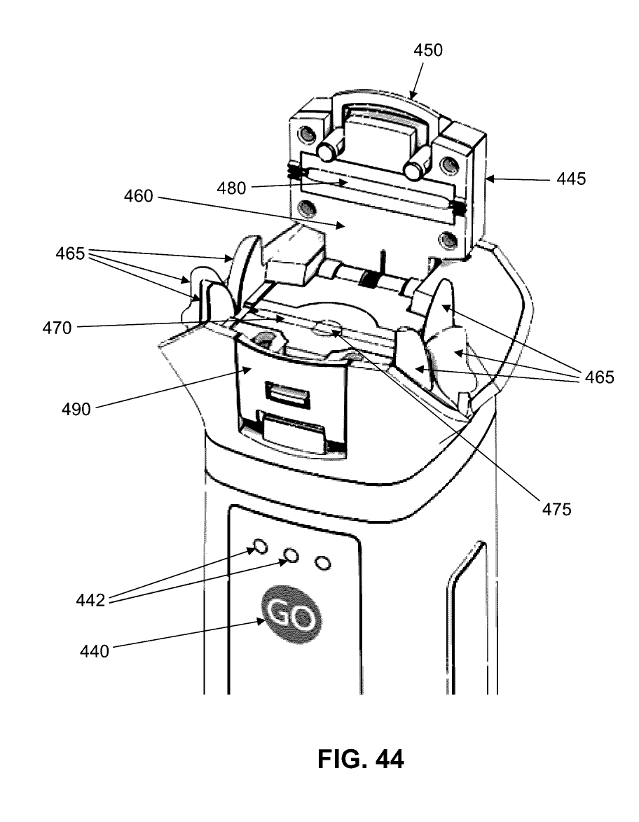

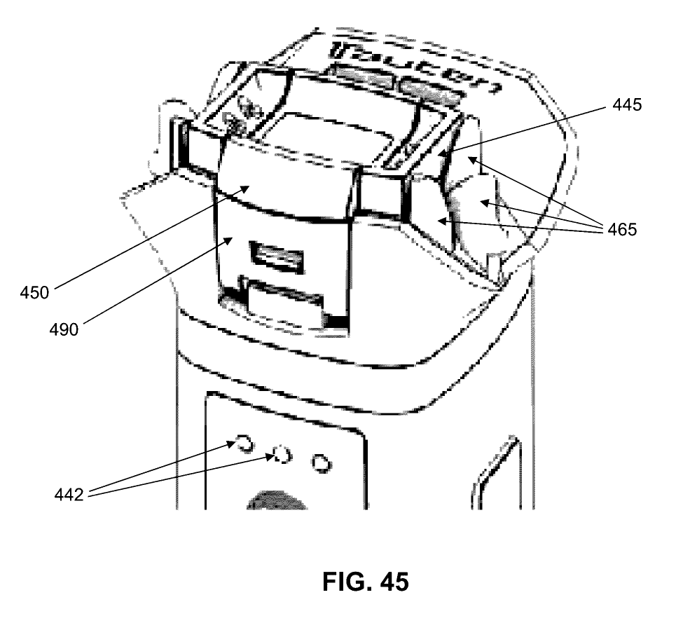

When it is desired to use novel welder 405 to join two strands of line together, it is first necessary to load welding cartridge 410 into body 412 of welder 405. More particularly, and looking first at FIGS. 39 and 40, welding cartridge 410 is loaded into cavity 415 by first releasing latch 450, which action opens mold door 445 and provides access to latch 490 of cartridge door 485. Next, as seen in FIG. 41, latch 490 is released so as to open cartridge door 485. Cartridge door 485 is then pivoted upward so as to expose cavity 415 in body 412 of welder 405. Welding cartridge 410 (or welding cartridge 410A) is then inserted (FIG. 42) into cavity 415 with the distal end (i.e., distal endcap 585) of welding cartridge 410 pointing up towards cartridge door 485. When welding cartridge 410 has been fully inserted into cavity 415, cartridge door 485 is closed (FIG. 43) and latch 490 is re-engaged, whereby to lock cartridge door 485 closed over cavity 415 (and over welding cartridge 410). See FIG. 44. Then mold door 445 is closed. See FIG. 45.

At this point, with welding cartridge 410 fully inserted and locked into cavity 415, proximal electrical contacts 570 of welding cartridge 410 make electrical contact with corresponding contacts (not shown) disposed in cavity 415. In one preferred form of the present invention, electrical power can selectively flow from battery 430 to control electronics 435, to proximal electrical contacts 570, along electrical contact leads 560 and to heating element 505 of welding cartridge 410 when welding cartridge 410 is inserted into cavity 415. If desired, activation button 440 may be used to selectively control the flow of electrical power from battery 430 to welding cartridge 410.

In addition, at this point (i.e., with welding cartridge 410 fully inserted into cavity 415), the distal end of plunger 420 is positioned to engage the proximal end of polymer stick 500 (or, where end cap 640 is provided with welding cartridge 410A, the distal end of plunger 420 is positioned to engage end cap 640 of welding cartridge 410A). As will hereinafter be discussed, plunger 420 can then be selectively actuated (i.e., moved distally via motor 425 in response to instructions from control electronics 435 and/or activation button 440) at the same time that electrical power is made to flow to heating element 505, whereby to selectively melt polymer stick 500 and cause polymer to flow distally out of exit port 610 of welding cartridge 410, through entrance 475 of cartridge door 485 and into proximal half 470 of the mold in lower mold assembly 455, whereby to flow into the complete mold and secure two lines together.

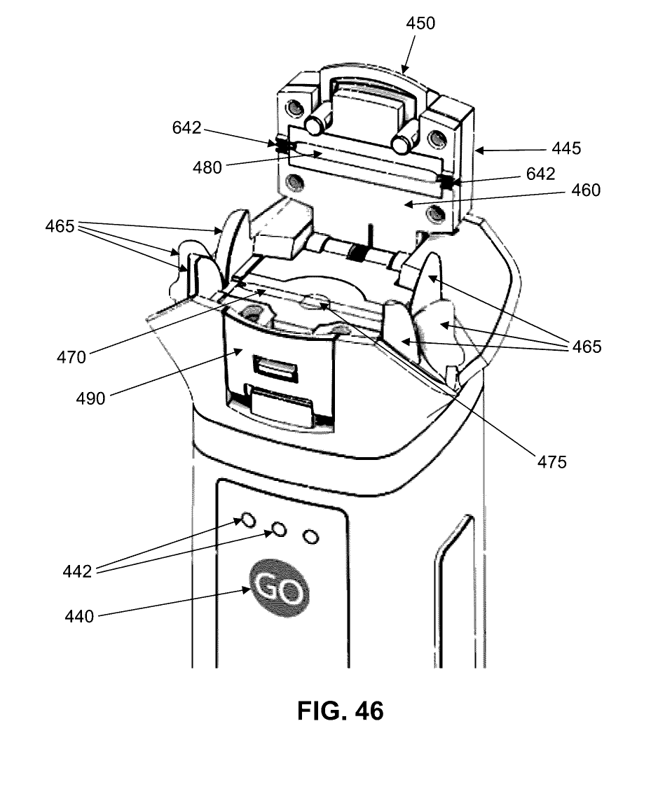

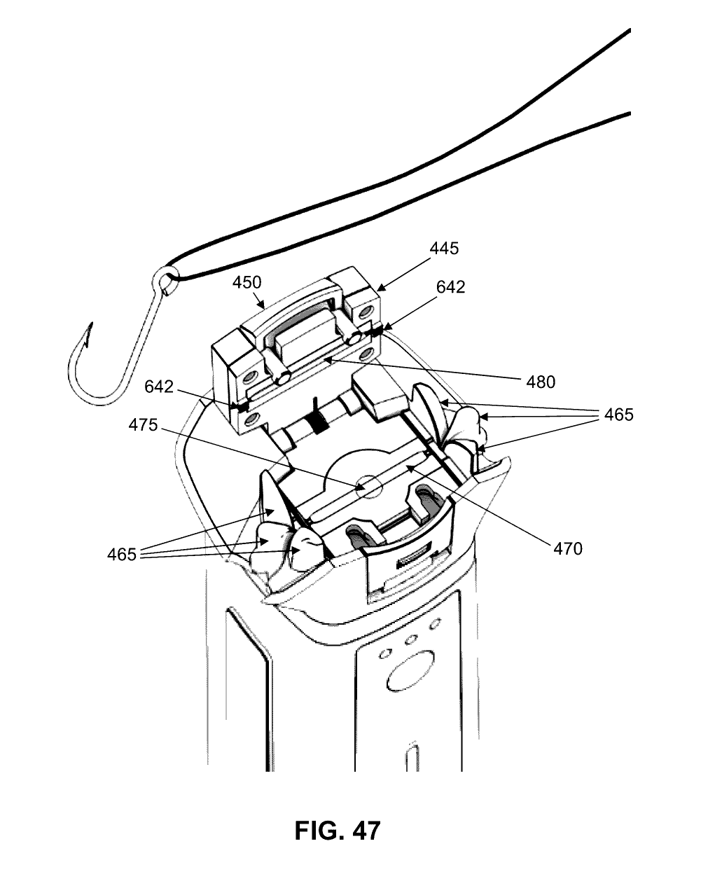

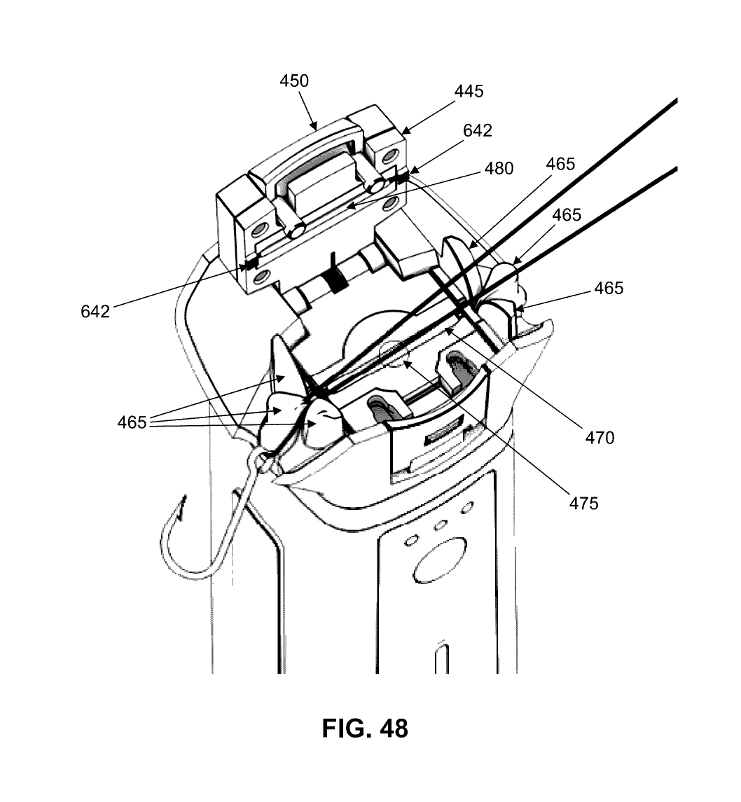

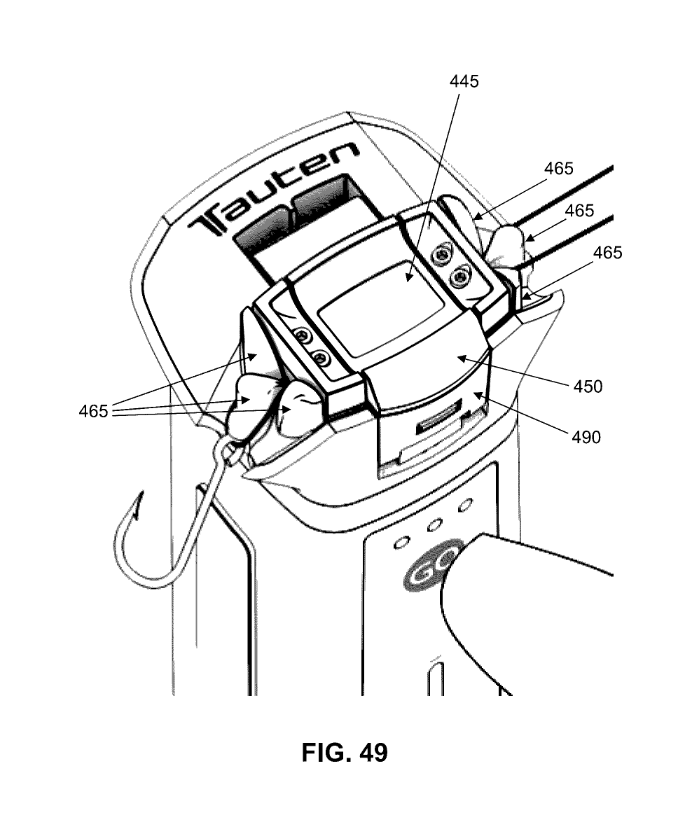

Next, when two lines are to be joined, mold door 445 is pivoted open (FIG. 46), the two (or more) lines which are to be joined are inserted into lower mold assembly 455, using guides 465 to keep the lines separated and to guide the lines into proper alignment with proximal half 470 of the complete mold cavity. See FIGS. 47 and 48. With the two lines disposed within proximal half 470 of the complete mold cavity (i.e., in parallel, spaced disposition to one another), mold door 445 is closed and locked via latch 450. See FIG. 49. At this point, proximal half 470 of the complete mold cavity (disposed on the top surface of cartridge door 485) and distal half 480 of the complete mold cavity (disposed on the bottom surface of mold door 445) are mated together so as to form the complete mold cavity, with the two (or more) lines which are to be joined being disposed alongside one another within the complete mold cavity.

If desired, upper mold assembly 460 may include small “knuckle-shaped” protrusions 642 (FIGS. 46, 47, 48 and 50) which, when brought into contact with the lines during closing of the mold, force the lines to tighten within the mold cavity, whereby to help ensure that the lines stay central to the mold and in optimal position for encapsulation by molten polymer.

The user then activates welder 405, e.g., by depressing activation button 440, whereby to simultaneously (i) cause electrical power to flow to heating element 505 and thereby melt polymer stick 500, and (ii) activate motor 425, whereby to move plunger 420 distally and force polymer stick 500 distally against heating element 505. This action causes liquefied polymer to flow out exit port 610 of welding cartridge 410, through entrance 475 in cartridge door 485 and into the complete mold cavity, where the flowable polymer flows around, and encases, the two lines.

If desired, a high-temperature compliant, material slit-valve (not visible in the figures) may be disposed in entrance 475 of cartridge door 485 so as to prevent melted polymer from prematurely “oozing” into the mold cavity. This same slit valve also helps prevent melted polymer from being forced anywhere but into the mold cavity. Likewise, this slit valve, once the flow of melted polymer has ceased, tends to return to its closed position, which minimizes or eliminates completely any gate vestige or sprue from the final line joint overmold.

After an appropriate amount of polymer has been injected into the complete mold cavity, electrical power to heating element 505, and electrical power to motor 425, is terminated. This allows the polymer in the complete mold cavity to cool, solidifying around the lines and creating a joined line construct.

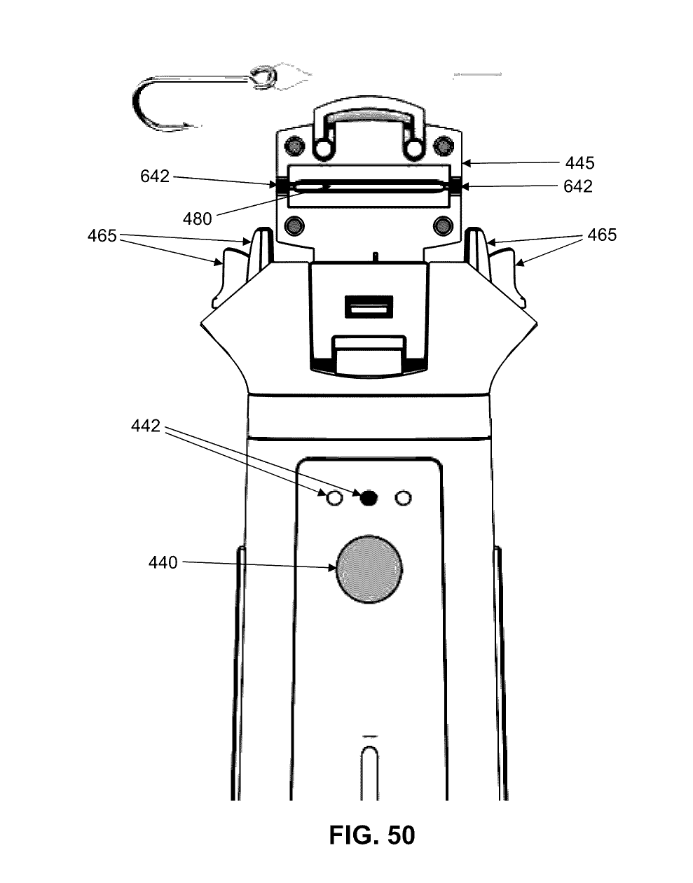

After the polymer has cooled and/or cured (i.e., resolidified), mold door 445 is opened, and the joined lines are removed from lower mold assembly 455. See FIG. 50.

It should be appreciated that control electronics 435 may be configured to adjust the amount of electrical power that is provided to heating element 505 and to adjust how far plunger 420 is moved distally, in order to ensure that the desired amount of liquefied polymer is made to flow into the mold cavity (and to prevent too much liquefied polymer from flowing into the mold cavity).

It should also be appreciated that, inasmuch as plunger 420 advances distally relative to welding cartridge 410/410A while injecting polymer into the mold, the disposition of tick mark 444 (FIG. 23) along window 443 gives a visual read of how much of the welding cartridge has been consumed at any given time.

### 4. Additional Features

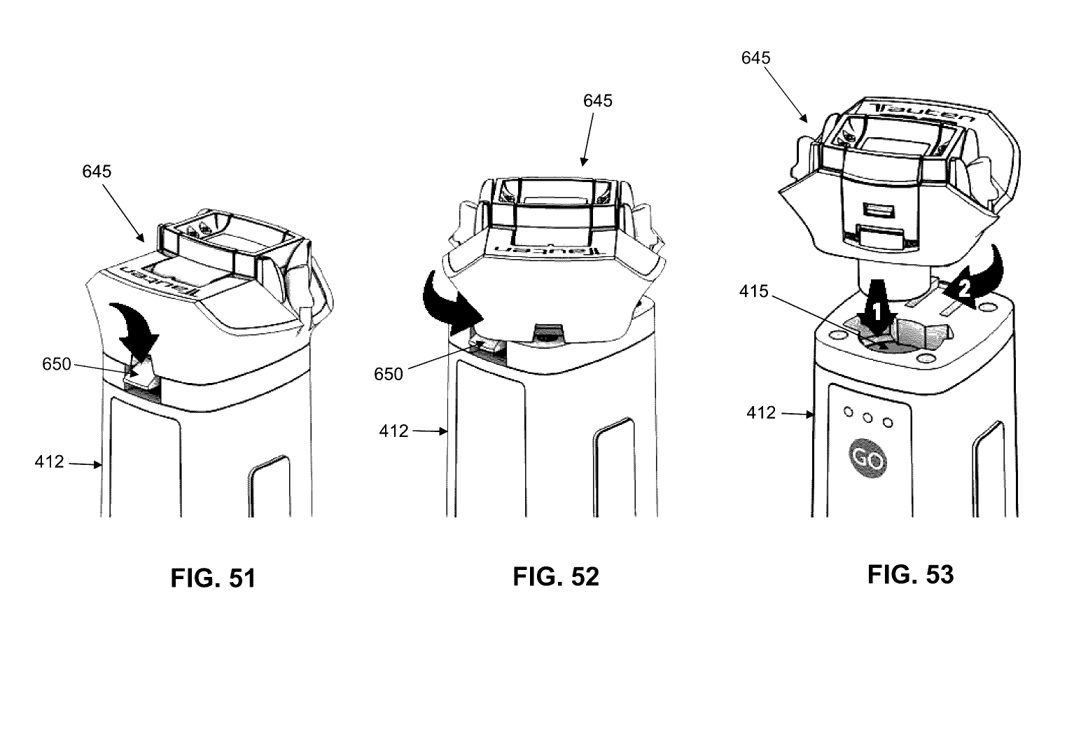

If desired, and looking now at FIGS. 51-53, welder 405 may be provided with a removable welding head 645 so as to allow a user to selectively exchange a given welding head 645 for an alternative welding head 645. By way of example but not limitation, this may be desirable when a user wishes to join two line segments of different gauge (i.e., diameter), to join different numbers of line segments, to adjust the orientation of the line segments in various parallel or non-parallel orientations, to accommodate the encapsulation of hooks or other components within the polymer sheath, etc.

To this end, welder 405 may comprise a latch 650 for selectively allowing welding head 645 to be rotated relative to body 412 of welder 405. In one preferred form of the present invention, removable welding head 645 comprises a bayonet-type mount for rotatably mounting/dismounting removable welding head 645 from welder 405.

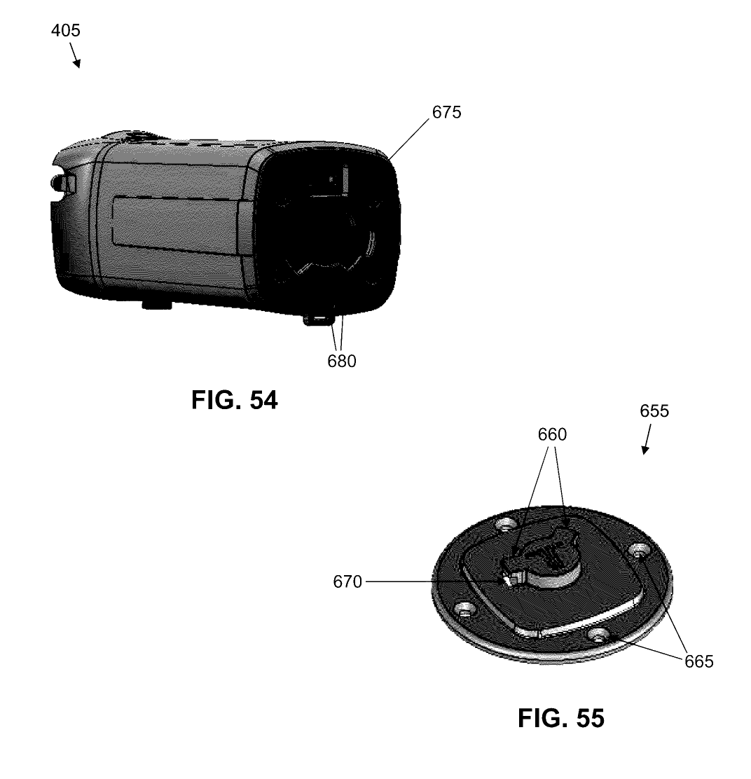

It may also be desirable to provide a mount, or charging base, in order to permit welder 405 to be mounted to a surface (e.g., to hold welder 405 in position during use so as to “free up a hand”, to store welder 405 while not in use, to charge battery 430 of welder 405, etc.). By way of example but not limitation, and looking now at FIGS. 54 and 55, welder 405 may be configured to be releasably mounted to a surface by way of a “bayonet”-type twist mount. With this construction, one-half of the bayonet mount is formed on a baseplate 655 (which is mounted to a surface) and one-half of the bayonet mount is formed on body 412 of welder 405.

More particularly, in this form of the invention, baseplate 655 comprises one or more upwardly-extending protrusions 660. Baseplate 655 is configured to be mounted to a surface, e.g., by passing one or more screws through one or more mounting holes 665 formed in the baseplate and into the surface. Upwardly-extending protrusions 660 comprise a groove 670 for mating to body 412 of welder 405, as will hereinafter be discussed in greater detail.

In one preferred form of the invention, the bottom of body 412 of welder 405 comprises a cavity 675 which is shaped to receive upwardly-extending protrusions 660 of baseplate 655 and which also comprises an overhang 680 sized to be received in groove 670 formed on upwardly-extending protrusions 660 of baseplate 655. Cavity 675 is configured such that when the welder 405 is disposed over upwardly-extending protrusions 660 on baseplate 655, the upwardly-extending protrusions extend into cavity 675 formed on the bottom of the body 412 of welder 405. When body 412 is thereafter rotated in a predetermined way (e.g., clockwise), overhang 680 formed on body 412 of the welder 405 extends into groove 670 formed upwardly-extending protrusions 660, whereby to selectively lock welder 405 to baseplate 655. When the welder 405 is to be removed from baseplate 655, the user simply rotates the body 412 of welder 405 in the opposite direction (e.g., counterclockwise) so that no portion of the base of the welder 405 is disposed in groove 670 formed on upwardly-extending protrusions 660 of baseplate 655, thereby releasing welder 405 from the baseplate.

### Overmolded Knots

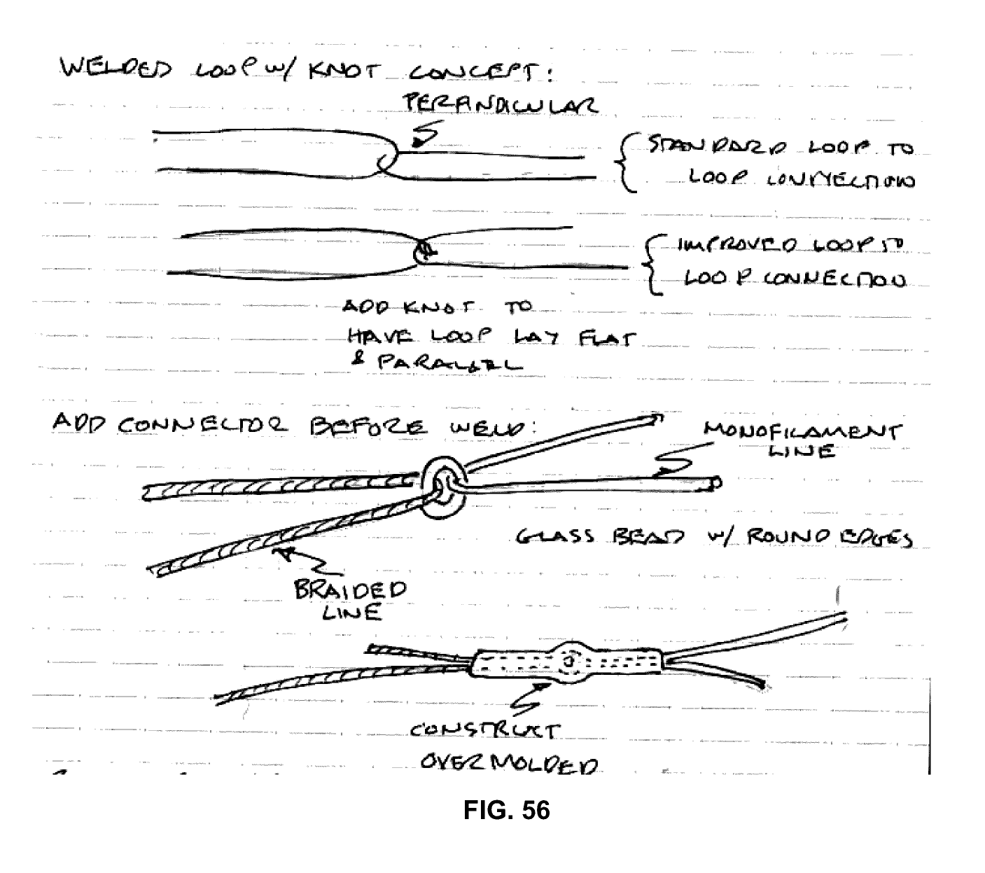

In addition to the foregoing, and looking now at FIG. 56, when connecting braided line to monofilament line, it can sometimes be advantageous to put a wrap or knot at the interface between the braided line and monofilament line and then apply the polymer overmold to the interface of the braided line and monofilament line. This approach helps relieve stress and facilitate proper orientation of the lines. By way of example but not limitation, a simple overhand knot may be made to link two lines (e.g., a 10 lb monofilament line and a 30 lb braided line) together, and then the polymer overmold applied over the knot, thereby significantly enhancing the strength of the joinder between the two lines. Alternatively, and still looking now at FIG. 56, when connecting braided line to monofilament line, it can sometimes be advantageous to place another element (e.g., a doughnut spheroid shape or ring) at the interface between the braided line and monofilament line and then apply the polymer overmold to the interface of the braided line and monofilament line. Again, this approach helps relieve stress and facilitate proper orientation of the lines.

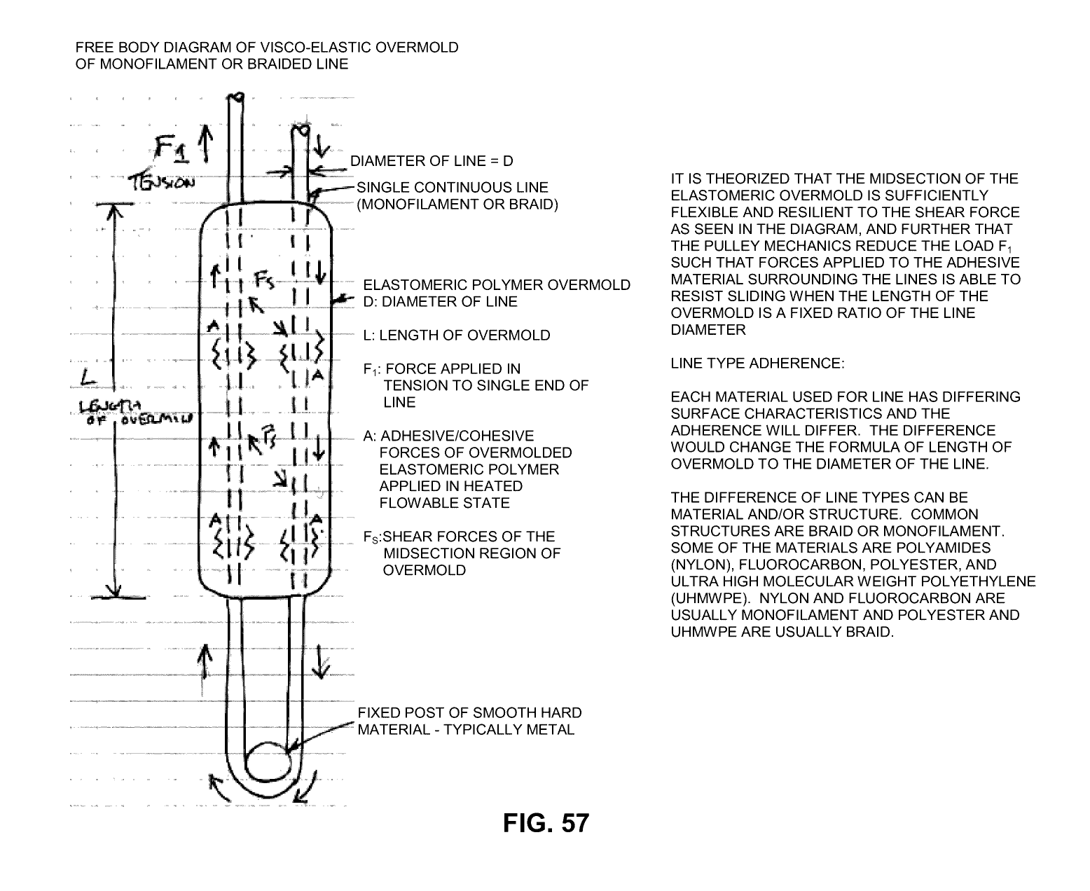

FIG. 57 provides a description of the line connection made by the overmold system of the present invention. More particularly, it provides a free body diagram showing the various pulley forces, visco-elastic shear forces and adhesion mechanisms present in the line connection.

### Modifications of the Preferred Embodiments

While the present invention has been set forth in terms of a specific embodiment or embodiments, it will be understood that the method and apparatus for joining lines together herein disclosed may be modified or altered by those skilled in the art to other configurations. Accordingly, the invention is to be broadly construed and limited only by the scope and spirit of the claims appended hereto.

What is claimed is:

1. A system for securing at least two line segments in position relative to one another, the system comprising:
a hand-held device, wherein the hand-held device comprises a mold defining a mold chamber and an inlet port in fluid communication with the mold chamber, and further wherein the hand-held device is configured to support the at least two line segments so that the at least two line segments extend into the mold chamber; and
a welding cartridge comprising a heating element and a solid polymer element, wherein the welding cartridge is configured to be received by the hand-held device so that when the heating element is energized and the solid polymer element is moved so as to contact the heating element, flowable polymer will enter the inlet port and flow into the mold chamber.

2. A system according to claim 1 wherein the solid polymer element comprises a polymer stick.

3. A system according to claim 1 wherein the hand-held device comprises a cavity sized to receive the welding cartridge, and a cartridge door for selectively closing off or opening up the cavity.

4. A system according to claim 3 wherein the inlet port is formed in the cartridge door.

5. A system according to claim 1 wherein the mold comprises a proximal half of the mold and a distal half of the mold, and further wherein the distal half of the mold may be moved towards or away from the proximal half of the mold so as to close off, or open up, the mold.

6. A system according to claim 5 wherein the proximal half of the mold is formed on the cartridge door.

7. A system according to claim 6 wherein the hand-held device further comprises a mold door which may be moved towards or away from the cartridge door, and further wherein the distal half of the mold is formed on the mold door.

8. A system according to claim 1 wherein the hand-held device further comprises a plunger for forcing the solid polymer element toward the heating element.

9. A system according to claim 8 wherein the plunger is moved by a motor.

10. A welding cartridge comprising:
a housing having a distal end, a proximal end and a lumen extending therebetween;
a heating element disposed at the distal end of the housing; and
a solid polymer element movably disposed within the lumen.

11. A welding cartridge according to claim 10 wherein the solid polymer element comprises a polymer stick.

12. A welding cartridge according to claim 10 further comprising an insulator mounted to the distal end of the housing, wherein the heating element is mounted to the insulator.

13. A welding cartridge according to claim 10 wherein the heating element comprises a planar body extending transverse to the longitudinal axis of the housing, and a heat director extending distally from the planar body, parallel to the longitudinal axis of the housing.

14. A welding cartridge according to claim 13 further comprising an outer cover, wherein the outer cover comprises a distal end, a proximal end and a cavity extending therebetween, the distal end of the outer cover comprising an end cap having a tapered distal tip and an exit port.

15. A welding cartridge according to claim 14 wherein the heat director extends into the exit port.

16. A welding cartridge according to claim 14 wherein the heat director further comprises a planar body extending transverse to the planar body of the heating element.

17. A method for securing at least two line segments in position relative to one another, the method comprising:
providing a system comprising:
a hand-held device, wherein the hand-held device comprises a mold defining a mold chamber and an inlet port in fluid communication with the mold chamber, and further wherein the hand-held device is configured to support the at least two line segments so that the at least two line segments extend into the mold chamber; and
a welding cartridge comprising a heating element and a solid polymer element, wherein the welding cartridge is configured to be received by the hand-held device so that when the heating element is energized and the solid polymer element is moved so as to contact the heating element, flowable polymer will enter the inlet port and flow into the mold chamber;
positioning the at least two line segments so that they extend into the mold chamber; and
activating the heating element on the welding cartridge so as to melt the solid polymer element and cause flowable polymer to enter the inlet port and flow into the mold chamber.

18. A method according to claim 17 wherein the solid polymer element comprises a polymer stick.

19. A method according to claim 17 wherein the hand-held device comprises a cavity sized to receive the welding cartridge, and a cartridge door for selectively closing off or opening up the cavity.

20. A method according to claim 19 wherein the inlet port is formed in the cartridge door.

21. A method according to claim 17 wherein the mold comprises a proximal half of the mold and a distal half of the mold, and further wherein the distal half of the mold may be moved towards or away from the proximal half of the mold so as to close off, or open up, the mold.

22. A method according to claim 21 wherein the proximal half of the mold is formed on the cartridge door.

23. A method according to claim 22 wherein the hand-held device further comprises a mold door which may be moved towards or away from the cartridge door, and further wherein the distal half of the mold is formed on the mold door.

24. A method according to claim 17 wherein the hand-held device further comprises a plunger for forcing the solid polymer element toward the heating element.

25. A method according to claim 24 wherein the plunger is moved by a motor.

26. A method according to claim 17 wherein the welding cartridge comprises:
a housing having a distal end, a proximal end and a lumen extending therebetween; and
a heating element disposed at the distal end of the housing;
wherein the solid polymer element movably disposed within the lumen.

27. A method according to claim 26 wherein the welding cartridge further comprises an insulator mounted to the distal end of the housing, wherein the heating element is mounted to the insulator.

28. A method according to claim 26 wherein the heating element comprises a planar body extending transverse to the longitudinal axis of the housing, and a heat director extending distally from the planar body, parallel to the longitudinal axis of the housing.

29. A method according to claim 28 further comprising an outer cover, wherein the outer cover comprises a distal end, a proximal end and a cavity extending therebetween, the distal end of the outer cover comprising an end cap having a tapered distal tip and an exit port.

30. A method according to claim 29 wherein the heat director extends into the exit port.

31. A method according to claim 29 wherein the heat director further comprises a planar body extending transverse to the planar body of the heating element.

32. A method according to claim 17 wherein the at least two line segments are tied together in a knot, and further wherein the knot is disposed in the mold chamber when the flowable polymer enters the mold chamber.

33. A method according to claim 17 wherein the at least two line segments are looped through one another, and further wherein the looped line segments are disposed in the mold chamber when the flowable polymer enters the mold chamber.

34. A method according to claim 17 wherein the at least two line segments are linked together by a linkage element, and further wherein the linkage element is disposed in the mold chamber when the flowable polymer enters the mold chamber.

35. A method according to claim 34 wherein the linkage element comprises a ring.
